(19) United States
(12) Patent Application Publication
(10) Pub. No.: US 2022/0335402 A1
(43) Pub. Date: Oct. 20, 2022

(54) PAYMENT ACCEPTOR WITH A MULTIFUNCTION IMAGING SENSOR

(71) Applicant: Crane Payment Innovations, Inc., Malvern, PA (US)

(72) Inventors: David Charles DEAVILLE, West Chester, PA (US); Robert James LISIC, Stow, OH (US); Yamane HIROSHISA, Sakado-Shi (JP); Murai SHIGEYUKI, Sakado-Shi (JP); Yuzawa FUMIO, Sakado-Shi (JP); Christopher CARMINE, Chalfont, PA (US); Thorsten SCHNEIDER, Aspensen (DE); Zachary GREENBERG, Malvern, PA (US); Christian VOSER, Vessy (CH)

(21) Appl. No.: 17/642,591

(22) PCT Filed: Oct. 12, 2020
(86) PCT No.: PCT/US20/55287

§ 371 Date: Mar. 11, 2022

Related U.S. Application Data
(60) Provisional application No. 62/913,651, filed on Oct. 10, 2019.
(60) Provisional application No. 62/914,199, filed on Oct. 11, 2019.
(60) Provisional application No. 62/914,214, filed on Oct. 11, 2019.
(60) Provisional application No. 62/949,337, filed on Dec. 17, 2019.

(51) Int. Cl. G06Q 20/20

(52) U.S. Cl. CPC G06Q 20/208; G06Q 20/204; G06Q 20/209

(57) ABSTRACT

A payment acceptor (500) includes an inlet, a payment media transport path to transport payment media such as a banknote or a coin from the inlet to an interior of the payment acceptor, and an imaging sensor (501) to capture an image of an object inserted in the payment media transport path. The imaging sensor is configured to capture an image of a user (504) attempting to insert an object (505) into the inlet. At least one processor (3902) is configured to receive one or more images of the media captured by the imaging sensor via at least one of the one or more fiber optic sensors (1121, 1122), analyze at least one of the one or more images to determine at least one media characteristic of the media, store the at least one media characteristic in the memory (3904), and cause the payment acceptor to perform an action based on the at least one media characteristic.

### CROSS-REFERENCE TO RELATED APPLICATIONS

This application is a 371 National Stage of International Application No. PCT/US2020/055287, filed Oct. 12, 2020, which claims the benefit of Provisional Application No. 62/913,651, filed Oct. 10, 2019, Provisional Application No. 62/914,199, filed Oct. 11, 2019, Provisional Application No. 62/914,214, filed Oct. 11, 2019, and Provisional Application No. 62/949,337, filed Dec. 17, 2019, the disclosures of which are herein incorporated by reference in their entirety.

### TECHNICAL FIELD

This disclosure relates generally to automated payment systems. More specifically, this disclosure relates generally to an imaging sensor implementation within a payment acceptor system. More specifically, this disclosure relates to a banknote or coin acceptor with a multifunctional imaging sensor.

### BACKGROUND

Automated payment acceptors facilitate transactions involving banknotes, coins and cashless payment for goods or services. Payment acceptors can include one or more of banknote acceptors, coin acceptors and cashless payment acceptors. Automated payment acceptors are used in unattended payment systems such as kiosks, self-service checkout terminals, parking meters, vending machines, gaming machines, ticketing machines and automated teller machines as well as in attended payment systems such as cashier assisted checkout terminals, bank counters, cannabis sales counters and other places where cashiers prefer to avoid touching currency such as banknotes or coins, as well as cashless payment objects like credit, debit or payment cards.

Banknote acceptors are used to check authentication and denomination of banknotes, coins and payment cards. Banknote acceptors are used in a wide variety of payment system applications including kiosks, cashier assisted payment terminals, self-service checkout terminals, parking meters, vending machines, gaming machines, ticketing machines, unattended lock safes, and automated teller machines. Banknote acceptors typically include at least a sensor unit for validating authenticity of inserted banknotes and at least an electrically powered motor to transport an inserted banknote to an interior of a banknote acceptor if deemed authentic by the sensor unit, and return the banknote to a user if the sensor unit determines otherwise. Various types of sensor units can be employed by a banknote acceptor device. For example, optical sensors with wavelengths ranging from ultraviolet (UV) to infra-red (IR) as well as phosphorescence decay, capacitive sensors, magnetic sensors, and acoustic sensors.

A banknote deposit-withdrawal system may sort banknotes and transport one or more banknotes to one or more storage locations. A banknote deposit-withdrawal system may provide change to a user at the end of a financial transaction. A deposit made by a customer may become change for a future customer. Banknote deposit-withdrawal systems can accept banknotes from a user, verify inserted banknotes, store accepted banknotes, provide genuine currency back for change or cash-back, and reject non-genuine banknotes. A banknote deposit-withdraw system may include an escrow position where a banknote may be temporarily stored during a transaction. A banknote deposit-withdrawal system has an opening where a customer or user may insert single or multiple banknotes. A banknote deposit-withdrawal system further includes a banknote transportation path to convey a banknote from said opening to one or more sensor systems, and/or to a storage unit. The storage unit can be a temporary storage unit such as an escrow module or recycling module, or a permanent storage unit such as a cashbox, cashbag or any other storage area. The banknote deposit-withdrawal system can also be referred to as a banknote recycler or a banknote accept-dispense system.

This arrangement of utilizing change, especially lower denomination banknotes, may result in a banknote deposit-withdrawal system conducting more transactions compared to a banknote acceptor that has one or more banknote storage units, as the banknote acceptor stores every accepted banknote into a permanent storage unit. This may result in a banknote deposit-withdrawal system with lower capacity banknote storage units or a banknote deposit-withdrawal system that requires less frequent banknote collections. As lower denomination banknotes are provided as change back to the users, higher denomination banknotes may be accumulated in the storage units. This may increase operational efficiency by executing more transactions per banknote collection and may increase the value of the banknote collection. An additional benefit of a banknote deposit-withdrawal system is the ability to provide cashback to the user of a non-ATM device. Cashback to the users reduces the accumulation of banknotes in a banknote storage unit. The reduced accumulation of banknotes in a deposit-withdrawal unit provides for more transactions before the banknote storage unit becomes full.

A subset of banknote deposit-withdrawal systems is an accept-dispense system. An accept-dispense system comprises a banknote acceptor and a banknote dispenser machine. An accept-dispense system has a larger envelope than a banknote deposit-withdrawal system. An accept-dispense system generally requires more frequent banknote collections and service operator interventions as the banknote acceptor is always accepting and filling up the banknote storage unit and the banknote dispenser machine is always dispensing banknotes and may run out of banknotes to dispense.

Coin acceptors typically include at least a sensor unit for validating authenticity of inserted coins and at least an electrically powered actuator to direct the inserted coins to an interior of a coin acceptor if deemed authentic by the sensor unit, and return the coins to a user if the sensor unit determines otherwise. Various types of sensor units can be employed by a coin acceptor device. For example, optical sensors with wavelengths ranging from ultraviolet (UV) to infra-red (IR) as well as inductive sensors, phosphorescence decay, capacitive sensors, magnetic sensors, and acoustic sensors. In addition, many coin acceptors comprise start sensors to activate a coin system inside a coin acceptor to initiate a transaction.

Many unattended payment systems such as kiosks, self-service checkout terminals, parking meters, vending machines, gaming machines, ticketing machines and automated teller machines are generally in areas that have high foot traffic and activity for a few hours a day and many are in locations that have surveillance imaging sensors. However, many unattended payment systems are in areas without coverage of surveillance imaging sensors and may not have security to protect against vandalism or fraud. As the unattended payment systems become more ubiquitous, vandalism and fraud attempts against these units increase as they may be considered soft targets and individuals who commit vandalism or fraud attempts face little repercussions. Vandalism and fraud attempts against the unattended payment systems may result in the units being non-operational, resulting in loss of revenue and repair and maintenance costs in case of physical damage to the unit.

Many unattended payment systems operate in areas with high electricity costs, and the systems are used for a limited period of time. Keeping all systems active all the time when the unattended payment system is not in use may consume unnecessary electricity costs, thereby increasing the operational cost of the unattended payment system. Many unattended payment systems require users to initiate a transaction by taking an action, for example pressing a button. This option in many cases is not user-friendly, resulting in some unattended payment systems employing multiple wake-up or activation sensors such as proximity sensors in various components of the unattended payment system. These multiple wake-up or activation sensors increase cost.

There is great interest in the application of low cost imaging sensor sensors for banknote recognition. These sensors offer a very low cost per pixel of data collected and facilitate high resolution image capture which can open up new opportunities such as serial number recognition, fitness assessment and die stain recognition. However existing imaging sensor lens systems have a fixed aspect ratio and mass market lens systems have a field of view that is inconvenient to package in a banknote acceptor. Existing designs also require that manufacturing tolerances be tightly controlled and there are a limited number of locations for a sensor to be placed within a given space envelope in a payment apparatus. If sensors are mounted to a printed circuit board (PCB), in existing designs, holes may need to be cut through the PCB to avoid obstructing the light path. The light path may also require multiple mirrors, which reduces efficiency and exacerbates the problem of tightly controlling manufacturing tolerances. Additionally, existing designs leave the optical path open to dirt and dust.

Paper handling systems are subject to occasional jams. Some paper handling systems have multiple access panels allowing access to the paper path and paper storage areas so that a jam can be cleared manually. However, jamming problems are compounded within the design of a banknote recycling system. The input document may be in a state of wear and tear that the machine designer has no control over, and/or the documents that are being processed possess intrinsic monetary value and therefore the possibility of theft or at least the need to deter theft must be considered. The act of manually opening the paper path or storage areas to clear a jam exposes the operator to the temptation to remove more cash than they report. Existing systems are not aware of this loss since banknotes are too variable in density and thickness to be accurately counted in bulk form. The level of accuracy and confidence required to detect the loss of a single banknote from a flat stack is not provided in existing systems.

One technique which has been adopted in the past is to store banknotes in a drum between layers of flexible film. A jammed note is often accessible while banknotes wrapped around the drum are typically gripped with a sufficient force that forcible extraction will damage either the note or the system with clearly detectable results. Furthermore, unwanted rotation of the storage drum can be detected by having positional markers along the flexible film or by simply winding the drum to a known reference point on power up. However, a circular drum is far from optimal as a storage system for larger numbers of banknotes. The film thickness, the unused inner core, and the geometrical fact that the ratio of the volume of a drum to the volume of a cube of the same extents is Pi/4 or approximately 79% means that a drum will likely not be as space efficient as a flat stack.

Coin acceptors can use various types of sensor units such as optical sensors with wavelengths ranging from ultraviolet (UV) to infra-red (IR) as well as inductive sensors, phosphorescence decay, capacitive sensors, magnetic sensors, and acoustic sensors. The current coin recognition systems in coin acceptors are mostly based on geometric features such as diameter, thickness and indentations on edges and material identification of coins. However, those features are not always enough to denominate coins or detect counterfeits. To improve the performances of coin validation systems, there is great interest in the application of low cost imaging sensor sensors for coin recognition. These sensors offer a very low cost per pixel of data collected and facilitate high resolution image capture which can open up new opportunities such as embossing detection and fitness assessment. Measuring the embossed pattern on coins might become a new security standard. Different technologies to detect embossed pattern on coins rely on imaging sensors. However, imaging does not detect 3d shapes in the embossed pattern. It can then easily be deceived by a printed image of good quality. Previous approaches have relied on multiple cameras and/or multiple illumination sources to capture, identify and analyze the shadows created by the different illumination angles, wavelengths, and viewing angles from the different lighting sources and cameras. These approaches are expensive and are not conducive to compact solutions or fast processing systems. In addition, existing imaging sensor lens systems have a fixed aspect ratio and mass market lens systems have a field of view that is inconvenient to package in a coin acceptor. Existing designs also require that manufacturing tolerances be tightly controlled and there are a limited number of locations for a sensor to be placed within a given space envelope in a payment apparatus. If sensors are mounted to a printed circuit board (PCB), in existing designs, holes may need to be cut through the PCB to avoid obstructing the light path. The light path may also require multiple mirrors, which reduces efficiency and exacerbates the problem of tightly controlling manufacturing tolerances. Additionally, existing designs leave the optical path open to dirt and dust.

Coin changers can have coin tubes in which coins stored in the coin changer and to be paid out by the coin changer are stored such that the coins are stacked on top of each other. One separate coin tube is provided for each type of coin. Thus, there is the necessity to determine the number of coins in the coin tubes, that is to say the fill level of the coin tubes, during the operation. This can be achieved by providing one or several light barriers, which are interrupted by the coin stack when one or several limit heights in the coin tubes are exceeded. It is disadvantageous in this kind of fill level determination that only discrete values of the fill level can be determined. In case that the coin stack is between two light barriers in its height, the coins between the light barriers are not included. Thus, this technology does not always offer sufficient accuracy in practice. Moreover, the utilization of sound- or ultrasound sensors is known for the indicated purpose, which measure the elapsed time of an ultrasound signal from a sender to the uppermost coin of a coin stack and back from there to a receiver. By means of this measurement of the elapsed time, the distance between the ultrasound sensor or receiver and the uppermost coin is calculated, from which, with known coin thickness, the height of the coin stack and thus the number of coins which are in the coin tube can be inferred in turn. Disadvantageous in this technology is the strong dependence of the sound velocity, and therefore of the measurement result, from the prevailing temperature and humidity. In addition, such ultrasound sensors have a large blind range, in which no reliable measurement is possible due to an overlap of the emitted and the reflected sound signals. This blind range is located near to the sound sender or sound receiver. A significant minimum distance between the sound senders or sound receivers and the uppermost coin of a coin stack is in practice necessary for a reliable measurement, for instance a distance of around 2 cm. In turn, this limits the capacity of the coin tubes when the installation space of the device is given.

Moreover, the utilization of image processing systems can be used for identifying and counting tokens used for instance in gambling casinos. Examples include U.S. Pat. No. 6,425,817 B1, U.S. Pat. No. 6,626,750 B2, U.S. Pat. No. 7,481,702 B2 or US 2014/0200071 A1. Some of these documents describe imaging methods in which a lateral view of a stack of tokens is captured. Based on this principle, an image processing software identifies different tokens located in the stack and determines an overall value of the stack, for instance of a gambler of a gambling casino. The described methods require a lateral access of the image sensors to the tokens that are to be evaluated. Such a lateral access is not always given in practice. Moreover, the described image evaluation systems are complex and not always reliable for this reason.

Coin changers with field configurable cassettes cannot automatically detect the coin cassette configuration (i.e., what coin tubes are in what position). The coin cassette configuration has to be manually loaded into the product during manufacturing or by the customer. Further, these coin changers cannot detect when a coin tube is improperly filled, such as filling a tube with the incorrect coin denomination, or if a coin is misrouted, such as if the coin changer intended to place a coin in a first position, but the coin was instead placed in a second, unintended, position. In such events, the result is a payout jam, or the customer receives incorrect change.

### SUMMARY

This disclosure provides an imaging sensor implementation within a banknote acceptor system or other system. Payment acceptors can accept banknotes, coins, payment cards such as credit and debit cards, or other types of payment media. Payment acceptors can include one or more of a banknote acceptor, coin acceptor, magnetic card reader, chip card reader, and NFC card reader. This disclosure is directed to a banknote validator with an imaging sensor and a fiber optic light path.

In a first embodiment, a banknote acceptor includes an inlet to allow a user to insert a banknote into the banknote acceptor. The banknote acceptor includes a banknote transport path to transport the banknote from the inlet to an interior of the banknote acceptor. The banknote acceptor includes an imaging sensor to capture an image of an object inserted in the banknote transport path. The imaging sensor can be further configured to monitor the inlet of the banknote acceptor for objects being inserted. The imaging sensor can be further configured to capture an image of the user attempting to insert an object into the inlet of the banknote acceptor. Furthermore, a reflective surface or refractive prism can be included to change the field of view of the imaging sensor. In addition, the reflective or refractive surface can shift from allowing the imaging sensor to monitor the inlet of the banknote acceptor for objects being inserted to capture an image of a user attempting to insert an object into the inlet of the banknote acceptor. In addition, the reflective or refractive surface can shift from allowing the imaging sensor to monitor the inlet of the banknote acceptor for objects being inserted in the banknote acceptor, to capture an image of an object present in the banknote transport path. In addition, one of the fields of view for the image sensor can comprise a one way transparent surface.

In addition, the image sensor can wake up the banknote acceptor. In addition, the image sensor can wake up the unattended payment system. In addition, the banknote acceptor can store an image of a user and an inserted object either in the banknote acceptor or in the unattended payment system, or in both the banknote acceptor and the unattended payment system. In addition, the image sensor can take images of the area surrounding the unattended payment system. In addition, the width of the banknote transport path can change to accommodate various sizes of inserted banknotes. In addition, the image sensor can take an image of a digital indicia being presented on a user's portable device. Information from this digital indicium can be sent to a remote device using an externally communicating device such as telemeter, modem or a network communicated controller. The remote device can then determine validity of the digital indicia and send instruction to the unattended payment system to either provide credit to the user or to unlock the machine. In some embodiments, validation of the digital indicia can be performed locally and a user can be billed later. In some embodiments, digital indicia can be stored and validated, and a user can be billed for the purchase.

In another embodiment, a method of taking an image of a user using an unattended payment system using an image sensor from a banknote acceptor is provided. The method comprises monitoring an inlet of the banknote acceptor for objects being inserted, detecting when an object is being inserted in the inlet of the banknote acceptor, finding the face of a user, and taking an image of a user. The method can comprise capturing an image of an object inserted in a banknote transport path. The method can comprise changing the field of view of an image sensor from the inlet of the banknote acceptor to a user. The method can comprise changing the field of view of an image sensor from a banknote coin path of the banknote acceptor to a user. The method can comprise storing images of a user and an inserted object. The method can comprise linking and storing images of a user and an inserted object. The method can comprise changing the width of a banknote path to accommodate a denomination of an inserted banknote. The method can comprise taking an image of digital indicia on a user's personal device, sending the image to a remote computing device, verifying the authenticity of that digital indicia and sending an instruction to the unattended payment system to either provide credit to a user or unlock the machine.

In another embodiment, a coin acceptor includes an inlet to allow a user to insert a coin into the coin acceptor. The coin acceptor includes a coin transport path to transport the coin from the inlet to an interior of the coin acceptor. The coin acceptor further includes an imaging sensor to capture an image of an object inserted in the coin transport path, where the imaging sensor is further configured to monitor the inlet of the coin acceptor for objects being inserted. The imaging sensor included in the coin acceptor is further configured to capture an image of a user attempting to insert an object into the inlet of the coin acceptor.

In various embodiments, the coin acceptor can include one or both of a reflective or a refractive surface to change the field of view of the imaging sensor. The reflective or refractive surface can move to capture an image of a user attempting to insert an object into the inlet of the coin acceptor. The reflective or refractive surface can move to capture an image of an object present in the coin transport path. The reflective or refractive surface can move to capture an image of a user attempting to insert an object into the inlet of the coin acceptor. The refractive surface can move to capture an image of an object present in the coin transport path. The coin acceptor can include an imaging sensor that moves to capture an image of a user attempting to insert an object into the inlet of the coin acceptor. The imaging sensor can move to capture an image of an object present in the coin transport path. The image sensor of the coin acceptor can comprise a one-way transparent surface. The coin acceptor wakes up from a sleep mode if the imaging sensor detects that an object is being inserted into the inlet of the coin acceptor. Images of a user and an inserted object are stored in the memory of the coin acceptor. Images of a user and inserted objects captured by the imaging sensor in the coin acceptor are stored in the memory of the unattended payment system.

The imaging sensor in the coin acceptor takes images of the area surrounding the unattended payment system. The coin acceptor modifies a size throughout the coin transport path to accommodate a denomination of the inserted coin. Images of a user and an inserted object can be linked and stored in the memory of the coin acceptor. Images of a user and an inserted object can be linked and stored in the memory of the unattended payment system. The coin acceptor can include a security shutter that is operated in response to an image captured by the imaging sensor. The imaging sensor in the coin acceptor captures the image of digital indicia from a user's portable device and the coin acceptor sends an image to a communicating device; the external communicating device can send information of digital indicia from a user's portable device to a remote device and the remote device sends an instruction to unlock the unattended payment system. In another embodiment, the imaging sensor in the coin acceptor captures an image of digital indicia from a user's portable device and the coin acceptor sends an image to a communicating device. The external communicating device can send information of digital indicia from a user's portable device to a remote device and the remote device sends an instruction to provide credit to a user of the unattended payment system.

In another embodiment, a payment acceptor includes an inlet to allow a user to insert a payment medium into the payment acceptor. The payment acceptor includes a payment transport path to transport the payment medium from the inlet to an interior of the payment acceptor. The payment acceptor further includes an imaging sensor to capture an image of an object inserted in the payment transport path, where the imaging sensor is further configured to monitor the inlet of the payment acceptor for objects being inserted. The said imaging sensor included in the payment acceptor is further configured to capture an image of a user attempting to insert an object into the inlet of the payment acceptor. The payment acceptor can include a reflective or refractive surface that changes the field of view of the imaging sensor. The reflective or refractive surface can move to capture an image of a user attempting to insert an object into the inlet of the payment acceptor. The reflective or refractive surface can move to capture an image of an object present in the payment transport path. The refractive surface can change the field of view of the imaging sensor in the payment acceptor. The payment acceptor can include a refractive surface that moves to capture an image of a user attempting to insert an object into the inlet of the said payment acceptor. The refractive surface can move to capture an image of an object present in the payment transport path. The payment acceptor can include an imaging sensor that moves to capture an image of a user attempting to insert an object into the inlet of the said payment acceptor. The imaging sensor can move to capture an image of an object present in the payment transport path. The image sensor of the payment acceptor can comprise a one-way transparent surface. The payment acceptor wakes up from a sleep mode if the imaging sensor detects that an object is being inserted into the inlet of the payment acceptor. Images of a user and an inserted object are stored in the memory of payment acceptor. An image of a user and inserted objects captured by imaging sensor in the payment acceptor are stored in the memory of the unattended payment system. The imaging sensor in the payment acceptor takes images of an area surrounding the unattended payment system. The payment acceptor modifies size throughout of payment transport path to accommodate denomination of inserted payment medium. Images of a user and an inserted object can be linked and stored in the memory of the payment acceptor. Images of a user and an inserted object can be linked and stored in the memory of the unattended payment system. The payment acceptor can include a security shutter that is operated in response to an image captured by the imaging sensor. The imaging sensor in the payment acceptor captures the image of digital indicia from a user's portable device and the payment acceptor sends an image to a communicating device; the external communicating device can send information of digital indicia from a user's portable device to a remote device and the remote device sends instruction to unlock the unattended payment system. In another embodiment, the imaging sensor in the payment acceptor captures the image of digital indicia from a user's portable device and the payment acceptor sends an image to a communicating device; the external communicating device can send information of digital indicia from a user's portable device to a remote device and the remote device sends instruction to provide credit to a user of the unattended payment system.

The unattended payment systems such as kiosks, self-service checkout terminals, parking meters, vending machines, gaming machines, ticketing machines, and automated teller machines are increasingly being deployed in areas that have high foot traffic and activity for a few hours a day or for a certain time during the year. After initial investment, operational cost of these the unattended payment systems is generally low as few persons can manage a significantly large number of the unattended payment systems for supplies replenishment, cash, and coin collection and routine maintenance. The unattended payment systems, especially vending and gaming machines are vulnerable to fraud and vandalism because of the opportunity for anonymous abuse. This anonymity combined with lack of injuries to other people make fraud and vandalism difficult for operators to identify the culprit and forces operators to repair the vending and gaming machines. Expensive surveillance systems are used to deter culprits.

The present disclosure provides a banknote acceptor equipped with a user-facing inlet. The inlet is equipped with an imaging sensor that has a wide field of view including the vicinity immediately in front of the banknote inlet. Pictures taken by the imaging sensor can be then stored by either a banknote acceptor or by the terminal. The imaging sensor or an image sensor in a banknote acceptor facing inlet can take an image of the culprit and reduce the incentive for anonymous vandalism and fraud attempts as there could be a picture of the culprit with the operator and that can help authorities find the culprit and take necessary legal action against the culprits. Reduction in vandalism and fraud attempts can reduce physical damage as well as downtime for the operator. In addition, banknote acceptors generally reject banknotes or coins that are not found genuine. Many banknote acceptors do not differentiate between a banknote or coin that can have been rejected due to improper insertion such as double-feed, and do not differentiate attempts to insert with a skew or fold, attempts to insert too fast or too slow, a worn out banknote or coin, a damaged banknote or coin, or a forgery. As banknote acceptors add new sensors and improve the software to verify the genuineness of banknotes, forgery of banknotes or coins with unattended payment systems constantly changes as fraudsters make modifications to their forgeries. The presence of an imaging sensor that faces the inlet of a banknote acceptor and takes pictures of a user and an inserted object provides another benefit of the possibility of linking a user with the attempted fraudulent insertion of a banknote assisting law enforcement with identifying cheats. In an area with higher concern for fraud or vandalism, the payment system can be fitted with a security shutter that can block unauthorized access to the banknote and/or credit card path unless a valid banknote and facial image are recognized.

In addition to taking pictures of users of the unattended payment systems, the imaging sensor or an image sensor can also periodically take pictures of the area surrounding the unattended payment system. These pictures can create a record of the actual operating condition of the unattended payment system for the operator and can assist the operator to understand the foot traffic of the location. This information can then be used to either move the unattended payment system to either a different location or improve visibility or change a product offering to increase activity at the unattended payment system. In addition, this record can also provide information if the location of the unattended payment system suffers from light out where the machine may be residing in a dark location or may be blocked by some obstacle out of view from potential users. In addition, the record can provide information about moving the unattended payment system from one location to another location. Another benefit of this record can assist the operator in confirming the location of their unattended payment systems, as operators can move the unattended payment systems to maximize revenue and can lose track of the location of which specific machine is at a given location. In addition, a GPS receiver, cannot work indoors for locations such as an airport or a shopping mall.

Another benefit of the imaging sensor facing inlet in a banknote acceptor is the possibility of linking a user with an inserted banknote or coin. This linking and storing of pictures of a user with an inserted banknote or coin can assist in dispute resolution where a user may miscalculate banknotes or coins inserted or remembers inserting different a denomination than claims to get credit for. A user can be shown a user's picture with the inserted banknote or coin, which can improve dispute resolution by adding proof to dispute resolution where none exist today.

Another advantage of the imaging sensor facing inlet in a banknote acceptor is the possibility of scanning a display of a personal electronic device of a user. If the unattended payment system is connected to a remote computing device, then a banknote acceptor may be able to send images taken to the remote computing device in real-time as data transfer speed permits. This benefit can be utilized to implement a cashless transaction on the unattended payment system where a user can be provided a credit on the unattended payment system. Through a reward or payment application, display of a personal device of a user can present a digital indicium to the banknote acceptor. The imaging sensor of a banknote acceptor takes an image of the digital indicia and send it to the remote computing device. The remote computing device can validate the authenticity of digital indicia and provide credit to a user. In other applications, a service technician can present digital indicia on display of his/her portable digital device, and the remote computing device can send instructions to unlock the unattended payment system for supplying or servicing. In another implementation, digital indicia created by a personal device of a user or service technician can contain encrypted instructions for a banknote acceptor or controller of the unattended payment system to either provide credit to a user or unlock the unattended payment system for supplying or servicing to the service technician.

A smart electronic lock can also be used for the unattended payment system. The smart electronic lock can require a onetime code to unlock the unattended payment system for servicing or replenishing supplies. In existing systems, service technicians or inventory management persons carry multiple keys when they plan their route for servicing or inventory refills. Old mechanical locks can be replaced with smart electronic locks. Smart electronic locks can provide the time of visits to access to the unattended payment system and reduce keys technician or inventory refill personnel may have to carry with them. A technician or inventory refill personnel can create or receive digital indicia on display of their portable display device. The pre-scan imaging sensor from the banknote acceptor takes an image of the display of portable display device with digital indicia, and sends an image to a network-connected device or controller of the unattended payment system that can send then an image of digital indicia to a remote computing device. The remote computing device validates the authenticity of the digital indicia, and send instructions to the unattended payment system to unlock the device providing access to the technician or inventory refill person. In some embodiments, a log of access of the unattended payment system by technician or inventory refill personnel can be created. Additional security measures such as two-factor authentications can be added when the technician or inventory refill personnel requests access to the unattended payment system. In some embodiments, the digital indicia provides information such as the type of user accessing the unattended payment system, such as to distinguish whether the user is a technician servicing the unattended payment system, or a customer using the unattended payment system to perform a transaction. In some embodiments where the user is a customer or other individual using the unattended payment system for a transaction, if the digital indicium is found to be genuine, the remote computing device sends an instruction to the unattended payment system to provide credit to the user of the unattended payment system. This can simplify loyalty or rewards redemption for a user without the need for additional hardware at the unattended payment system. This may simplify loyalty or reward redemption for users as they may not have to carry a separate card or fob or other devices. Users can simply generate a reward or loyalty redemption code and present it to a banknote acceptor that may take an image of the display and a user may be provided a credit on the unattended payment system.

In one aspect, a banknote validator comprises a memory, an imaging sensor, one or more fiber optic sensors coupled to the imaging sensor, wherein the one or more fiber optic sensors are each disposed at a position relative to a banknote path of the banknote validator, and at least one processor coupled to the memory and the imaging sensor. The at least one processor is configured to receive one or more images of a banknote captured by the imaging sensor via at least one of the one or more fiber optic sensors, analyze at least one of the one or more images to determine at least one banknote characteristic of the banknote, store the at least one banknote characteristic in the memory, and cause the banknote validator to perform an action based on the stored at least one banknote characteristic.

In one aspect, a coin acceptor comprises a memory, a processor, an imaging sensor, an illumination source. The imaging sensor and the illumination source are arranged in such a manner that a portion a coin passes through direct reflection and side reflection. The imaging sensor captures multiple images of side reflection and direct reflection. These multiple images then are stitched together by the processor to get an image with direct reflection and one or more images with side reflection. Upon comparison of these images captured with direct reflection and side reflection it can be determined if embossing on a coin is genuine.

This disclosure provides a banknote recycler with jam recovery and audit integrity. In one aspect, a currency handling apparatus includes a banknote input area operable to receive banknotes into the currency handling apparatus. The currency handling apparatus further includes one or more sensors configured to capture one or more banknote parameters from each of the banknotes received into the currency handling apparatus. The currency handling apparatus further includes one or more storage areas. The currency handling apparatus further includes a banknote transport path operable to convey the banknotes to the one or more storage areas and to dispense the banknotes at least to the one or more sensors. The currency handling apparatus further includes a memory configured to store the one or more banknote parameters of each of the banknotes received into the currency handling apparatus. The currency handling apparatus further includes a controller coupled to the memory. The controller is configured to receive, from the one or more sensors, at least one banknote parameter for a banknote dispensed from one of the one or more storage areas to the one or more sensors. The controller is further configured to compare the at least one banknote parameter with the one or more banknote parameters stored in the memory. The controller is further configured to generate an alert signal based on the comparison of the at least one banknote parameter with the one or more banknote parameters stored in the memory.

In one aspect, a coin acceptor comprises a memory, an imaging sensor and an illumination source. The illumination source provides illumination on a coin in such a manner that a small illumination source provides direct illumination to a section of a coin. This direct illumination of sections of coin at a time results in multiple images of coins under direct reflection and multiple images at different illumination that is not direct illumination. These multiple images enable generating more than one image with different contrast. These images of different contrast can be stitched together to get complete images of the coin with different contrast. These images from different contrast enables the detection of presence or absence of embossing on a coin.

This disclosure provides a coin changer system that automatically detects the cassette configuration so that the coin changer can determine which cassettes are loaded for specific coin denominations. The system can detect when a coin is improperly filled, or if a coin is misrouted, so that the condition can be detected and corrected before a payout error or a coin jam occurs. In some embodiments, a coin changer includes one or more imaging sensors or imaging sensors that view a coin tube cassette of the coin changer, and the coin stack therein, from above. In some embodiments, a single imaging sensor can be used with image redirecting features, or a plurality of imaging sensors can be used, with an imaging sensor placed above each of the coin tubes in the coin changer. The imaging sensor viewing the coin stack captures one or more images of the coin stack, including the topmost coin. The imaging sensor also captures images of identifying marks on the coin tube. In some embodiments, the identifying marks can be an encoded tube identifier (ID) for automatic cassette configuration.

According to one aspect, the present disclosure provides a device for determining a fill level and identifying a coin type mismatch of at least one coin tube. The device comprises at least one spatially resolving optical sensor positioned at a defined distance to an upper side of the coin tube and configured to capture at least one spatially resolved image of the upper side of the at least one coin tube. The device further comprises an evaluation unit coupled to the at least one spatially resolving optical sensor. The evaluation unit is configured to receive the at least one spatially resolved image, identify, based on the at least one spatially resolved image of the upper side of the at least one coin tube, a coin tube identifier (ID) of the at least one coin tube, identify a coin type of an uppermost coin in the at least one coin tube, determine that there is a mismatch between the identified coin type and a coin type associated with the coin tube ID, and transmit a mis-fill or mis-route signal to another device.

According to the another aspect, the present disclosure provides a method comprising capturing at least one spatially resolved image of the upper side of the at least one coin tube using a spatially resolving optical sensor arranged at a defined distance above the at least one coin tube and directed onto the upper side of the at least one coin tube. The method further comprises transmitting the at least one spatially resolved image to an evaluation unit. The method further comprises Evaluating the at least one spatially resolved image by the evaluation unit by means of image processing, wherein the diameter of the uppermost coin filled into the coin tube is detected in the spatially resolved image. The fill level of the at least one coin tube is determined from the ratio between the inner or outer diameter of the at least one coin tube on the spatially resolved image and the detected diameter of the uppermost coin filled into the coin tube.

The present disclosure also provides a device comprising at least one spatially resolving optical sensor arranged at a defined distance above the at least one coin tube and directed onto the upper side of the at least one coin tube for capturing at least one spatially resolved image of the upper side of the at least one coin tube. An evaluation unit, wherein the at least one spatially resolving optical sensor is connected to the evaluation unit for transmitting the at least one spatially resolved image. The evaluation unit is adapted to evaluate the at least one spatially resolved image to detect the diameter of the uppermost coin filled into the coin tube in the spatially resolved image. The evaluation unit is adapted to determine the fill level of the at least one coin tube from the ratio between the inner or outer diameter of the at least one coin tube on the spatially resolved image and the detected diameter of the uppermost coin filled into the coin tube.

The at least one coin tube may be circular or cylindrical in particular. It is open at the topside, and the coin tubes are filled into the coin tube being stacked atop each other. At least one optical sensor looks into the coin tube from the topside, in particular vertically from the topside in the axial direction of the coin tube. The at least one optical sensor records the coins that are present in the coin tube. In addition, the at least one optical sensor can also record the normally circular opening of the coin tube. Spatially resolved images captured by the optical sensor are sent to the evaluation unit. Using one or more image evaluation algorithms, the evaluation unit identifies the outer limits of the uppermost coin, which differs from the coin tube in particular with respect to color or contrast, and then the evaluation unit determines the diameter of the visible uppermost coin in the spatially resolved image. Thus, the real diameter of the coin is not determined. One type of coins may be filled into each coin tube. The evaluation unit records the diameter of the uppermost coin like it appears in the spatially resolved image. This diameter depends on the distance of the coin to the optical sensor. The more the coin is remote, the smaller it appears, and therefore its diameter is also determined using the captured spatially resolved image.

The diameter of the uppermost coin in the spatially resolved image determined in this way is considered in relation to the inner or outer diameter of the coin tube, as if it appears in the spatially resolved image. The inner diameter is the diameter of the opening of the coin tube. The outer diameter is the diameter of the outer wall of the coin tube. As the defined distance of the sensor to the upper side of the coin tube does not change, the inner or outer diameter of the coin tube in the spatially resolved image remains the same. Therefore, the observed diameter proportion changes when the distance between the optical sensor and the uppermost coin changes.

In particular, from the ratio between the inner or outer diameter of the at least one coin tube in the spatially resolved image on the one hand, and the determined diameter of the uppermost coin filled into the coin tube on the other hand, the evaluation unit determines the distance of the at least one spatially resolving sensor from the uppermost coin filled into the coin tube, and from this, taking into account the known thickness of the coins filled into the measured coin tube, it derives the fill level of the at least one coin tube.

Thus, this disclosure offers fill level recognition by a simple and reliable evaluation technique, without the necessity of any lateral optical access and which is not depending on outer influences like temperature, humidity or reflectivity of the coins and the ambient light. A relevant blind range like with ultrasound sensors does also may not be used, so that the filling capacity of the coin tubes can be maximized. A high accuracy of the fill level recognition is possible if the resolution of the image sensors is sufficiently high. By doing so, it is made sure that every coin in the examined coin tube is taken into account in the fill level determination.

The at least one spatially resolving sensor used according to this disclosure may e.g., be a spatially resolving imaging sensor. It may be a spatially resolving CCD sensor or a spatially resolving CMOS sensor in particular. These devices yield high resolution and are compact and cost-saving at the same time. The coins of this disclosure can comprise metal coins used in normal payment transactions as well as collector coins and tokens used in the gaming field in slot machines and in casinos, tokens of metal or plastics. The at least one spatially resolving sensor and the evaluation unit may be separate components, wherein the at least one spatially resolving sensor is connected to the evaluation unit by a suitable line or so on. Nevertheless, it is also possible that the at least one spatially resolving sensor and the evaluation unit are integrated in one common component part, in which the connection of the at least one spatially resolving sensor to the evaluation unit is then also realized. The evaluation unit integrated into this common component part can then output the determined distance to the uppermost coin or the fill level directly, e.g., to a further evaluation unit.

According to an embodiment, it may be provided that the evaluation unit determines the fill level of the at least one coin tube based on the distance of the at least one spatially resolving optical sensor from the uppermost coin filled into the coin tube. The distance of the at least one spatially resolving optical sensor from the uppermost coin filled into the coin tube is determined taking into account the defined distance of the at least one spatially resolving optical sensor to the topside of the at least one coin tube, in particular according to the equation:

$$a = \frac{A \cdot D}{d}$$

wherein:
a: distance of the at least one spatially resolving optical sensor from the uppermost coin filled into the coin tube;
A: distance of the at least one spatially resolving optical sensor from the topside of the at least one coin tube;
d: diameter of the uppermost coin filled into the coin tube in the spatially resolved image; and
D: inner or outer diameter of the at least one coin tube in the spatially resolved image.

This embodiment offers a particularly simple mathematical determination of the distance between the at least one optical sensor and the uppermost coin, and based on this, the determination of the fill level of the respective coin tube, taking into account the known thickness of the coins in the coin tube.

According to a further embodiment, it may be provided that the defined distance of the at least one spatially resolving optical sensor from the upper side of the at least one coin tube and/or the inner or outer diameter of the at least one coin tube in the spatially resolved image is stored in a memory of the evaluation unit, and that the evaluation unit uses the distance stored in the memory and/or the inner or outer diameter stored in the memory in the determination of the fill level of the at least one coin tube. Because the mentioned two values do not change at different fill levels of the coin tube, it is not necessary to determine them by measurement in every measurement process. Instead, these values can be determined once, for instance in the context of a calibration, and be stored in a memory for the evaluation unit and read out from the memory in each measurement process for the determination of the fill level. This simplifies the evaluation according to this disclosure. It is also conceivable that the at least one spatially resolved image captured by the at least one spatially resolving optical sensor comprises the inner or outer diameter of the coin tube and that the evaluation unit determines the inner or outer diameter of the at least one coin tube in the spatially resolved image, which was used in the determination of the fill level of the at least one coin tube via image processing of the at least one spatially resolved image too.

With increasing distance of the optical sensor from the uppermost coin, i.e., at decreasing fill level, the determined diameter of the uppermost coin in the spatially resolved image becomes smaller and smaller. This can lead to problems, e.g., at distances of 10 cm and more if the resolution of the used image sensors is not sufficient. Therefore, in particular for high coin tubes with large coin capacity, high-resolution image sensors must be used. Alternatively or in addition, a fish eye lens can be mounted in front of the at least one spatially resolving sensor. Fish eye lenses enlarge the central region of the captured image compared to the outer regions of the image. Sufficiently large diameters of the uppermost coin appearing in the image can be generated even at larger distances from the uppermost coin through this measure. But on the other hand, the distance determination becomes more difficult through this. The fill level of a plurality of coin tubes can be determined by the method and/or the device of the present disclosure. The different coin tubes are then can be filled with different coins, with one type of coin being associated to each coin tube for filling. The measurement and evaluation exemplified above for at least one coin tube may then be performed for each of the coin tubes.

Further, it is possible that one spatially resolving optical sensor, disposed in a defined distance above the respective coin tube and directed onto the upper side of the respective coin tube, is associated to each coin tube, wherein each of the spatially resolving optical sensors captures at least one spatially resolved image of the upper side of the respective coin tube, each of the spatially resolved images is transmitted to the evaluation unit, and the evaluation unit evaluates each of the spatially resolved images by means of image processing, wherein the diameter of the uppermost coin filled into the respective coin tube is determined in the spatially resolved image, and wherein the fill level of the respective coin tube is determined from the ratio between the inner or outer diameter of the respective coin tube in the spatially resolved image and the respective detected diameter of the uppermost coin filled into the coin tube.

Correspondingly, it is also possible that one common spatially resolving optical sensor, disposed in a defined distance above the respective coin tube and directed onto the upper side of the respective coin tube, is associated with several or all of the coin tubes, wherein the common spatially resolving optical sensor captures at least one spatially resolved image of the upper side of the associated coin tube, each of the spatially resolved images is transmitted to the evaluation unit, and the evaluation unit evaluates each of the spatially resolved images by means of image processing, wherein the diameter of the uppermost coin filled into the respective coin tube is determined in the spatially resolved image, and wherein the fill level of the respective coin tube is determined from the ratio between the inner or outer diameter of the respective coin tube in the spatially resolved image and the respective detected diameter of the uppermost coin filled into the coin tube. Using one common spatially resolving optical sensor can reduce complexity and costs.

According to a further embodiment, the common spatially resolving optical sensor, associated to the several or all of the coin tubes, can be optically connected to the coin tubes via one fiber optic cable at a time. By doing so, the common optical sensor can capture a spatially resolved image from each of the coin tubes in a particularly simple and reliable way. The endoscope principle is used in this. Each of the fiber optic cables, for instance one glass fiber at a time, is then placed above the respective coin tube such that the common optical sensor captures a spatially resolved image of each of the coin tubes. Fish eye lenses can be mounted in addition in front of the respective fiber optic cables like described above, in particular in the region above the respective coin tube.

It is possible that the common spatially resolving optical sensor, associated with the several or all of the coin tubes, captures the spatially resolved images of the upper sides of the associated coin tubes consecutively. Nevertheless, it is also possible that the common spatially resolving optical sensor, associated with the several or all of the coin tubes, captures the spatially resolved images of the upper sides of the associated coin tubes simultaneously, wherein the spatially resolved images are captured on different areas of the image sensor of the optical sensor. In an embodiment, the sensor surface of the optical sensor is subdivided into different areas, wherein for instance the fiber optic cables are directed towards the individual areas such that each area captures the spatially resolved image of one of the coin tubes. The evaluation unit can separate these measurement signals from each other in the course of the evaluation, and discriminate the individual spatially resolved images in the overall measurement of the optical sensor and associate them to the individual coin tubes for fill level determination.

The device according to the present disclosure is particularly suitable and adapted for performing the method. This applies in particular to the at least one optical sensor and the evaluation unit. Correspondingly, the method of the present invent can be performed using the device of this disclosure.

According to an embodiment, this disclosure achieves the goal by a method for determining the fill level of at least one coin tube that can be filled with coins and which has one or several marks on its inner wall. The method comprises capturing at least one spatially resolved image of the upper side of the at least one coin tube with a spatially resolving optical sensor. The spatially resolving optical sensor is disposed at a defined distance above the at least one coin tube and directed towards the upper side of the at least one coin tube. Transmitting the at least one spatially resolved image to an evaluation unit. Evaluating the at least one spatially resolved image by the evaluation unit by means of image processing. One or several of the marks on the inner wall of the at least one coin tube which are not covered by coins filled into the coin tube are identified, and the fill level of the at least one coin tube is determined from this.

Moreover, according to another embodiment, this disclosure achieves the goal by a device for determining the fill level of at least one coin tube that can be filled with coins and, which has one or several marks on its inner wall. The device comprises at least one spatially resolving optical sensor arranged at a defined distance above the at least one coin tube and directed onto the upper side of the at least one coin tube for capturing at least one spatially resolved image of the upper side of the at least one coin tube. An evaluation unit, wherein the at least one spatially resolving optical sensor is connected to the evaluation unit for transmitting the at least one spatially resolved image. The evaluation unit is configured to evaluate the at least one spatially resolved image to identify one or several marks on the inner wall of the respective coin tube which are not covered by coins filled into the respective coin tube. The evaluation unit is configured to determine the fill level of the at least one coin tube from this.

The at least one coin tube can be realized like explained above with respect to the first aspect of this disclosure. The at least one coin tube may be circular or cylindrical. The coin tubes are open at the topside, and the coin tubes are filled into the coin tube being stacked atop each other. The at least one optical sensor can also be realized like explained above with respect to the first aspect of this disclosure. The at least one optical sensor looks into the coin tube from the topside, in particular vertically from the topside in the axial direction of the coin tube. The at least one optical sensor records the coins present in the coin tube. In addition, it can also record the normally circular opening of the coin tube. Due to the perspective, the at least one optical sensor records, in addition, the inner wall of the at least one coin tube where it is not covered by coins that are present in the coin tube. The spatially resolved images captured by the at least one optical sensor are sent to the evaluation unit.

The evaluation unit identifies the mark(s) that is/are visible in that area of the inner wall of the at least one coin tube which is not covered by coins and was captured by the at least one optical sensor, and by means of the identified one or several mark(s) it determines the height of the filling of the at least one coin tube by coins, and from this the fill level of the at least one coin tube taking into account the known thickness of the coins which were filled into the respective coin tube. The evaluation of the filling height, and thus of the fill level is further simplified in this second aspect of this disclosure. Through a covering of the inner wall by the optical mark(s) as continuous as possible, it can again be made sure that each coin filled into the coin tube is recorded. For the rest, the same advantages result like in the first aspect of this disclosure, i.e., in particular independence from outer influences, high reliability of the fill level determination in a simple way under avoidance of a relevant blind range.

At least one spatially resolving sensor can be a spatially resolving imaging sensor, a spatially resolving CCD sensor or a spatially resolving CMOS sensor in particular. According to an embodiment, the marks may comprise several lines, spaced apart in the axial direction of the coin tube and extending vertically to the axial direction of the at least one coin tube on the inner wall of the at least one coin tube. According to an alternative or additional embodiment, the optical mark may comprise at least one line which extends helically along the inner wall of the at least one coin tube.

A fish eye lens can be mounted in front of the at least one spatially resolving sensor in order to increase the resolution. The fill level of a plurality of coin tubes can be determined by the method or respectively the device according to an aspect of this disclosure. It is then possible that one own spatially resolving optical sensor, disposed in a defined distance above the respective coin tube and directed onto the upper side of the respective coin tube is associated to each one of the coin tubes, wherein each of the spatially resolving optical sensors captures at least one spatially resolved image of the upper side of the respective coin tube. Each of the spatially resolved images is transmitted to the evaluation unit and is evaluated by the evaluation unit by means of image processing. One or several marks on the inner wall of the respective coin tube which are not covered by coins filled into the respective coin tube are identified, and the fill level of the at least one coin tube is determined from this.

It is also possible however that one common spatially resolving optical sensor disposed in a defined distance above the respective coin tube and directed onto the upper side of the respective coin tube is associated to several or all of the coin tubes. The common spatially resolving optical sensor captures at least one spatially resolved image of the upper side of the associated coin tubes. Each of the spatially resolved images is transmitted to the evaluation unit and is evaluated by the evaluation unit by means of image processing. One or several marks on the inner wall of the respective coin tube which are not covered by coins filled into the respective coin tube are identified at a time and the fill level of the at least one coin tube is determined from this.

The common spatially resolving optical sensor, associated with the several or all of the coin tubes, can be optically connected to the coin tubes via one fiber optic cable at a time. Fish eye lenses can be mounted additionally in front of the respective optical fiber cables, in the area above the respective coin tube in particular. The common spatially resolving optical sensor, associated to the several or all of the coin tubes, may capture the spatially resolved images of the upper sides of the associated coin tubes simultaneously, wherein the spatially resolved images are captured on different areas of the image sensor of the optical sensor. It is possible that the common spatially resolving optical sensor, associated to the several or all of the coin tubes, captures the spatially resolved images of the upper sides of the associated coin tubes consecutively. The device according to this disclosure, in particular the at least one optical sensor or the evaluation unit, can be suited for performing the method according to the second aspect. Correspondingly, the method according to the second aspect of this disclosure can be performed by the device according to the second aspect of this disclosure. It is also possible to combine embodiments according to the first aspect of this disclosure and embodiments according to the second aspect of this disclosure.

Moreover, the present disclosure relates to a coin storage device for storing and/or paying out coins, comprising one or several coin tubes that can be filled with coins, and comprising a device according to the present disclosure. The coin storage device may be a moneychanger in particular, which is used in pay stations or other payment apparatuses. It has a coin inlet, through which coins are supplied to a coin-testing device of the moneychanger. The genuineness and the type of the respective supplied coins are tested in the coin-testing device. Depending on the test result, the coins are then filled into the coin tubes provided for the respective coin type, or fed to an outlet if no genuineness was found. The coin tubes are normally located below the coin-testing device. The optical radiation senders and optical radiation receivers as well as the control and evaluation units according to the present disclosure may then be integrated into the coin-testing device.

According to a further embodiment, it may be provided that the testing device performs a payout of coins from the coin tubes by means of fill levels determined for the individual coin tubes in such a way that the fill levels in the coin tubes do not fall below a respective given minimum value. Thus, there will be an intelligent coin management due the measurement results of the sensor technology of this disclosure. By giving out certain coins, the coin changer can influence the fill levels of the individual coin tubes within certain limits, such that there will be enough coins of every coin type. If the number of coins in one of the coin tubes falls below the given minimum value, the coin changer can emit a warning signal.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication or interaction between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable medium” includes any type of medium capable of being accessed by a computer, such as read only memory (ROM), electrically erasable programmable read only memory (EEPROM/E2PROM), random access memory (RAM), ferroelectric RAM (FRAM), a hard disk drive, a compact disc (CD), a digital video disc (DVD), or any other type of volatile/non-volatile/memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIGS. 1A-1D illustrate examples of unattended payment systems according to various embodiments of the present disclosure;

FIGS. 2A-2I illustrate examples of banknote acceptors according to various embodiments of the present disclosure;

FIGS. 3A-3D illustrate examples of coin acceptors according to various embodiments of the present disclosure;

FIG. 4 illustrates an example of a banknote acceptor with a pre-scan imaging sensor according to various embodiments of the present disclosure;

FIGS. 5A-5E illustrate examples of banknote acceptor with a pre-scan imaging sensor according to various embodiments of the present disclosure;

FIG. 6 illustrates an example banknote acceptor with a pre-scan imaging sensor according to various embodiments of the present disclosure;

FIG. 7 illustrates an example banknote acceptor with a pre-scan imaging sensor according to various embodiments of the present disclosure;

FIG. 8 illustrates an example of a banknote acceptor with a pre-scan imaging sensor according to one of the embodiments of the present disclosure;

FIG. 9 illustrates an example of a banknote acceptor with a pre-scan imaging sensor according to various embodiments of the present disclosure;

FIG. 10 illustrates an example of a banknote acceptor with a pre-scan imaging sensor according to various embodiments of the present disclosure;

FIGS. 11A-11J illustrate examples of payment acceptors according to various embodiments of the present disclosure;

FIG. 12 illustrates an example payment acceptor with a pre-scan imaging sensor according to various embodiments of the present disclosure;

FIG. 13 illustrates an example payment acceptor with a pre-scan imaging sensor according to various embodiments of the present disclosure;

FIG. 14 illustrates an example payment acceptor with a pre-scan imaging sensor according to various embodiments of the present disclosure;

FIG. 15 illustrates a process of operation of a banknote acceptor or a payment acceptor with a pre-scan imaging sensor according to various embodiments of the present disclosure;

FIGS. 16A and 16B illustrate an example banknote imaging system according to various embodiments of this disclosure;

FIGS. 17A-17C illustrate an example coin imaging system according to various embodiments of this disclosure;

FIGS. 18A-18C illustrate examples of image types in accordance with various embodiments of this disclosure;

FIG. 19 illustrates an example banknote detection process in accordance with various embodiments of this disclosure;

FIG. 20 illustrates an example coin detection process in accordance with various embodiments of this disclosure;

FIGS. 21A-21C illustrate an example coin imaging system according to various embodiments of the present disclosure;

FIG. 22 illustrates an example of images of a genuine coin reproduced by a coin imaging system according to various embodiments of the present disclosure;

FIG. 23 illustrates an example of images of a counterfeit coin reproduced by a coin imaging system according to various embodiments of the present disclosure;

FIGS. 24A-24C illustrate examples of a coin tube imaging system according to various embodiments of the present disclosure;

FIG. 25 illustrates an example top view of a coin tube in accordance with various embodiments of the present disclosure;

FIG. 26 illustrates an example cross-section of an interior of a coin tube according to various embodiments of the present disclosure;

FIGS. 27A-27C illustrate example images of a coin tube captured by an imaging sensor according to various embodiments of the present disclosure;

FIG. 28 illustrates an example coin tube imaging process according to various embodiments of the present disclosure;

FIGS. 29A-29F illustrate various examples of jammed or improperly placed coins in a coin tube in accordance with various embodiments of the present disclosure;

FIG. 30 illustrates an example of jammed or improperly placed coins in a coin hopper in accordance with various embodiments of the present disclosure;

FIGS. 31A-31D illustrate various examples of jammed or improperly places coins in a coin track in accordance with various embodiments of the present disclosure;

FIG. 32 illustrates an example banknote recycling system for providing audit integrity in accordance with various embodiments of this disclosure;

FIG. 33 illustrates example banknote data in accordance with various embodiments of this disclosure;

FIG. 34 illustrates an example banknote audit integrity process in accordance with various embodiments of this disclosure;

FIG. 35 illustrates an example banknote cashbox in accordance with various embodiments of this disclosure;

FIG. 36 illustrates an example banknote cashbox identification process in accordance with various embodiments of this disclosure;

FIG. 37 illustrates an example banknote dispensing unit in accordance with various embodiments of this disclosure;

FIG. 38 illustrates an example banknote dispensing unit identification process in accordance with various embodiments of this disclosure;

FIG. 39 illustrates an example electronic device in accordance with various embodiments of this disclosure; and

FIG. 40 illustrates another example electronic device in accordance with various embodiments of this disclosure.

Many of the disclosed concepts are discussed with reference to the representative currency processing systems depicted in the drawings. However, the novel aspects and features of the present disclosure are not per se limited to the particular arrangements and components presented in the drawings. It should also be understood that the drawings are not necessarily to scale and are provided purely for descriptive purposes; thus, the individual and relative dimensions and orientations presented in the drawings are not to be considered limiting.

### DETAILED DESCRIPTION

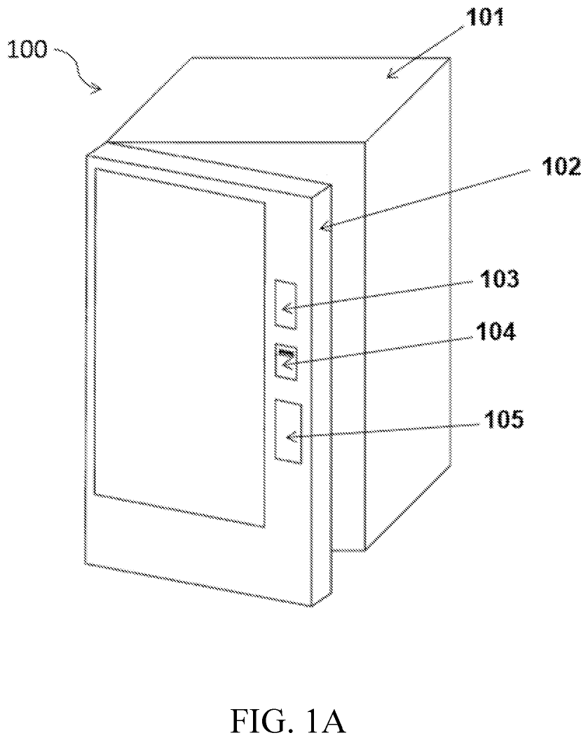

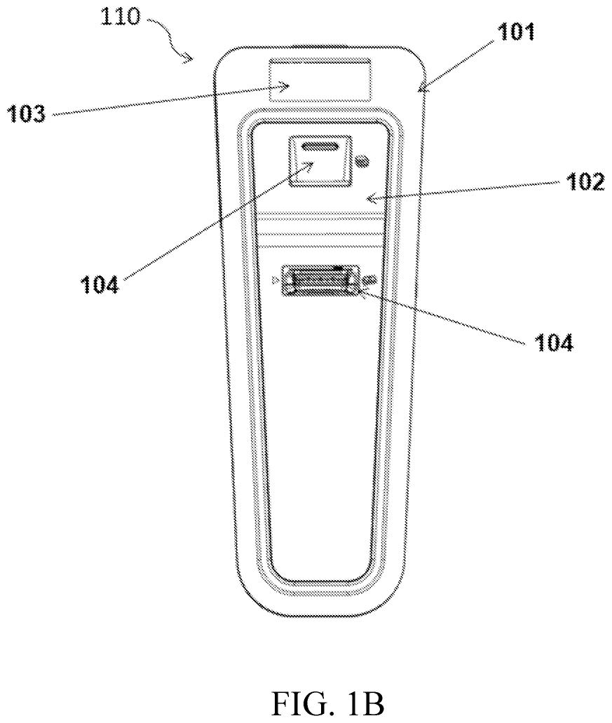

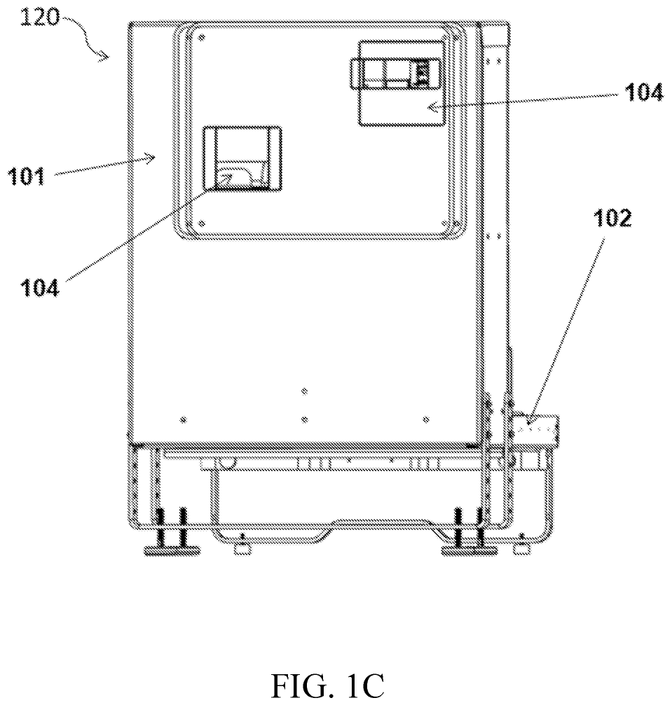

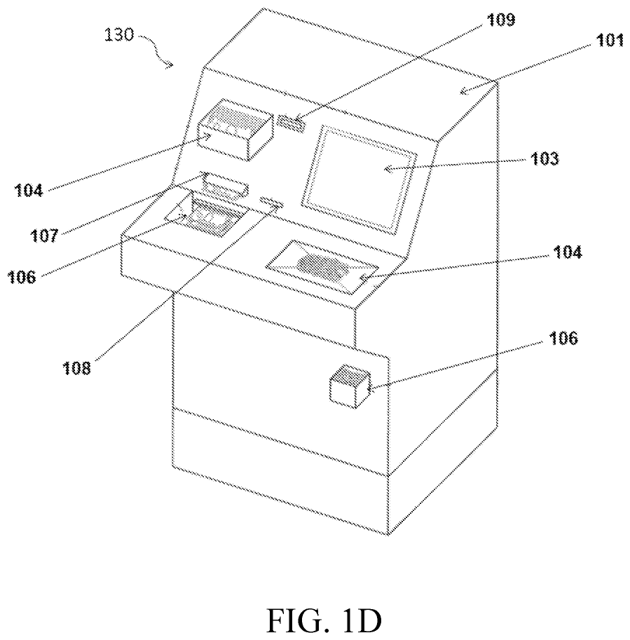

FIGS. 1A through 40, discussed below, and the various embodiments used to describe the principles of the present invention in this patent document are by way of illustration only and should not be construed in any way to limit the scope of the disclosure. Those skilled in the art will understand that the principles of this disclosure may be implemented in any suitably arranged device or system.

As used throughout this specification, the terms currency denomination, denomination of currency, valuable document, currency bill, bill, banknote, note, bank check, paper money, paper currency, coin, coinage, and cash may be used interchangeably herein to refer to a type of a negotiable instrument or any other writing that evidences a right to the payment of a monetary obligation, typically issued by a central banking authority. Payment acceptor and coin acceptor may be used interchangeably herein to refer to a type of monetary acceptor unit that may verify inserted banknote in a banknote acceptor or coin in coin acceptor. Payment acceptor may comprise both a banknote acceptor and coin acceptor and other electronic payment acceptance devices. Payment acceptor may include either of a banknote acceptor or a coin acceptor; payment acceptor may or may not comprise electronic payment acceptance devices.

FIG. 1A is a perspective view illustrating an unattended payment system 100 according to various embodiments of the present disclosure. The unattended payment system 100 shown in FIG. 1A is for illustration only. Other unattended payment systems could be used without departing from the scope of the present disclosure.

The unattended payment system 100 includes a cabinet 101 and a service door 102 that, together, define an enclosure. As illustrated in FIG. 1A, the service door 102 is pivotally mounted to the front of the cabinet 101 and extends across the front face of the unattended payment system 100. In some embodiments, the service door 102 may extend only partway across the front of the unattended payment system or may be formed in two portions (of equal or unequal sizes) that swing open in opposite directions. In some embodiments, the service door 102 may slide open.

The service door 102 includes a user interface or display device 103, illustrated as a touch screen liquid crystal display (LCD) display. A payment system 104 is mounted within the service door 102 and includes one or more of a banknote acceptor, a coin acceptor and/or a credit card reader or debit card reader. The payment system 104 receives currency, coins or other forms of payment from a user and returns change as necessary. The unattended payment system 100 also includes an access port 105 to a delivery receptacle mounted within the service door 102 or in the cabinet 101. The access port 105 may have a delivery door or other mechanical system (e.g., a rotatable delivery receptacle on one side) for controlling or restricting access by a user into the delivery receptacle, an interior of the unattended payment system, or both. The access port 105 may be located near the bottom of the unattended payment system and extend across most of the width of the machine, below a large glass window allowing the contents within the cabinet to be viewed or a large liquid crystal display selectively presenting images of products or services available for sale or advertisements. In some embodiments, one or more of the user interface 103, the payment system 104 and the access port 105 could be part of the cabinet. The display device 103 is, in various embodiments, a cathode ray tube (CRT), a high-resolution liquid crystal display (LCD), a plasma display, a light emitting diode (LED) display, a DLP projection display, an electroluminescent (EL) panel, or any other type of display suitable for use in the currency processing machine 13. A touch screen, which has one or more user-selectable soft touch keys, may be mounted over the display device 103.

FIG. 1B is a front view illustrating an unattended payment system 110 according to various embodiments of the present disclosure. The unattended payment system 110 shown in FIG. 1B is for illustration only. Other unattended payment systems could be used without departing from the scope of the present disclosure.

The unattended payment system 110 includes a cabinet 101 and a service door 102 that, together, define an enclosure. The service door 102 is pivotally mounted to the front of the cabinet 101. The cabinet 101 includes a user interface 103, illustrated as a touch screen liquid crystal display (LCD) display. In some embodiments, the user interface 103 accepts contactless payment. Payment systems 104 are mounted behind the service door 102 and include one or more of a banknote acceptor, a coin acceptor and/or a credit card reader or debit card reader. Payment systems 104 receive currency, coins or other forms of payment from a user and returns change as necessary. The display device 103 is, in various embodiments, a cathode ray tube (CRT), a high-resolution liquid crystal display (LCD), a plasma display, a light emitting diode (LED) display, a DLP projection display, an electroluminescent (EL) panel, or any other type of display suitable for use in the currency processing machine 13. A touch screen, which has one or more user-selectable soft touch keys, may be mounted over the display device 103.

FIG. 1C is a perspective view illustrating an unattended payment system 120 according to various embodiments of the present disclosure. The unattended payment system 120 shown in FIG. 1C is for illustration only. Other unattended payment systems could be used without departing from the scope of the present disclosure.

The unattended payment system 120 includes a cabinet 101 and a service door 102 that, together, define an enclosure. The service door 102 is pivotally mounted to the back of the cabinet 101. Payment systems 104 are mounted inside the cabinet 101 and include one or more of a banknote acceptor, a coin acceptor and/or a credit card reader or debit card reader. Payment systems 104 receive currency, coins or other forms of payment from a user and returns change as necessary. The service door allows access to the payment systems 104 from the back of the unattended payment system 120.

FIG. 1D illustrates an example of a currency processing system, designated generally as 130, in accordance with aspects of the present disclosure. The currency processing system 130 is a hybrid redemption-type and deposit-type currency processing machine with which funds may be deposited into and returned from the machine, in similar or different forms, in whole or in part, and/or funds may be credited to and withdrawn from a personal account. The currency processing machine 130 illustrated in FIG. 1D includes a housing 101 that may house various input devices, output devices, and input/output devices. By way of non-limiting example, the currency processing machine 130 includes a display device 103 that may provide various input and output functions, such as displaying information and instructions to a user and receiving selections, requests, and other forms of inputs from a user. The display device 103 is, in various embodiments, a cathode ray tube (CRT), a high-resolution liquid crystal display (LCD), a plasma display, a light emitting diode (LED) display, a DLP projection display, an electroluminescent (EL) panel, or any other type of display suitable for use in the currency processing machine 130. A touch screen, which has one or more user-selectable soft touch keys, may be mounted over the display device 103. While a display device 103 with a touchscreen may be a preferred means for a user to enter data, the currency processing machine 130 may include other known input devices, such as a keyboard, mouse, joystick, microphone, etc.

The currency processing machine 130 includes a coin and/or banknote input area 104. The coin and/or banknote input area 104 can be a bin or tray, which receives batches of coins from a user. Each coin batch may be of a single denomination, a mixed denomination, a local currency, or a foreign currency, or any combination thereof. Additionally, coin and/or banknote input area 104 may be in the nature of a retractable pocket or basket, is also offered by the currency processing machine 130. The banknote input area 104, which is illustrated in its open position in FIG. 1, can be retracted by the currency processing machine 130 once the bulk currency has been placed therein by the user. In addition to banknotes, or as a possible alternative, the banknote receptacle 104 of the currency processing machine 130 can also be operable to accommodate casino scrip, paper tokens, bar coded tickets, or other known forms of value. These input devices—i.e., the currency input areas 104, allow the user of the currency processing machine 130 to input his or her funds, which can ultimately be converted to some other sort of fund source that is available to the user. Optionally or alternatively, the currency processing machine 130 can operate to count, authenticate, valuate, and/or package funds deposited by a user.

In addition to the above-noted output devices, the currency processing machine 130 may include various output devices 106, such as a banknote dispensing receptacle and a coin dispensing receptacle for dispensing to the user a desired amount of funds in banknotes, coins, or a combination thereof. An optional banknote return slot 107 or other banknote return slot (not shown) may also be included with the currency processing machine 130 to return notes to the user, such as those which are deemed to be counterfeit or otherwise cannot be authenticated or processed. Coins which cannot be authenticated or otherwise processed may be returned to the user via the coin dispensing receptacle 106 or other coin return slot (not shown). The currency processing machine 130 further includes a paper dispensing slot 108, which can be operable for providing a user with a receipt of the transaction that was performed.

In one representative transaction, the currency processing machine 130 receives funds from a user via the input area 104 and, after these deposited funds have been authenticated and counted, the currency processing machine 130 returns to the user an amount equal to the deposited funds but in a different variation of banknotes and coins. Optionally, the user may be assessed one or more fees for the transaction (e.g., service fees, transaction fees, etc.). For example, the user of the currency processing machine 130 may input $102.99 in various small banknotes and pennies and in turn receive a $100 banknote, two $1 banknotes, three quarters, two dimes, and four pennies. As another option or alternative, the currency processing machine 130 may simply output a voucher or a receipt of the transaction through the paper dispensing slot 108 which the user can then redeem for funds by an attendant of the currency processing machine 130. Yet another option or alternative would be for the currency processing machine 130 to credit some or all of the funds to a personal account, such as a bank account or store account. As yet another option, the currency processing machine 130 may credit some or all of the funds to a smartcard, gift card, cash card, virtual currency, etc.

The currency processing machine 130 may also include a media reader slot 109 into which the user inserts a portable medium or form of identification, such as a driver's license, credit card, or bank card, so that the currency processing machine 130 can, for example, identify the user and/or an account associated with the user. The media reader 109 may take on various forms, such as a ticket reader, card reader, bar code scanner, wireless transceiver (e.g., RFID, Bluetooth, etc.), or computer-readable-storage-medium interface. The display device 103 with a touchscreen typically provides the user with a menu of options which prompts the user to carry out a series of actions for identifying the user by displaying certain commands and requesting that the user press touch keys on the touch screen (e.g. a user PIN). The media reader device 109 of the illustrated example is configured to read from and write to one or more types of media. This media may include various types of memory storage technology such as magnetic storage, solid state memory devices, and optical devices. It should be understood that numerous other peripheral devices and other elements exist and are readily utilizable in any number of combinations to create various forms of a currency processing machine in accord with the present concepts.

Other unattended payment systems such as kiosks, cashier assisted payment terminals, self-service checkout terminals, parking meters, vending machines, gaming machines, ticketing machines, unattended lock safes, and automated teller machines may have additional components such as printers, keypads, audiovisual communication interfaces to facilitate user interaction.

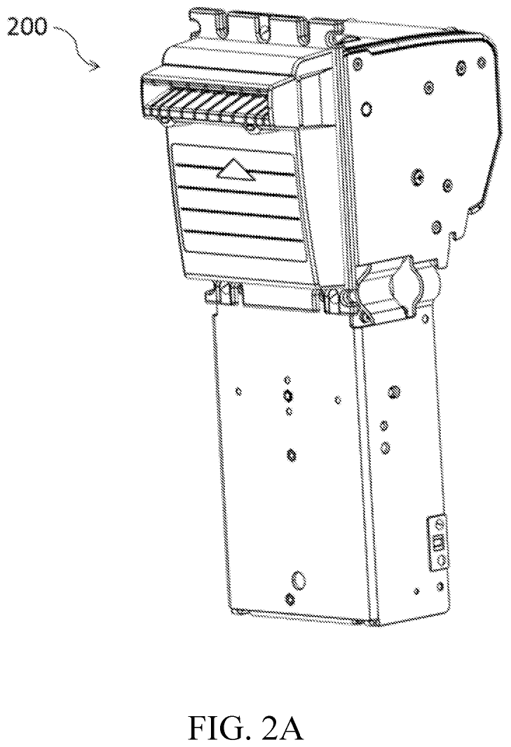

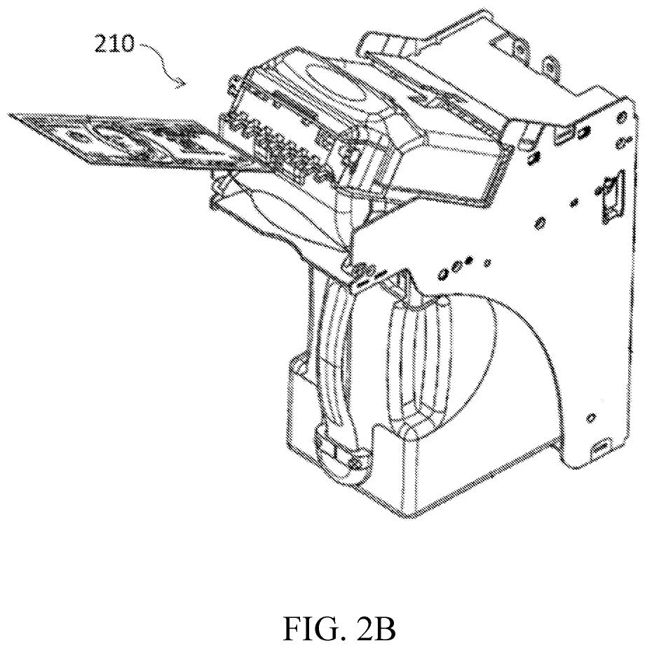

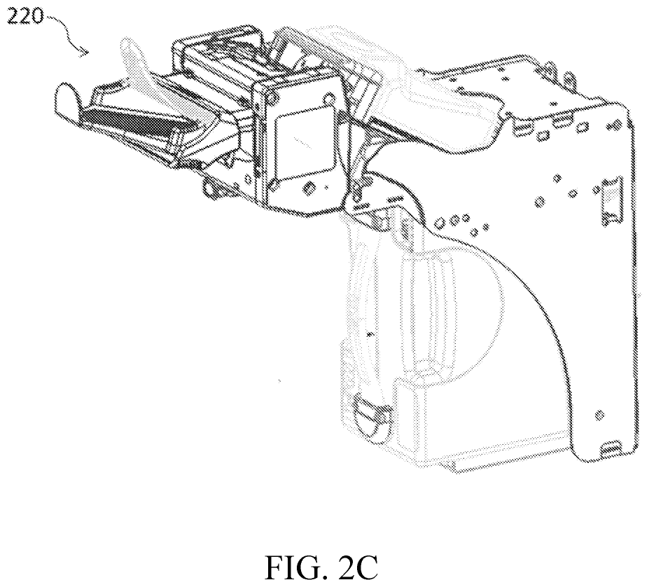

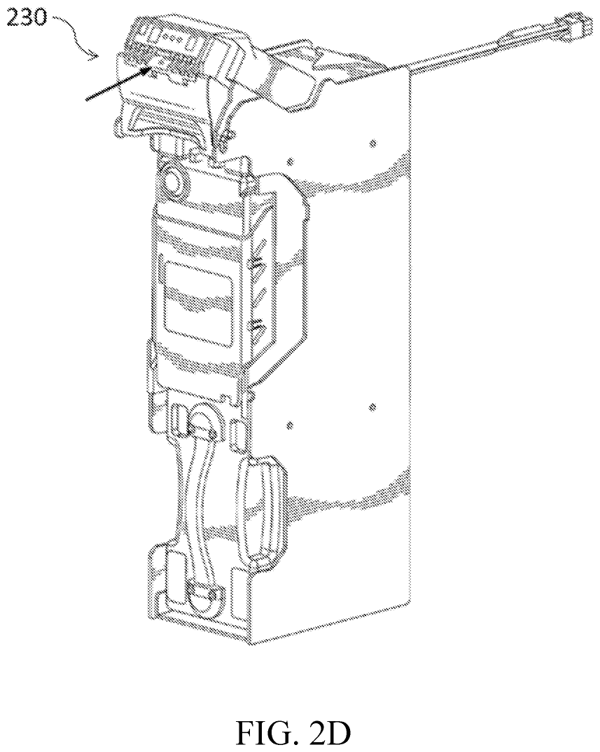

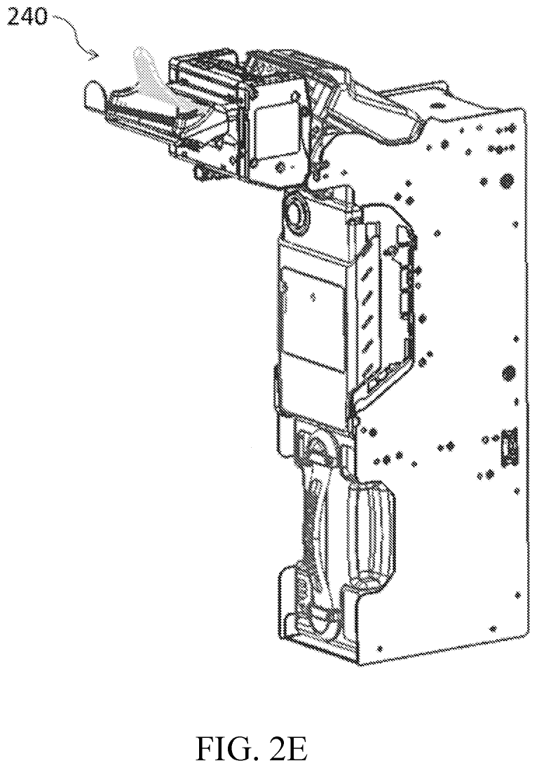

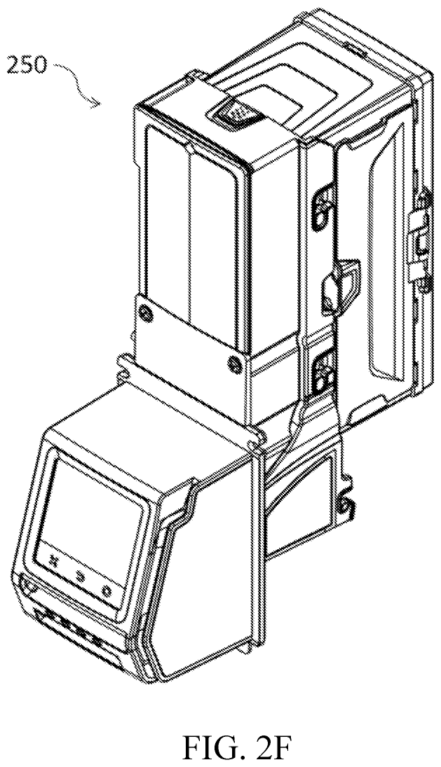

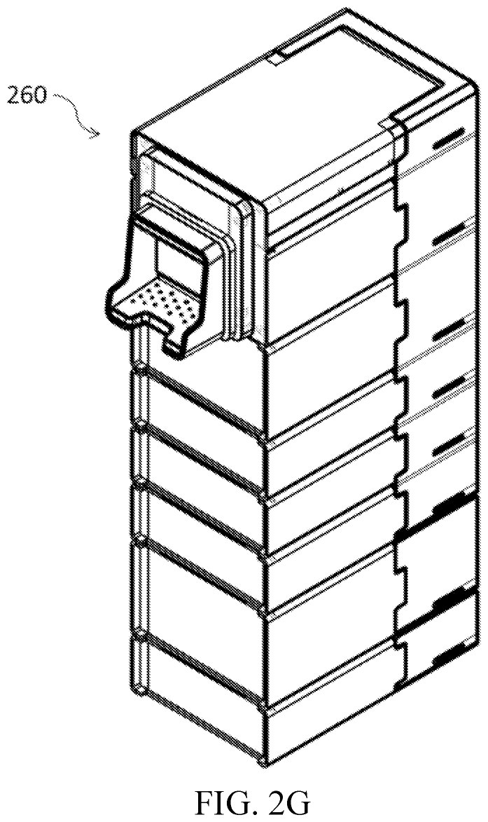

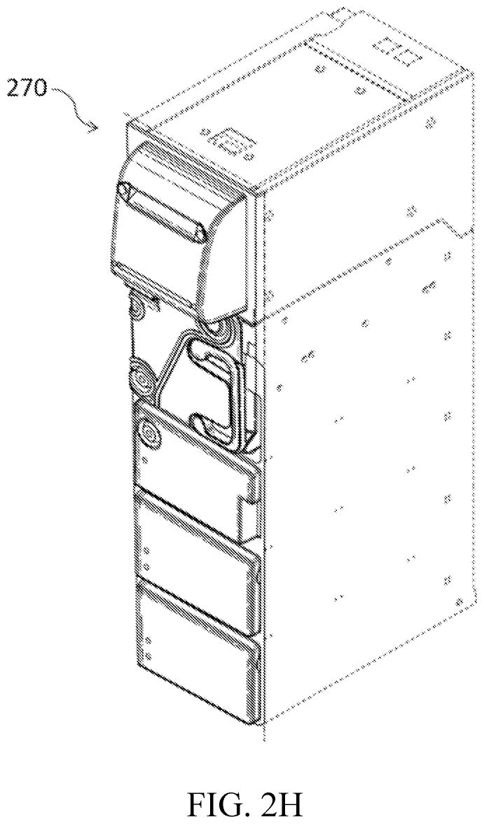

FIGS. 2A-2I illustrate examples of banknote acceptors 200-280 that may be used in the unattended payment system according to various embodiments of the present disclosure. Banknote acceptors 200-280 may include a bezel, a chassis, an acceptor head, a banknote transport mechanism, a banknote transport path, one or more sensors to verify genuineness of inserted banknotes, a banknote storage section, and/or a banknote acceptor-dispenser module. FIG. 2A illustrates an example of a banknote acceptor system 200 in accordance with various embodiments of the present disclosure. FIG. 2B illustrates an example of a banknote acceptor system 210 in accordance with various embodiments of the present disclosure. FIG. 2C illustrates an example of a banknote acceptor system 220 in accordance with various embodiments of the present disclosure. FIG. 2D illustrates an example of a banknote deposit-withdrawal system 230 in accordance with various embodiments of the present disclosure. FIG. 2E illustrates an example of a banknote deposit-withdrawal system 240 in accordance with various embodiments of the present disclosure. FIG. 2F illustrates an example of a banknote acceptor system 250 in accordance with various embodiments of the present disclosure. FIG. 2G illustrates an example of a banknote deposit-withdrawal system 260 in accordance with various embodiments of the present disclosure. FIG. 2H illustrates an example of a banknote deposit-withdrawal system 270 in accordance with various embodiments of the present disclosure. FIG. 2I illustrates an example of a banknote deposit-withdrawal system 280 in accordance with various embodiments of the present disclosure. Any of banknote acceptor or banknote deposit withdrawal systems 200-280 as described in FIGS. 2A-2I can be used in unattended payment systems 100-130 as described in FIGS. 1A-1D.

FIG. 2A shows a banknote acceptor system 200 configured to verify the authenticity of the inserted banknote. The banknote acceptor system 200 generally has an acceptor head, a banknote transport system and a removable banknote storage unit. Inserted banknotes are generally authenticated in a banknote accepting module using various sensors, once the banknote is deemed authentic and deemed acceptable the banknote is transported further into the banknote acceptor using the banknote transport system into the removable banknote storage unit.

FIG. 2B shows a banknote acceptor system 210 configured to verify the authenticity of the inserted banknote. The banknote acceptor system 210 generally has an acceptor head, a banknote transport system and a removable banknote storage unit. Inserted banknotes are generally authenticated in a banknote accepting module using various sensors, once the banknote is deemed authentic and deemed acceptable the banknote is transported further into the banknote acceptor using the banknote transport system into the removable banknote storage unit.

FIG. 2C illustrates a banknote acceptor system 220 in accordance with various embodiments of the present disclosure. FIG. 2C shows a banknote acceptor system 220 configured to receive multiple banknotes in bulk to verify the authenticity of the inserted banknotes in bulk. The banknote acceptor includes an adapter to accept banknotes in bulk, and has a banknote accepting module, a banknote transport system, and a removable banknote storage unit. Inserted banknotes are separated serially and sent to be authenticated in the banknote accepting module using various sensors. Once the banknote is deemed authentic and deemed acceptable, the banknote is transported further into the banknote acceptor using the banknote transport system and into the removable banknote storage unit.

FIG. 2D illustrates a banknote deposit-withdrawal system 230 in accordance with various embodiments of the present disclosure. In addition to a banknote accepting module, a banknote transport system, and a removable banknote storage unit as shown in FIG. 2B, the banknote deposit-withdrawal system 230 illustrated in FIG. 2D comprises a banknote recycling module that allows the unit to provide banknotes back to the customer. For example, the banknote deposit-withdrawal system 230 could be used in an automated payment system where a customer presents a high denomination banknote to purchase goods or services that are valued more than the value of purchased goods or services and the unit provides lower denomination banknotes to provide change to the customer to assist in completing the transaction. The recycling module may act as an escrow unit that holds the accepted document until the transaction is completed.

FIG. 2E illustrates a banknote deposit-withdrawal system 240 in accordance with various embodiments of the present disclosure. In addition to a banknote accepting module, a banknote transport system, and a removable banknote storage unit as shown in FIG. 2D, the banknote deposit-withdrawal system 240 illustrated in FIG. 2E comprises a banknote recycling module that allows the unit to provide banknotes back to the customer. For example, the banknote deposit-withdrawal system 240 could be used in an automated payment system where a customer presents a high denomination banknote to purchase goods or services that are valued more than the value of purchased goods or services and the unit provides lower denomination banknotes to provide change to the customer to assist in completing the transaction. The recycling module may act as an escrow unit that holds the accepted document until the transaction is completed.

FIG. 2F shows a banknote acceptor system 250 configured to verify the authenticity of the inserted banknote. The banknote acceptor system 250 generally has an acceptor head, a banknote transport system and a removable banknote storage unit. Inserted banknotes are generally authenticated in a banknote accepting module using various sensors, once the banknote is deemed authentic and deemed acceptable the banknote is transported further into the banknote acceptor using the banknote transport system into the removable banknote storage unit.

FIG. 2G illustrates a banknote deposit-withdrawal system 260 in accordance with various embodiments of the present disclosure. The banknote deposit-withdrawal system 260 includes a banknote accepting module, a banknote transport system and a removable banknote storage unit, an escrow module and multiple banknote recycling modules that allows the unit to provide banknotes back to the customer. For example, the banknote deposit-withdrawal system could be used in an automated payment system where a customer presents a high denomination banknote to purchase goods or services that are valued more than the value of purchased goods or services and the unit provides lower denomination banknotes to provide change to the customer to assist in completing the transaction. The escrow unit holds the accepted document until the transaction is completed.

FIG. 2H illustrates a banknote deposit-withdrawal system 270 in accordance with various embodiments of the present disclosure. The banknote deposit-withdrawal system 270 includes a banknote accepting module, a banknote transport system and a removable banknote storage unit and multiple banknote recycling modules that allows the unit to provide banknotes back to the customer. For example, the banknote deposit-withdrawal system could be used in an automated payment system where a customer presents a high denomination banknote to purchase goods or services that are valued more than the value of purchased goods or services and the unit provides lower denomination banknotes to provide change to the customer to assist in completing the transaction. The recycling module may act as an escrow unit that holds the accepted document until the transaction is completed.

FIG. 2I illustrates schematic of a banknote deposit-withdrawal system 280 in accordance with various embodiments of the present disclosure. The banknote deposit-withdrawal system 280 includes a banknote accepting head or module 202, a banknote sensing module 204, a banknote transport system and a removable banknote storage unit 206, an escrow module 208, and multiple banknote recycling modules 212 that allows the unit to provide banknotes back to the customer. For example, the banknote deposit-withdrawal system could be used in an automated payment system where a customer presents a high denomination banknote to purchase goods or services that are valued more than the value of purchased goods or services and the unit provides lower denomination banknotes to provide change to the customer to assist in completing the transaction. The escrow unit 208 holds the accepted document until the transaction is completed.

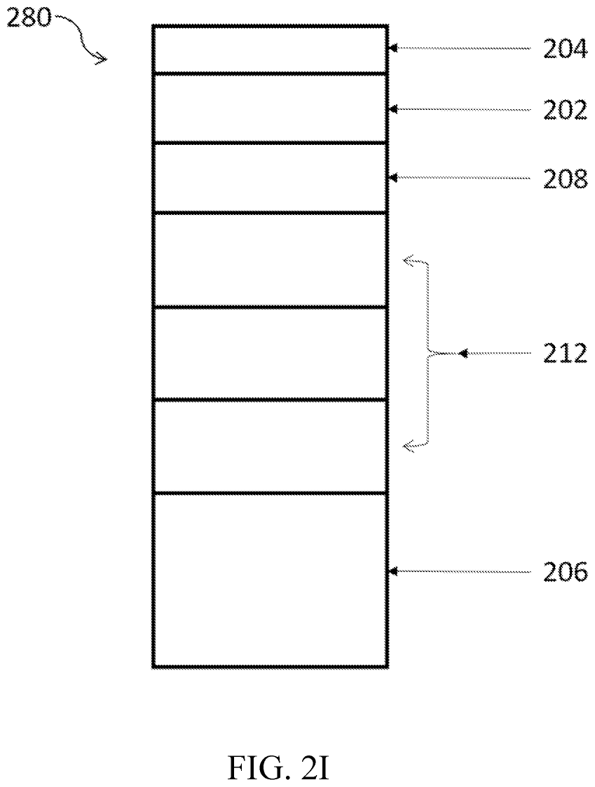

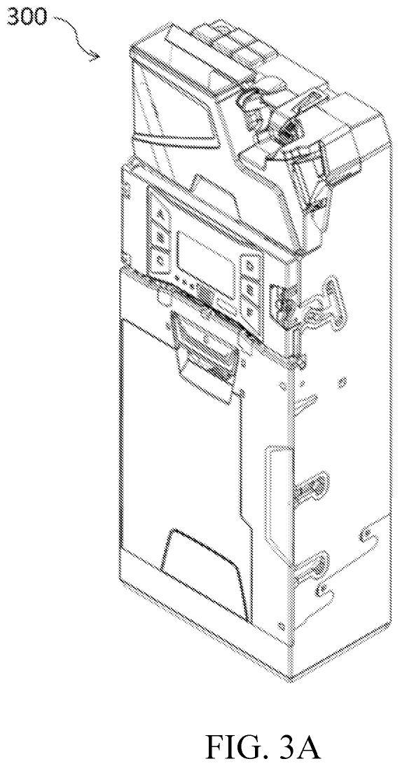

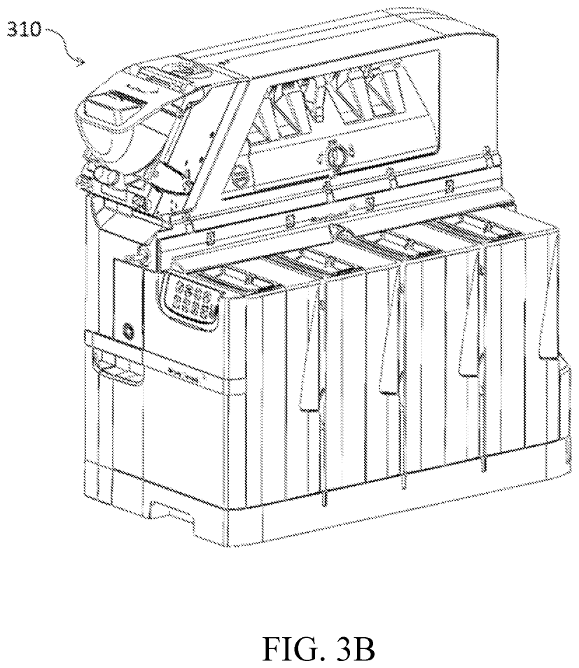

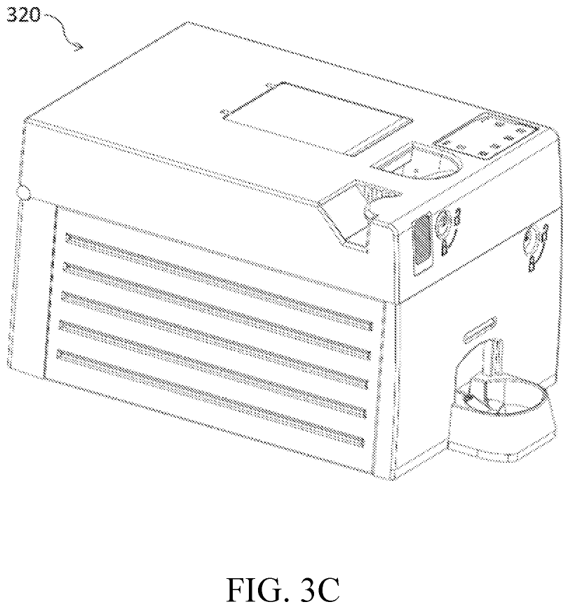

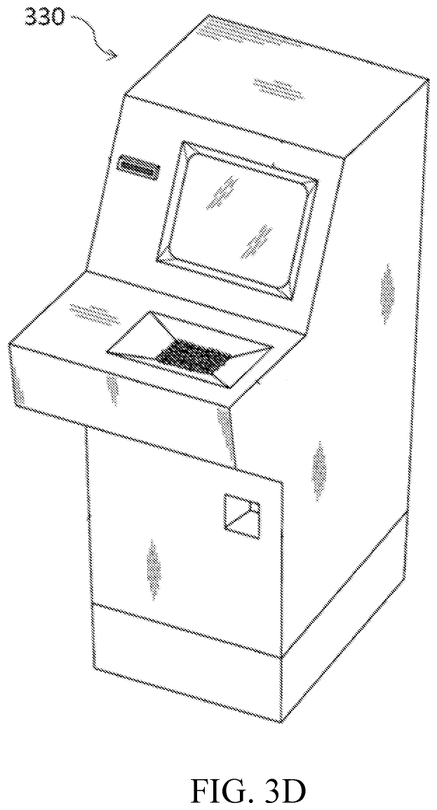

FIGS. 3A-3D illustrate examples of coin acceptors 300-330 that may be used in the unattended payment system according to various embodiments of the present disclosure. Coin acceptors 300-330 may include a bezel, a chassis, an acceptor head, a coin transport mechanism, a coin transport path, one or more sensors to verify genuineness of inserted coins, a coin storage section, and/or a coin acceptor-dispenser module. FIG. 3A illustrates an example of a coin acceptor system 300 in accordance with various embodiments of the present disclosure. FIG. 3B illustrates an example of a coin acceptor system 310 in accordance with various embodiments of the present disclosure. FIG. 3C illustrates an example of a coin acceptor system 330 in accordance with various embodiments of the present disclosure. FIG. 3D illustrates an example of a coin acceptor system 330 in accordance with various embodiments of the present disclosure. Coin acceptors described in FIGS. 3A-3D can also be identified as coin changers, coin recyclers, coin deposit withdrawal systems or coin acceptor dispensers. Any of coin acceptors 300-330 as described in FIGS. 3A-3D can be used in unattended payment systems 100-130 as described in FIGS. 1A-1D.

FIG. 3A shows a coin acceptor system 300 configured to verify the authenticity of the inserted coin. The coin acceptor system 300 generally has an acceptor head, a coin transport system, coin tubes and a removable coin storage unit. Inserted coins are generally authenticated in a coin accepting module using various sensors, once the coin is deemed authentic and deemed acceptable the coin is transported further into the coin acceptor using the coin transport system into either one of the coin tubes or the removable coin storage unit. The coin tubes in the coin acceptor holds coins to provide change to user of the coin acceptor. This ability to provide change to user allows the coin acceptor to operate for longer duration as fewer lower value coins are routed to the removable coin storage unit, preventing the removable coin storage unit from filling up and putting the coin acceptor out of operation.

FIG. 3B shows a coin acceptor system 310 configured to verify the authenticity of the inserted coin. The coin acceptor system 310 generally has an acceptor head, a coin transport system, coin hoppers and a removable coin storage unit. Inserted coins are generally authenticated in a coin accepting module using various sensors, once the coin is deemed authentic and deemed acceptable the coin is transported further into the coin acceptor using the coin transport system into either one of the coin hoppers or the removable coin storage unit. The coin hoppers in the coin acceptor holds coins to provide change to user of the coin acceptor. This ability to provide change to user allows the coin acceptor to operate for longer duration as fewer lower value coins are routed to the removable coin storage unit, preventing the removable coin storage unit from filling up and putting the coin acceptor out of operation.

FIG. 3C shows a coin acceptor system 320 configured to verify the authenticity of the inserted coin. The coin acceptor system 320 generally has an acceptor head, a coin transport system, coin hoppers and a removable coin storage unit. Inserted coins are generally authenticated in a coin accepting module using various sensors, once the coin is deemed authentic and deemed acceptable the coin is transported further into the coin acceptor using the coin transport system into either one of the coin hoppers or the removable coin storage unit. The coin hoppers in the coin acceptor holds coins to provide change to user of the coin acceptor. This ability to provide change to user allows the coin acceptor to operate for longer duration as fewer lower value coins are routed to the removable coin storage unit, preventing the removable coin storage unit from filling up and putting the coin acceptor out of operation.

FIG. 3D shows a coin acceptor system 330 configured to verify the authenticity of the inserted coin. The coin acceptor system 330 generally has an acceptor head, a coin transport system and a removable coin storage unit. Inserted coins are generally authenticated in a coin accepting module using various sensors, once the coin is deemed authentic and deemed acceptable the coin is transported further into the coin acceptor using the coin transport system into the removable coin storage unit.

Any of banknote acceptor or banknote deposit withdrawal systems 200-280 as described in FIGS. 2A-2I and any of coin acceptors 300-330 as described in FIGS. 3A-3D can be used in unattended payment systems 100-130 as described in FIGS. 1A-1D. Any of banknote acceptor or banknote deposit withdrawal systems 200-280 can be combined with any of coin acceptors 300-330 to form a part of unattended payment systems 100-130 depending upon various performance and cost requirements.

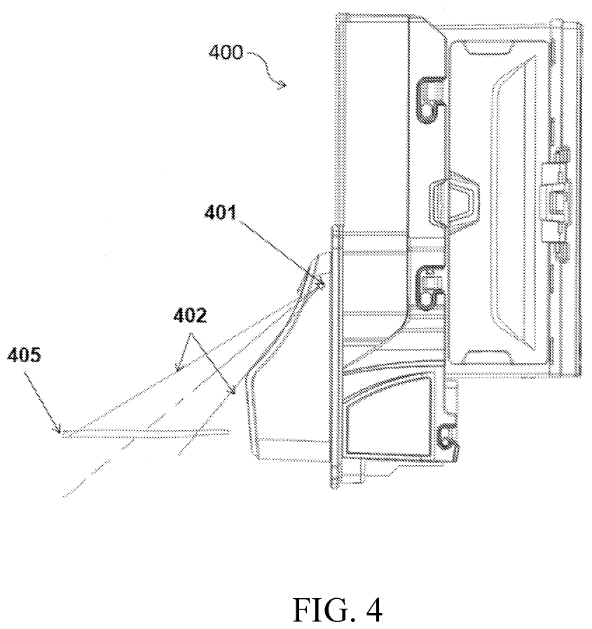

FIG. 4 illustrates an example of a banknote acceptor 400 with a pre-scan imaging sensor according to various embodiments of the present disclosure. The banknote acceptor 400 could be one of, or a component of, any of banknote acceptor or banknote deposit withdrawal systems 200-280 as described in FIGS. 2A-2I.

The banknote acceptor 400 comprises a pre-scan imaging sensor 401 that monitors the entrance of the banknote acceptor for objects that may be inserted. A field of view 402 of the pre-scan imaging sensor comprises space adjacent to a banknote acceptor path entrance to check if an object 405 is present. If the object 405 to be inserted is a banknote then a banknote transport mechanism may be initiated. In addition, the pre-scan imaging sensor 401 can also identify the denomination of a banknote 405 from an image and adjust a size throughout a banknote acceptor path to accommodate a banknote.

If a user attempts to insert a credit/debit card or a non-banknote object 405 such as a cardboard cut up or other objects that may not appear to be a flexible sheet, then a banknote transport mechanism is not initiated. This avoidance of initiation of a banknote transport mechanism prevents a credit/debit card from entering deep into a banknote transport path where a banknote transport mechanism may not be able to push the credit/debit card successfully. Differences in flexibility and friction between thin film sheets such as banknotes, barcode coupons, or credit/debit cards are significant, leaving them stuck inside the banknote transport path once entered deep into the path. Start sensors used in banknote acceptors 400 generally detect a presence or absence of an object in a banknote transport path to initiate a banknote transport mechanism and then use sensors to detect validity of an inserted object. However, once these sensors determine that an inserted object is a credit/debit card, a user may no longer be able to pry the credit/debit card out of the banknote acceptor and a banknote transport mechanism is no longer able to push the credit/debit card out. This forces a banknote acceptor 400 of the unattended payment system 100-130 to go into service mode as it may not be able to accept banknotes and may require an expensive service technician visit. The pre-scan imaging sensor 401 can prevent insertion of a credit/debit card into a banknote transport path and provide access to a user, allowing a user to push the credit/debit card and then can pull the credit/debit card out once the user realizes there is an erroneous insertion. Presence of the pre-scan imaging sensor 401 can save technician expenses for the operator of the unattended payment system 100-130 from credit/debit card insertion into a banknote acceptor 400.

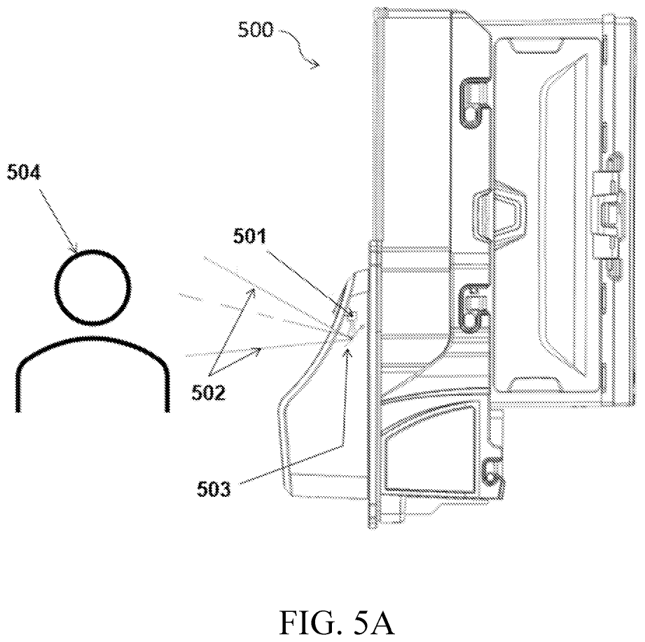

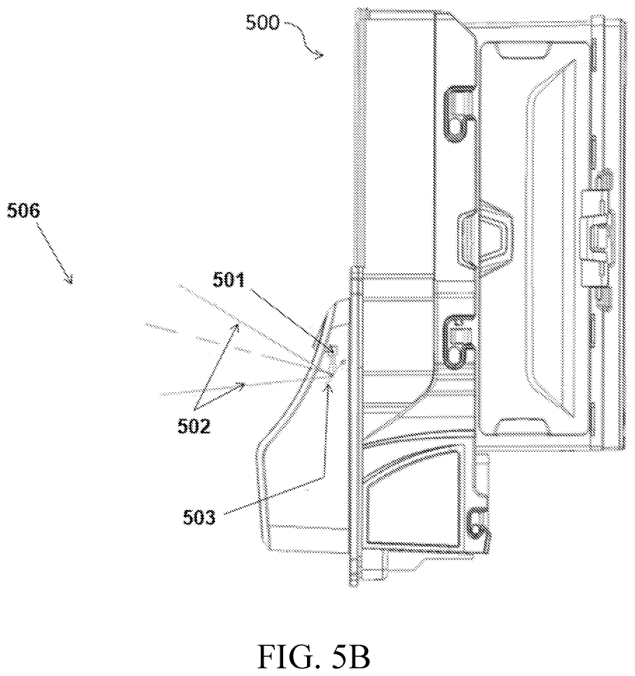

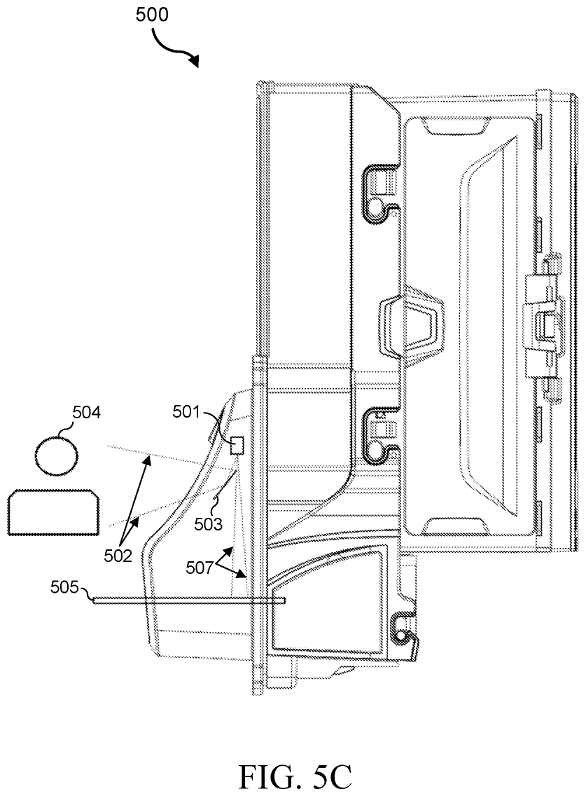

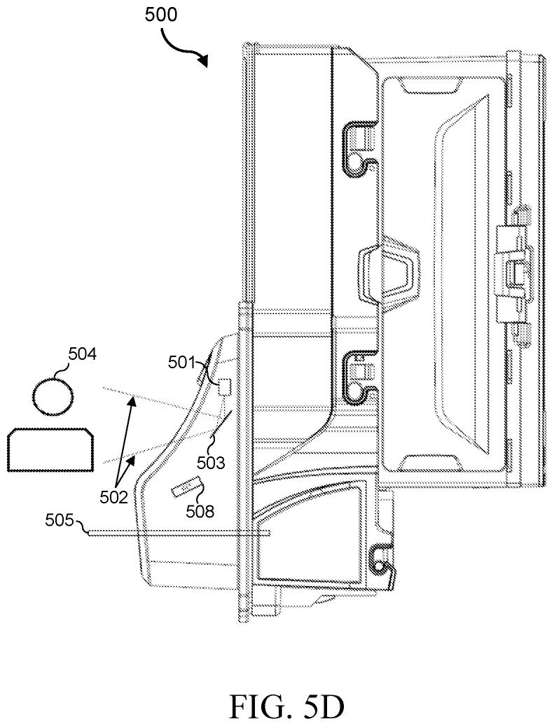

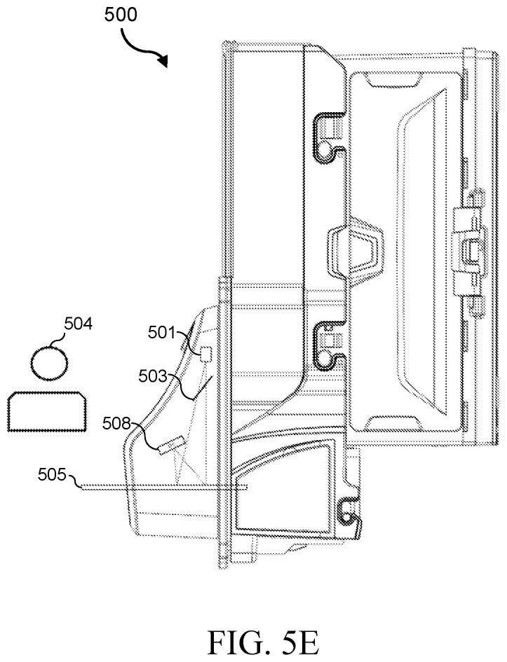

FIGS. 5A-5E illustrate examples of a banknote acceptor 500 with a pre-scan imaging sensor according to various embodiments of the present disclosure. The banknote acceptor 500 could be one of, or a component of, any of banknote acceptor or banknote deposit withdrawal systems 200-280 as described in FIGS. 2A-2I. The banknote acceptor 500 comprises a pre-scan imaging sensor 501 that may take pictures of a face of a user 504 inserting an object inside a banknote acceptor 500 of the unattended payment system. The pre-scan imaging sensor 501 in a combination of a mirror or other reflective or refractive surface 503 changes the field of view 502 from monitoring an entrance of a banknote acceptor 500 to take an image of the face of a user 504 inserting an object in a banknote acceptor. This image can then be stored in the memory of either a banknote acceptor 500 or the unattended payment system. This image of a user 504 can then be time-stamped and associated with an inserted object 505 or interaction with the unattended payment system.

This offers a unique low-cost benefit to operators of the unattended payment systems that are vulnerable to fraud and vandalism because of the opportunity for anonymous abuse, especially unattended payment systems that are located in areas without presence of surveillance imaging sensors or security personnel. This anonymity combined with a lack of injuries to other people makes fraud and vandalism difficult for operators to identify the culprit and forces operators to repair the unattended payment systems. The capacity to identify a culprit provided by the various embodiments of this disclosure can assist operators and law enforcement. Another benefit of identifying a culprit may be to trace the origin of fake banknotes designed to cheat banknote acceptors. While banknote acceptors can reject banknotes that may not meet predefined genuineness criteria based on preselected criteria, banknote acceptors may not distinguish between different classes of forgeries from simply an unacceptable banknote. Storing images of fake banknotes and associating them with a culprit may offer law enforcement persons to pursue culprits more efficiently.

Another benefit as shown in FIG. 5B is the ability to take pictures of a surrounding area 506 the unattended payment systems. Owners or operators of the unattended payment systems may not be aware of the actual operating condition or environmental factors affecting the visibility of the unattended payment systems. The pre-scan imaging sensor 501 placed in a banknote acceptor can provide information about foot traffic in a vicinity of the unattended payment system as well as if some other equipment is blocking access or visibility of the unattended payment system during time of heavy foot traffic, affecting opportunities for users to interact with the unattended payment system and bring revenue for the operator or owner. Information of actual operating conditions allows the operator to improve conditions to increase visibility by changing product selection, appearance, or simply moving the unattended payment system into a different area with heavier foot traffic.

As shown in FIG. 5C, a banknote acceptor 500 of an unattended payment system includes an inlet to allow insertion of an object 505, such as a banknote, into the banknote acceptor 500. The banknote acceptor includes at least one imaging sensor 501 configured to capture an image of the object 505 inserted in the banknote transport path, and capture an image of a user 504 while attempting to insert the object 505 into the inlet of the banknote acceptor 500.

In some embodiments, the banknote acceptor 500 includes one or more reflective and/or refractive surfaces 503 operable to change a field of view 502 of the at least one imaging sensor. In some embodiments, the reflective and/or refractive surfaces 503 allowing simultaneous monitoring of multiple noncontiguous regions by capturing images within the field of view 502 directed towards an outside area of the banknote acceptor 500 and a second field of view 507 directed towards the banknote inlet, to capture images of the object 505. In some embodiments, the at least one imaging sensor 501 is operable to move to capture the image of the user 504 attempting to insert the object 505 into the inlet of the banknote acceptor 500. In some embodiments, the at least one imaging sensor 501 is operable to move to capture images of the object 505 inserted in the banknote transport path. In some embodiments, the field of views 502, 507 for the at least one imaging sensor 501 includes the one or more reflective and/or refractive surfaces 503, such as a one-way transparent surface such as a partially silvered mirror or beam splitter.

As shown in FIGS. 5D and 5E, in some embodiments, the banknote acceptor is operable to wake up from a sleep mode if the at least one imaging sensor 501 detects insertion or detects attempted insertion of the object 505 into the inlet of the banknote acceptor. As shown in FIG. 5D, a light source 508, such as an LED, can be in an off state when the at least one imaging sensor 501 does not detect insertion of the object 505. When the light source 508 is in the off state, the banknote path may be dark and the at least one image sensor 501 captures images of external to the banknote acceptor 500 in the field of view 502. As shown in FIG. 5E, when the at least one image sensor 501 detects insertion of the object 505, the light source 508 is switched to an on state, emitting light in a direction towards an interior of the banknote inlet or banknote path and towards the object 505, illuminating an area of the banknote path in which the object 505 is present. The at least one image sensor 501 then captures images of the object 505. In some embodiments, the at least one image sensor 501 can capture images of the user and the inserted object simultaneously.

In some embodiments, the banknote acceptor 500 includes a memory, wherein the image of the user and the image of the inserted object are stored in the memory of the banknote acceptor 500. In some embodiments, the banknote acceptor 500 stores the image of the user and the image of the inserted object in a memory of the unattended payment system. In some embodiments, the banknote acceptor 500 includes at least one image sensor that is further configured to capture an image of an area surrounding the unattended payment system. In some embodiments, a size throughout of the banknote transport path of the banknote acceptor is modified to accommodate a denomination of the inserted banknote.

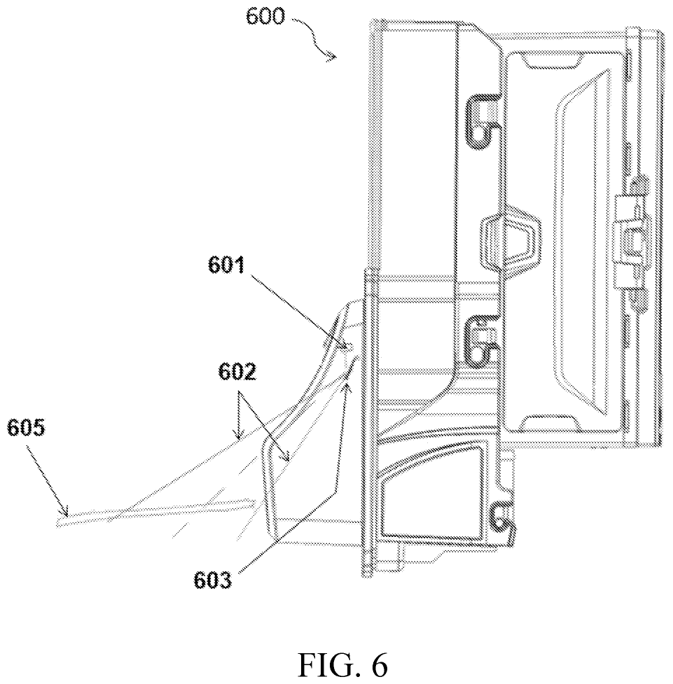

FIG. 6 illustrates an example banknote acceptor 600 with a pre-scan imaging sensor according to various embodiments of the present disclosure. The banknote acceptor 600 could be one of, or a component of, any of banknote acceptor or banknote deposit withdrawal systems 200-280 as described in FIGS. 2A-2I. The banknote acceptor 600 comprises a pre-scan imaging sensor 601 that monitors the entrance of the banknote acceptor for objects 605 that may be inserted. A field of view of the pre-scan imaging sensor 601 comprises space adjacent to a banknote acceptor path entrance to check if an object is present. In some embodiments, the pre-scan imaging sensor in combination with a mirror or other reflective or refractive surface 603 changes the field of view 602 from monitoring a banknote transport path or a surrounding area of a banknote acceptor to take an image of the face of a user inserting an object in a banknote acceptor.

In some embodiments, the mirror can be a half-silvered mirror that reflects both a user's hand or input area of the banknote acceptor and the user's face. In some embodiments, a split light path can be used such that half of the pixels captured by an imaging sensor are of a user's hand or an input area of the banknote acceptor 600, and the other half of the pixels captured by the imaging sensor are of a user's face. If the object about to be inserted is a banknote, then a banknote transport mechanism may be initiated. In addition, the pre-scan imaging sensor may also identify the denomination of a banknote from an image and adjust the width of a banknote path to accommodate a banknote.

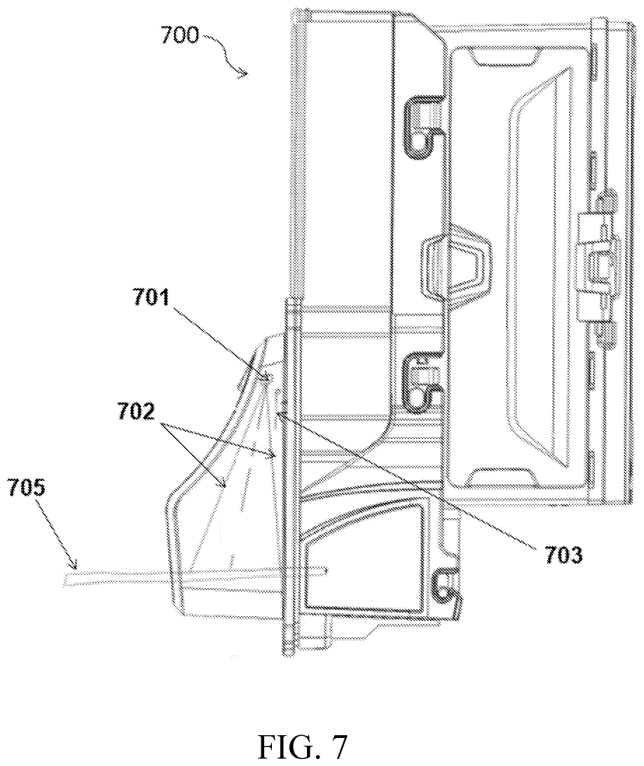

FIG. 7 illustrates an example banknote acceptor 700 with a pre-scan imaging sensor according to various embodiments of the present disclosure. The banknote acceptor 700 could be one of, or a component of, any of banknote acceptor or banknote deposit withdrawal systems 200-280 as described in FIGS. 2A-2I. The banknote acceptor 700 comprises a pre-scan imaging sensor that scans inserted banknotes for genuineness. In some embodiments, a mirror or reflective or refractive surface 703 may allow the pre-scan imaging sensor to view a banknote transport path. This view of the banknote transport path allows the pre-scan imaging sensor to view a banknote 705 or other documents such as a coupon in either a reflective or refractive or a transmissive manner. The refractive or reflective and/or transmissive images of an inserted banknote 705 can then be used for authentication and denomination purposes. This image can also assist in detecting if the inserted banknote comprises any string attached to the banknote to pull a “stringing” type fraud, where a culprit attaches a string or tape to a genuine banknote being inserted and, after getting credit for the genuine banknote, pulls the genuine banknote using the string. The pre-scan imaging sensor may detect the string and reject the banknote with the string, and also take an image of the culprit that the operator or owner can use to take legal action.

The mirror or reflective or refractive surface 703 allows the pre-scan imaging sensor 701 to change its field of view to alternatively take images of the surroundings, the face of a user interacting with, or inserting a banknote into, the unattended payment system, or an inserted object, and can authenticate the inserted banknote. In some embodiments, the mirror can be a half-silvered mirror that reflects both a user's hand or input area of the banknote acceptor and the user's face. In some embodiments, a split light path can be used such that half of the pixels captured by an imaging sensor are of a user's hand or an input area of the banknote acceptor, and the other half of the pixels captured by the imaging sensor are of a user's face. The pre-scan imaging sensor can serve as a sensor for authentication and denomination can perform multi-purpose roles inside a banknote acceptor.

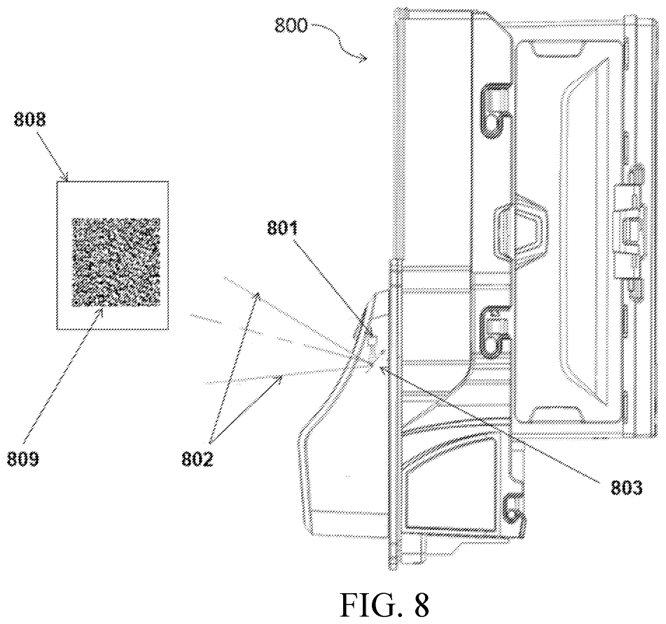

FIG. 8 illustrates an example banknote acceptor 800 with a pre-scan imaging sensor 801 according to one of the embodiments of the present disclosure. The banknote acceptor 800 could be one of, or a component of, any of banknote acceptor or banknote deposit withdrawal systems 200-280 as described in FIGS. 2A-2I. The banknote acceptor 800 comprises a pre-scan imaging sensor 801 that can take pictures of a display of a portable display device 808 of a user interacting with the unattended payment system 800. A field of view 802 of the pre-scan imaging sensor 801 can be adjusted to view the portable device 808 of a user. During interaction with the unattended payment system 800, a user can receive or create digital indicia 809, and that digital indicia 809 is then presented to the banknote acceptor 800. The pre-scan imaging sensor 801 of the banknote acceptor 800 then takes an image of this digital indicium 809 and sends it to a controller of the unattended payment system and/or to a network-connected device inside the unattended payment system. In some embodiments, the digital indicia 809 can be a quick response (QR) code or other scannable code, image, or barcode that can identify a user and grant a user access to the banknote acceptor 800 or allow the user to perform a transaction using the banknote acceptor 800.

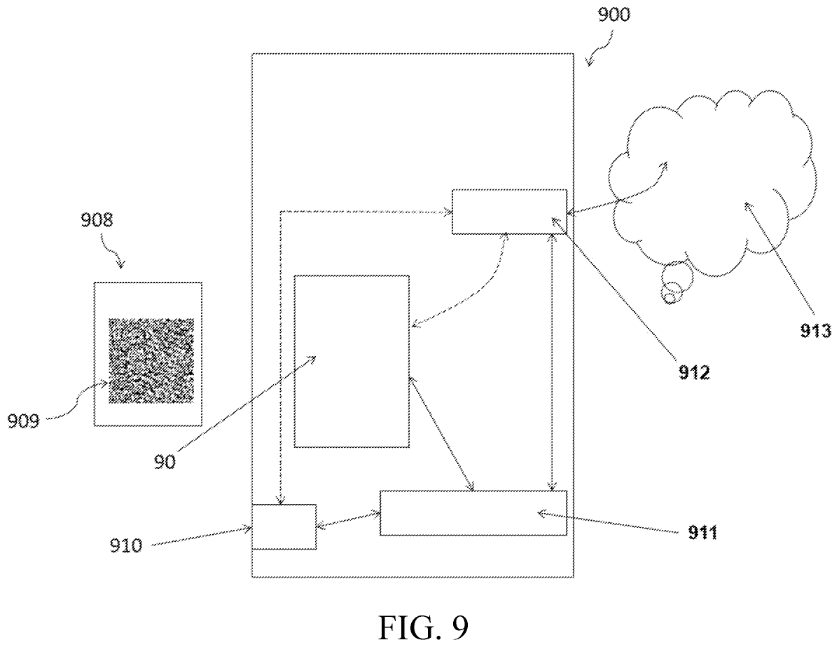

FIG. 9 illustrates an example unattended payment system 900 with a banknote acceptor 90 including a pre-scan imaging sensor according to various embodiments of the present disclosure. In some embodiments, a banknote acceptor 90 with the pre-scan imaging sensor can be connected with a telemeter 912. The telemeter 912 can be in communication with at least a remote computing device 913. In some embodiments, the banknote acceptor 90 with the pre-scan imaging sensor may be connected to a controller 911 of the unattended payment system 900 that may be connected to a telemeter 912 connected to at least a remote computing device 913. The telemeter 912 represents an example of a network-connected device. In some embodiments, the telemeter 912 can be any other network-connected device such as a router, cellular modem, a wireless connection enabled device, or other devices. The telemeter 912 can be directly in communication with a lock 910 inside the unattended payment system 900 and can instruct the lock 910 to remain locked or to unlock.

The unattended payment system 900 can also include a smart electronic lock 910 for the unattended payment system 900. These smart electronic locks 910 may require a onetime code to unlock the unattended payment system 900 for servicing or replenishing supplies. In existing systems, service technicians or inventory management personnel carry multiple keys when they plan their route for servicing or inventory refill. Old mechanical locks with smart electronic locks 910. Smart electronic locks 910 can provide the time of the visit to access to the unattended payment system 900 and reduce keys technician or inventory refill personnel have to carry with them. Technicians or inventory refill personnel can create or receive digital indicia on a display of their portable display device. The pre-scan imaging sensor from the banknote acceptor 90 takes an image of the display of portable display device 908 with digital indicia 909 and sends an image to the network-connected device 912 or controller 911 of the unattended payment system 900 that can then send an image of digital indicia 909 to a remote computing device 913. The remote computing device 913 validates the authenticity of the digital indicia 909 and send instructions to the unattended payment system 900 to unlock the device to provide access to the unattended payment system 900 to the technician or inventory refill personnel. In some embodiments a log can be created of access to the unattended payment system 900 by the technician or inventory refill personnel. Additional security measures such as two-factor authentications can also be added when the technician or inventory refill personnel requests access to the unattended payment system 900.

In some embodiments, the digital indicia 909 can be a QR code or other scannable code, image, or barcode that can identify a user and grant a user access to the banknote acceptor 900 or allow the user to perform a transaction using the banknote acceptor 900. In some embodiments, the telemeter 912 can be in communication with the controller 911 of the unattended payment system, where the controller 911 can instruct the lock 910 to either remain locked or to unlock. An image of digital indicia 909 from user's personal portable display device 908 received by the controller 911 of the unattended payment system 900 or the telemeter 912 is sent to at least a remote computing device 913 in either an image of digital indicia 909 or processed digital indicia, that may verify genuineness of the digital indicia and send an instruction back to telemeter 912 that may unlock the unattended payment system 900 either directly by instructing the lock or through the controller 911 of the unattended payment system 900.

The same infrastructure can be relied upon to provide credit to a user if a user presents digital indicia 909 representing loyalty or reward redemption. The remote computing device 913, in some embodiments, can also send credit to the unattended payment system 900 for a user to spend. An image of a digital indicia 909 from user's personal portable display device 908 is captured by a banknote acceptor 90 with the pre-scan imaging sensor. The telemeter 912 can be in communication with at least a remote computing device 913. The telemeter 912 sends the digital indicia 909 captured by the banknote acceptor 90 with the pre-scan imaging sensor to the remote computing device 913. The remote computing device 913 can verify authenticity of the digital indicia 909. If verified, the user is provided a credit on the unattended payment system 900.

In other embodiments, the remote computing device 913 can provide an indicia to users representing a credit to be used on the unattended payment system 900 for refund or promotional or other purposes. The digital indicia 909 could indicate credit for the user that if verified by the remote computing device 913. The user can use the credit on the unattended payment system 900 for goods or services.

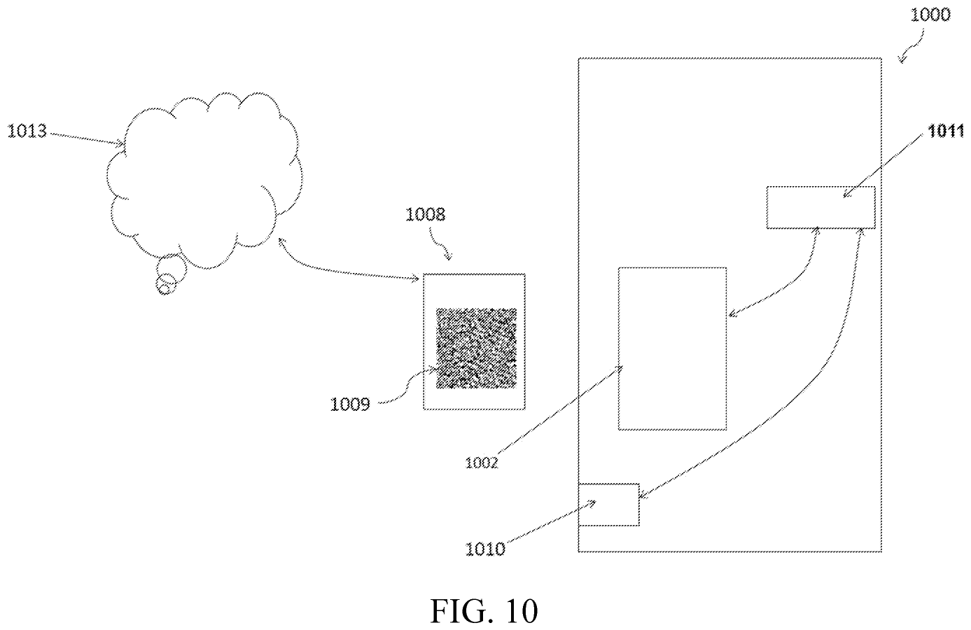

FIG. 10 illustrates an unattended payment system 1000 with an example banknote acceptor 1002 with a pre-scan imaging sensor according to various embodiments of the present disclosure system. The banknote acceptor 1002 with the pre-scan imaging sensor include a controller, and the unattended payment system may not comprise any telemeter or other network-connected devices. In some embodiments, the controller 1011 of the unattended payment system 1000 can decide genuineness of digital indicia 1009 presented by the banknote acceptor 1002 with the pre-scan imaging sensor. The digital indicia 1009 created or received by a display of portable display device 1008 may contain a specific decryption key unique to the unattended payment system 1000. In some embodiments, the digital indicia 1009 can be a QR code or other scannable code, image, or barcode that can identify a user and grant a user access to the banknote acceptor 1000 or allow the user to perform a transaction using the banknote acceptor 1000. Once the controller 1011 of the unattended payment system 1000 verifies the genuineness of digital indicia 1009 it may instruct a lock to unlock and provide access to service a technician or inventory refill personnel.

The same infrastructure can be relied upon to provide credit to a user if a user presents digital indicia 1009 representing loyalty or reward redemption. Digital indicia 1009 created or received by a user on display of a user's portable display device 1008 can contain a specific decryption key unique to the unattended payment system to provide credit to a user of a specified amount.

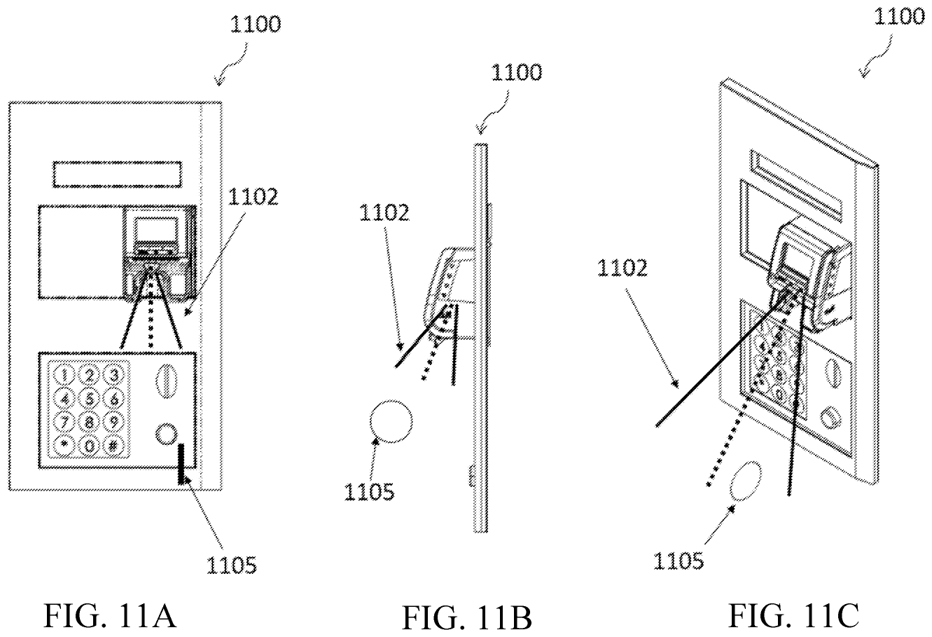

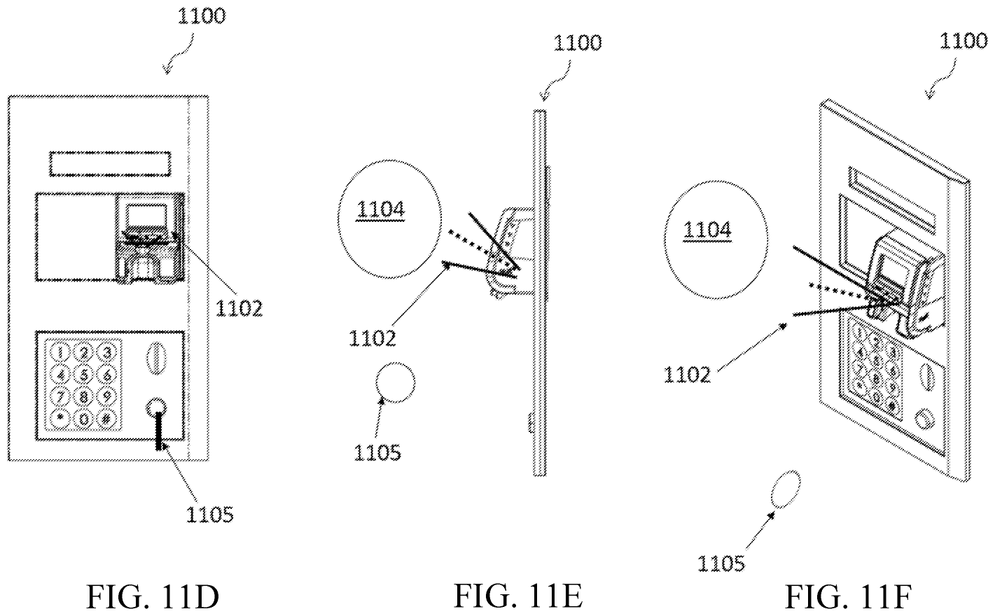

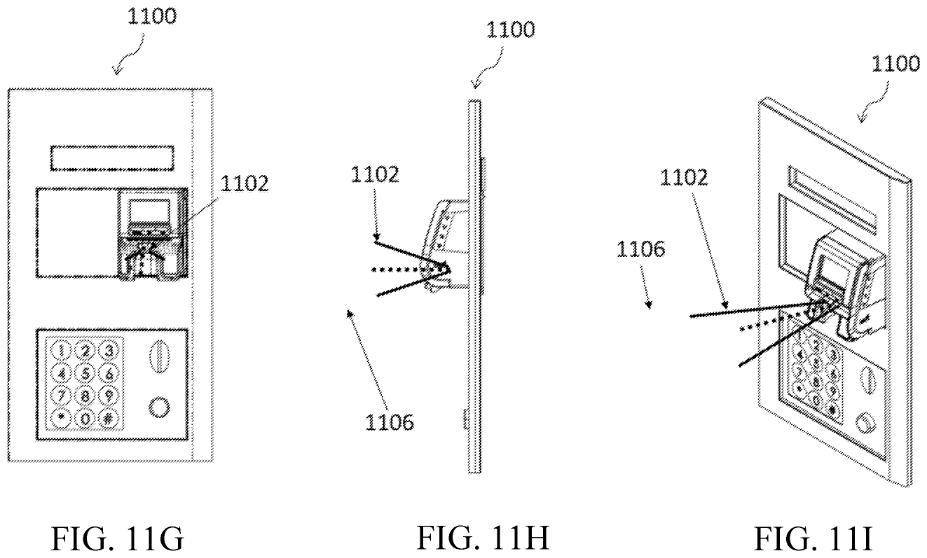

FIGS. 11A-11J illustrates an example payment acceptor 1100 with a pre-scan imaging sensor (not shown) according to various embodiments of the present disclosure. As illustrated in FIGS. 11A-11C, the payment acceptor 1100 comprises a pre-scan imaging sensor that monitors the entrance of the payment acceptor 1100 for objects 1105 that may be inserted. A field of view 1102 of the pre-scan imaging sensor comprises space adjacent to the payment acceptor path entrance to check if an object is present. In some embodiments, the payment acceptor can include a coin acceptor. If the object about to be inserted is a coin, then a coin transport mechanism may be initiated.

In addition, the pre-scan imaging sensor may also identify the denomination of a coin from an image and adjust a size throughout a coin path to accommodate the coin. If a user attempts to insert a non-coin object such as slug or other object that may not appear to be a coin or token, then the coin transport mechanism is not initiated. This avoidance of initiation of a coin transport mechanism prevents the non-coin object from entering deep into the coin transport path where the coin transport mechanism may not be able to push the non-coin object successfully. Differences in stiffness and weight between coins and non-coin objects are significant, leaving them stuck inside the coin transport path once entered deep into it. In many coin acceptors, recognition sensors act as start sensors. In cases where dedicated start sensors are present, start sensors used in payment acceptors generally detect presence or absence of an object in the payment transport path to initiate the payment transport mechanism and then sensors are used to detect the validity of the inserted object. However, once these sensors determine that the inserted object is a non-coin object, the coin transport mechanism is no longer able to push the non-coin object out of the coin transport mechanism. This forces the payment acceptor of the unattended payment system to go into service mode as it may not be able to accept coins and may require an expensive service technician visit. The pre-scan imaging sensor can prevent insertion of the non-coin object into the coin transport path as a user can push the non-coin object that remains accessible to a user, and the user can pull the non-coin object out once the user realizes there is an erroneous insertion. The pre-scan imaging sensor can save the operator of the unattended payment system from service technician expenses due to non-coin object insertion.

As illustrated in FIGS. 11D-11F, in some embodiments, the payment acceptor 1100 comprises a pre-scan imaging sensor that can take pictures of a face of a user 1104 inserting an object inside the payment acceptor of the unattended payment system 1100. The pre-scan imaging sensor in combination with a mirror or other reflective or refractive surface changes the field of view from monitoring an entrance of payment acceptor 1100 to take an image of the face of the user 1104 inserting the object in the payment acceptor 1100. In some embodiments, the mirror can be a half-silvered mirror that reflects both a user's hand or input area of the banknote acceptor and the user's face. In some embodiments, a split light path can be used such that half of the pixels captured by an imaging sensor are of a user's hand or an input area of the banknote acceptor, and the other half of the pixels captured by the imaging sensor are of a user's face 1104. This image can then be stored in the memory of either the payment acceptor or the unattended payment system 1100. This image of the user can also be time-stamped and associated with an inserted object or an interaction with the unattended payment system 1100. This offers unique low-cost benefits to operators of the unattended payment systems that are vulnerable to fraud and vandalism because of the opportunity for anonymous abuse, especially unattended payment systems those are located in areas without the presence of surveillance imaging sensors or security personnel. Anonymity combined with a lack of injuries to other people makes fraud and vandalism difficult for operators to identify the culprit and forces operators to repair the unattended payment systems. The embodiments of the present disclosure provide a capacity to identify culprits to assist operators and law enforcement. Another benefit of identifying culprits is to trace the origin of fake coins designed to cheat payment acceptors. While payment acceptors reject coins that may not meet predefined genuineness criteria based on preselected criteria, payment acceptors may not distinguish between different classes of forgeries from inserted unacceptable coins. Storing images of fake coins and associating them with a culprit can thus allow law enforcement personnel to pursue culprits more efficiently.

Another benefit as shown in FIGS. 11G-11I is the ability to take pictures of the area surrounding the unattended payment system 1100. Owners or operators of the unattended payment systems 1100 may not be aware of the actual operating condition of environmental factors affecting the visibility of the unattended payment systems 1100. The pre-scan imaging sensor placed in the payment acceptor can provide information about foot traffic in the vicinity of the unattended payment system as well as if some other equipment is blocking access or visibility of the unattended payment system during times of heavy foot traffic, affecting opportunities for users to interact with the unattended payment system and bring revenue for the operator or owner. Information of actual operating conditions allows the operator to improve conditions to increase visibility by changing product selection, appearance, or simply moving the unattended payment system into a different area with heavier foot traffic.

As illustrated in FIG. 11J, in some embodiments, the payment acceptor 1100 comprises a pre-scan imaging sensor 1101 that monitors the entrance of the payment acceptor for objects that may be inserted. A field of view of the pre-scan imaging sensor 1101 comprises space adjacent to the payment acceptor path entrance to check if an object is present. In some embodiments, the pre-scan imaging sensor 1101 in combination with a mirror or other reflective or refractive surface changes the field of view 1102 from monitoring a banknote transport path or surrounding of payment acceptor 1100 to take an image of the face of a user inserting an object 1105 in payment acceptor. In some embodiments, the imaging sensor 1101 in the payment acceptor 1100 can include fiber optic cables 1121 and 1122 or light guides to switch between different fields of view. The fiber optic cables 1121 and 1122 may allow the imaging sensor 1101 to view multiple fields of view simultaneously or a selected region of interest, allowing it to broaden the area the imaging sensor 1101 can monitor. In addition, an end of the fiber optic cable 1121 or light guide may include a reflective or refractive surface to further change the field of view as also described with respect to FIGS. 5A-5E.

In addition, the pre-scan imaging sensor 1101 can also identify the denomination of a coin from an image and adjust the width of the coin transport path to accommodate the coin 1105. The payment acceptor comprises the pre-scan imaging sensor 1101 that scans the inserted coin 1105 for genuineness. In some embodiments, the mirror or reflective or refractive surface allows the pre-scan imaging sensor 1101 to view a coin transport path. This view of the coin can allow the pre-scan imaging sensor 1101 to view the coin or other tokens and images taken of the inserted coin can then be used for authentication and denomination purposes. The image can also assist in detecting if the inserted coin comprises any string attached to pull a “stringing” type fraud, where a culprit attaches a string or tape to a genuine coin being inserted and after getting credit for a genuine coin, pulls the genuine coin using string. The pre-scan imaging sensor 1101 may detect the string, reject the coin with the string, and take an image of the culprit 1104 that the operator or owner can use to take legal action.

The mirror or reflective or refractive surface that allows the pre-scan imaging sensor to change its field of view 1102 allows the imaging sensor to alternatively take images of the surroundings 1106, the face of a user 1104 interacting with the unattended payment system 1100, or an inserted object 1105, and allows the imaging sensor 1101 to authenticate the inserted banknote or coin. The pre-scan imaging sensor 1101 can serve as a sensor for authentication and denomination and the pre-scan imaging sensor can perform multi-purpose roles inside payment acceptor.

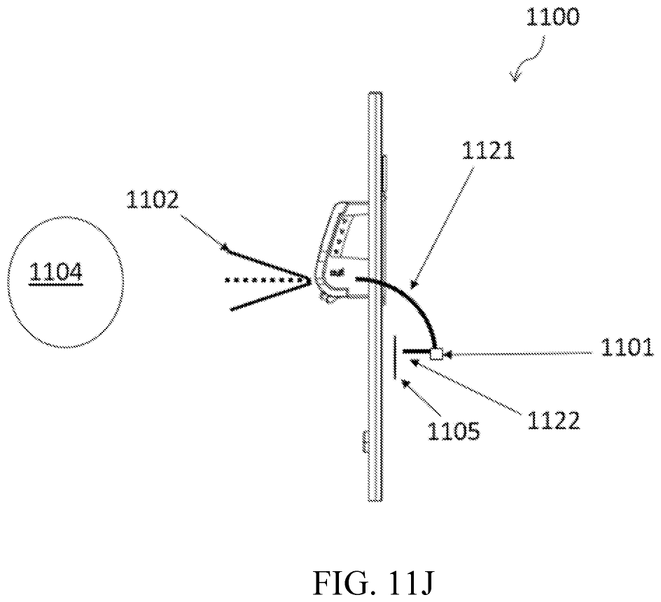

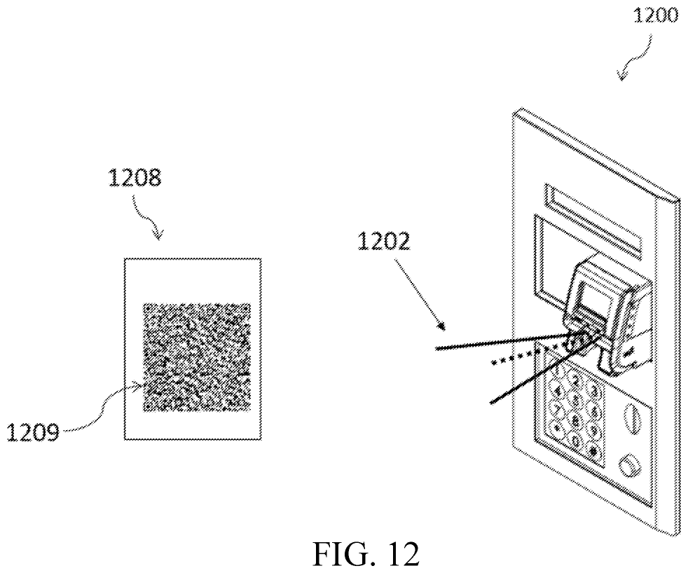

FIG. 12 illustrates an example payment acceptor 1200 with a pre-scan imaging sensor (not shown) according to various embodiments of the present disclosure. The payment acceptor 1200 comprises a pre-scan imaging sensor that may take pictures of a display of a portable display device 1208 of a user interacting with the unattended payment system 1200. A field of view 1202 of the pre-scan imaging sensor may be adjusted to view the portable device 1208 of a user. A user during interaction with the unattended payment system can receive or create digital indicia 1209 that digital indicia 1209 is then presented to the payment acceptor 1200. The pre-scan imaging sensor of the payment acceptor 1200 then takes an image of sends this digital indicium 1209 and sends it to a controller of the unattended payment system 1200 and/or to a network-connected device inside the unattended payment system 1200. The network-connected device can send an image of the digital indicia 1209 or digital indicia to at least a remote computing device. The remote computing device then can verify the digital indicia. In some embodiments, the digital indicia 1209 can be a QR code or other scannable code, image, or barcode that can identify a user and grant a user access to the banknote acceptor 1200 or allow the user to perform a transaction using the banknote acceptor 1200. If the digital indicium is found genuine then the remote computing device may send an instruction to the unattended payment system to provide credit to a user of the unattended payment system. This application may simplify loyalty or rewards redemption to a user without need for additional hardware at the unattended payment system. This can simplify loyalty or reward redemption for users as they may not have to carry a separate card or fob or other devices. Users can simply generate a reward or loyalty redemption code and present it to payment acceptor that takes an image of the display, and a user is provided a credit on the unattended payment system.

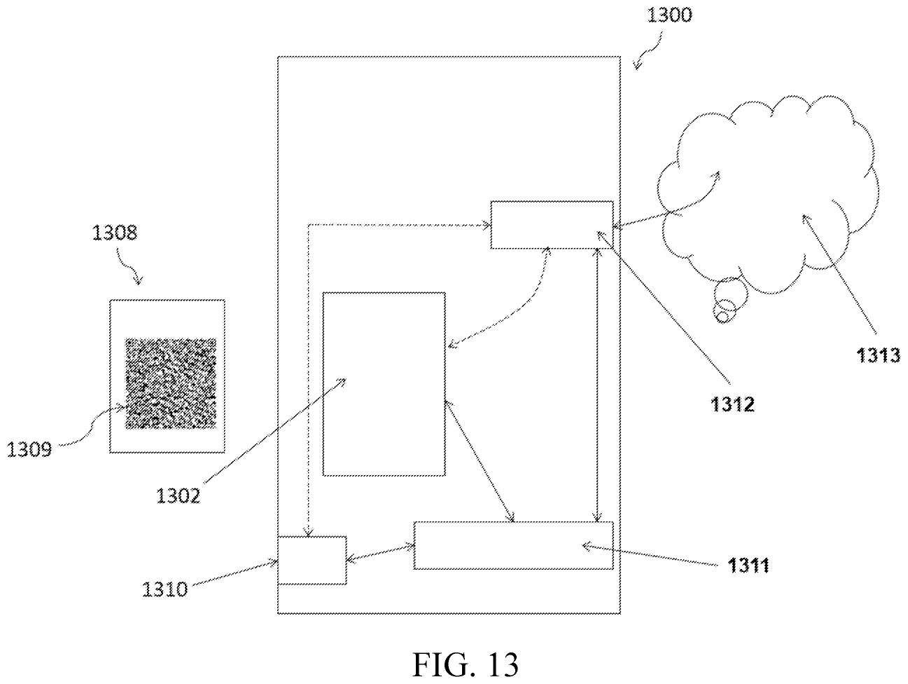

FIG. 13 illustrates an unattended payment system 1300 including an example payment acceptor 1302 with a pre-scan imaging sensor according to various embodiments of the present disclosure. In some embodiments, the payment acceptor 1302 with the pre-scan imaging sensor can be directly connected with a telemeter 1312. The telemeter 1312 can be in communication with at least a remote computing device 1313. In some embodiments, the payment acceptor 1302 with the pre-scan imaging sensor can be connected to the controller 1311 of the unattended payment system 1300 that can be connected to a telemeter 1312 connected at least a remote computing device 1313. A telemeter 1312 represents an example of a network-connected device. The telemeter 1312 can also be any other network-connected devices such as a router, cellular modem, a wireless connection enabled device, or other devices. The telemeter 1312 may be directly in communication with the lock inside the unattended payment system 1300 and can instruct the lock 1310 to remain locked or to unlock. The telemeter 1312 can be in communication with the controller of the unattended payment system 1300, where the controller can instruct the lock 1310 to remain locked or to unlock. An image of digital indicia 1309 received by the controller of the unattended payment system 1311 or the telemeter 1312 is sent to at least a remote computing device 1313 in either an image of digital indicia 1309 from user's personal display device 1308 or processed digital indicia, that is used to verify genuineness of digital indicia 1309 and send instructions back to the telemeter 1312 to unlock the unattended payment system 1300 either directly by instructing the lock 1310 or through the controller of the unattended payment system 1300. In some embodiments, the digital indicia 1309 can be a QR code or other scannable code, image, or barcode that can identify a user and grant a user access to the banknote acceptor 1300 or allow the user to perform a transaction using the banknote acceptor 1300.

The unattended payment system 1300 can also include a smart electronic lock 1310 for the unattended payment system 1300. These smart electronic locks 1310 may require a onetime code to unlock the unattended payment system 1300 for servicing or replenishing supplies. In existing systems, service technicians or inventory management personnel carry multiple keys when they plan their route for servicing or inventory refill. Old mechanical locks with smart electronic locks 1310. Smart electronic locks 1310 can provide the time of the visit to access to the unattended payment system 1300 and reduce keys technician or inventory refill personnel have to carry with them. Technicians or inventory refill personnel can create or receive digital indicia on a display of their portable display device. The pre-scan imaging sensor from the payment acceptor 1300 takes an image of the display of portable display device 1308 with digital indicia 1309, and sends an image to the network-connected device 1312 or controller 1311 of the unattended payment system 1300 that can then send an image of digital indicia 1309 to a remote computing device 1313. The remote computing device 1313 validates the authenticity of the digital indicia 1309, and send instructions to the unattended payment system 1300 to unlock the device to provide access to the unattended payment system 1300 to the technician or inventory refill personnel. In some embodiments a log can be created of access to the unattended payment system 1300 by the technician or inventory refill personnel. Additional security measures such as two-factor authentications can also be added when the technician or inventory refill personnel requests access to the unattended payment system 1300.

The same infrastructure can be relied upon to provide credit to a user if a user presents digital indicia 1309 representing loyalty or reward redemption. The remote computing device 1313, in some embodiments, can also send credit to the unattended payment system 1300 for a user to spend. An image of a digital indicia 1309 from user's personal portable display device 1308 is captured by a payment acceptor 1302 with the pre-scan imaging sensor. The telemeter 1312 can be in communication with at least a remote computing device 1313. The telemeter 1312 sends the digital indicia 1309 captured by the payment acceptor 1302 with the pre-scan imaging sensor to the remote computing device 1313. The remote computing device 1313 can verify authenticity of the digital indicia 1309. If verified, the user is provided a credit on the unattended payment system 1302.

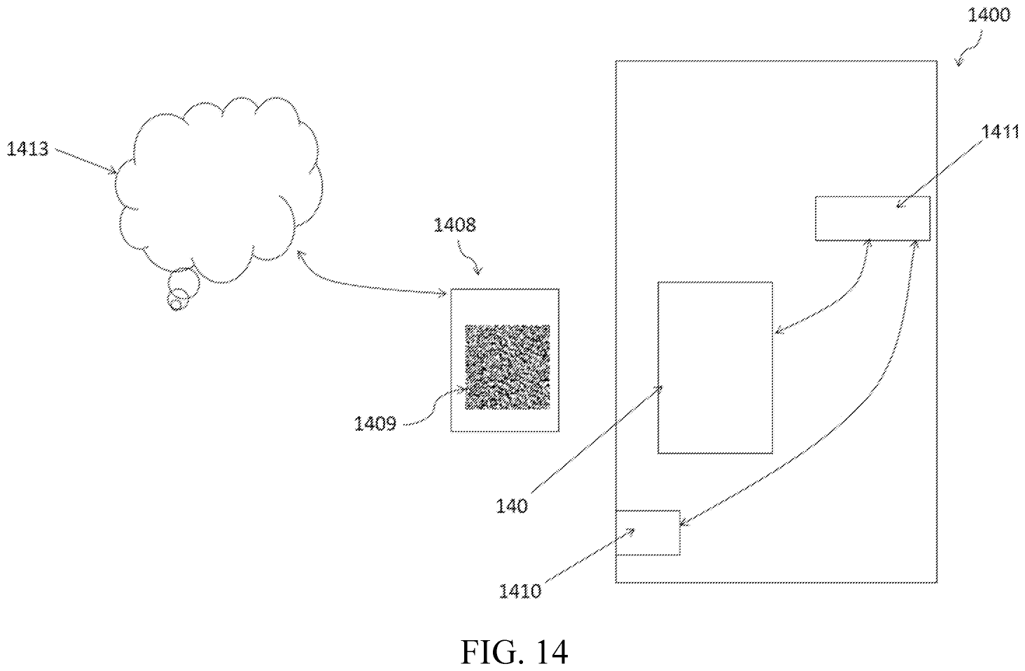

FIG. 14 illustrates an unattended payment system 1400 including an example payment acceptor 140 with a pre-scan imaging sensor according to various embodiments of the present disclosure. The payment acceptor 140 with the pre-scan imaging sensor can be connected to the controller 1411 of the unattended payment system 1400 and the unattended payment system 1400 may not comprise any telemeter or other network-connected devices. The controller 1411 of the unattended payment system 1400 can decide genuineness of digital indicia 1409 on user's personal portable device 1408 presented by the payment acceptor 140 with the pre-scan imaging sensor. The digital indicia 1409 created or received by a display of a portable display device 1408 can contain a specific decryption key unique to the unattended payment system 1400. Once the controller 1411 of the unattended payment system 1400 verifies the genuineness of digital indicia 1409, the controller 1411 instructs a lock 1410 to unlock and provide access to a service technician or inventory refill personnel.

The same infrastructure can be relied upon to provide credit to a user if a user presents digital indicia 1409 representing loyalty or reward redemption. In some embodiments, the digital indicia 1409 can be a QR code or other scannable code, image, or barcode that can identify a user and grant a user access to the banknote acceptor 1400 or allow the user to perform a transaction using the banknote acceptor 1400. Digital indicia 1409 created or received by a user on display of a user's portable display device 1408 can contain a specific decryption key unique to the unattended payment system 1400 to provide credit to a user of a specified amount.

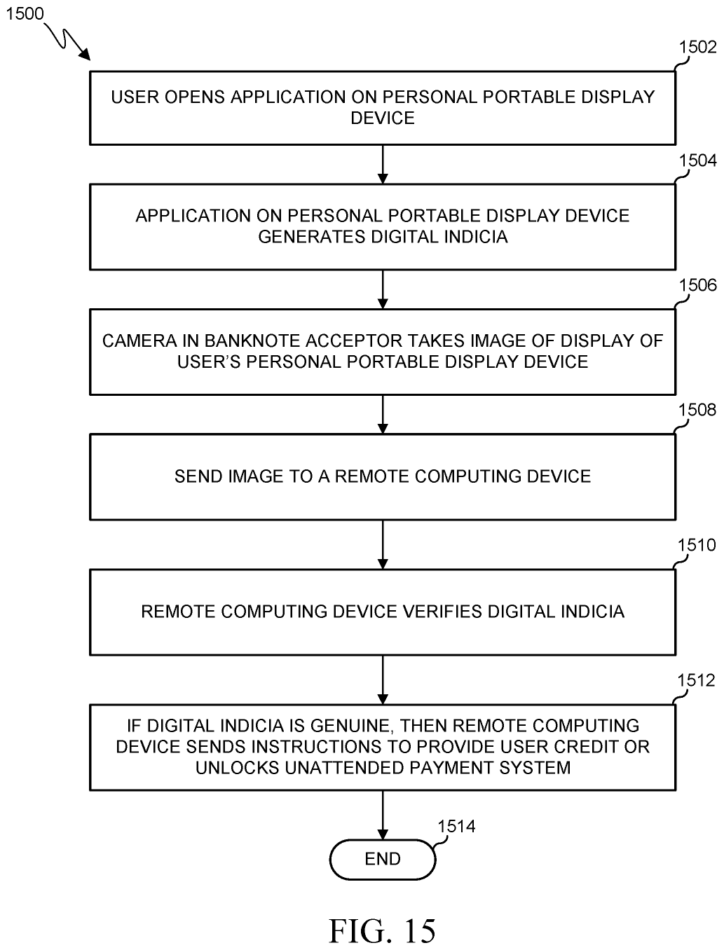

FIG. 15 illustrates a process 1500 of a payment acceptor or a banknote acceptor with a pre-scan imaging sensor according to various embodiments of the present disclosure. The method can be used in the unattended payment systems of the various embodiments of the present disclosure, such as the unattended payment systems 100-130, 900, 1000, 1100, 1200, 1300, and 1400. The process 1500 can be performed by the payment acceptors disclosed in the various embodiments of this disclosure, such as the banknote acceptors 200-280, 400, 500, 600, 700, and 800.

At block 1502, a user such as a technician, inventory refill personnel, or a customer opens an application on the user's portable display device. At block 1504, the user creates or receives digital indicia on a display of the portable display device. In some embodiments, the digital indicia provides information such as the type of user accessing the unattended payment system, such as to distinguish whether the user is a technician servicing the unattended payment system, or a customer using the unattended payment system to perform a transaction. In some embodiments, the digital indicia can be a QR code or other scannable code, image, or barcode that can identify a user and grant a user access to the banknote acceptor or allow the user to perform a transaction using the banknote acceptor. At block 1506, the pre-scan imaging sensor from the payment acceptor or the banknote acceptor takes an image of the display of the portable display device displaying the digital indicia and sends an image to a network-connected device or controller of the unattended payment system. At block 1508, the network-connected device or controller of the unattended payment system sends an image of digital indicia to a remote computing device.

At block 1510, the remote computing device validates the authenticity of the digital indicia. At block 1512, if the digital indicium is found to be genuine, the remote computing device sends instructions to the unattended payment system to perform an action at the unattended payment system. For example, if the user is a technician or refill personnel, the remote computing device can send an instruction to the unattended payment system to unlock the system to provide access of the system to the technician or inventory refill personnel. In some embodiments, the method can include creating a log of access of the unattended payment system by a technician or inventory refill person. Additional security measures such as two-factor authentications can also be added when a technician or inventory refill person requests access to the unattended payment system. In some embodiments where the user is a customer or other individual using the unattended payment system for a transaction, if the digital indicium is found to be genuine, the remote computing device sends an instruction to the unattended payment system to provide credit to the user of the unattended payment system. This can simplify loyalty or rewards redemption for a user without the need for additional hardware at the unattended payment system. This may simplify loyalty or reward redemption for users as they may not have to carry a separate card or fob or other devices. Users can simply generate a reward or loyalty redemption code and present it to a payment acceptor or a banknote acceptor that may take an image of the display and a user may be provided a credit on the unattended payment system. The process 1500 ends at block 1514.

The various embodiments of this disclosure provide a banknote handling apparatus or banknote validator including a banknote imaging system that includes a processor, a memory, and an imaging sensor. The banknote imaging system disclosed in the various embodiments of this disclosure can be included in the unattended payment systems of the various embodiments of the present disclosure, such as the unattended payment systems 100-130, 900, 1000, 1100, 1200, 1300, and 1400, and/or the payment acceptors disclosed in the various embodiments of this disclosure, such as the banknote acceptors 200-280, 400, 500, 600, 700, and 800. The imaging sensor is coupled to one or more fiber optic sensors, such as fiber optic bundles, positioned at various points in relation to a banknote path to detect banknotes travelling along the banknote path in order to provide the system with various information concerning the banknotes. The banknote imaging system in various embodiments provides a single imaging sensor or imaging sensor that is capable of multiple functions by being able to detect various characteristics of banknotes and different positions of banknotes in the banknote path via the fiber optic sensors. In various embodiments, the banknote imaging system can be calibrated to map pixels of the imaging sensor to the optical fibers of the fiber optic sensors, and a spatial distribution for the pixels can be stored the memory. This map can be used to pre-process data that can be further processed by the processor using image recognition software. Once the pixel mapping has been completed a standard (human and machine) recognizable image can be reconstructed and banknote recognition may proceed.

In various embodiments of this disclosure, the banknote imaging system provides freedom of physical shape since fibers may be trimmed to different lengths and bent as desired. The imaging sensor can be of a compact size allowing the imaging sensor to mount directly to a printed circuit board along with the processor and the memory, which is not achievable in other systems without mirrors. This avoids the interference, cost and reliability issues of connectors and cables. The banknote imaging system also can be installed in various apparatuses of differing manufacturing tolerances, as the fiber optic sensors can be placed at different areas along the banknote path as needed, or the sizes or number of the fiber optic sensors can be altered based on the apparatus. Other systems using lenses and mirrors do not have the same flexibility as the banknote imaging system of this disclosure to be installed in various currency handling apparatuses.

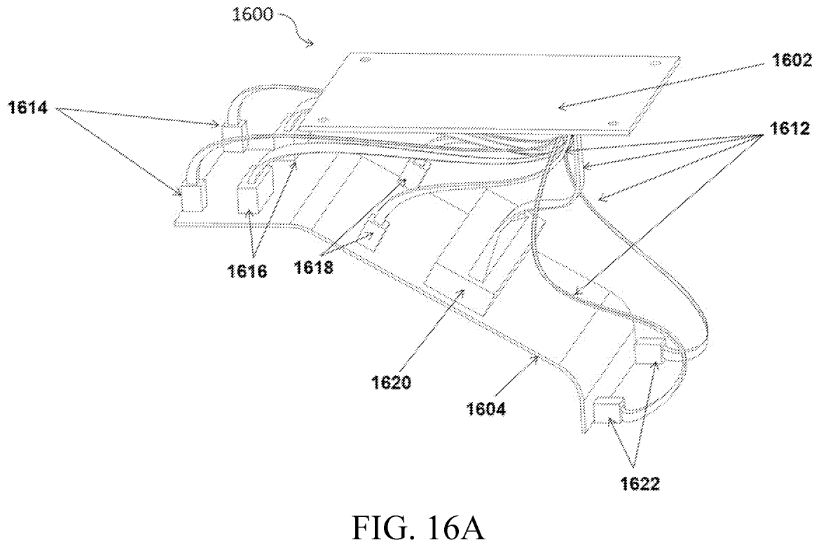

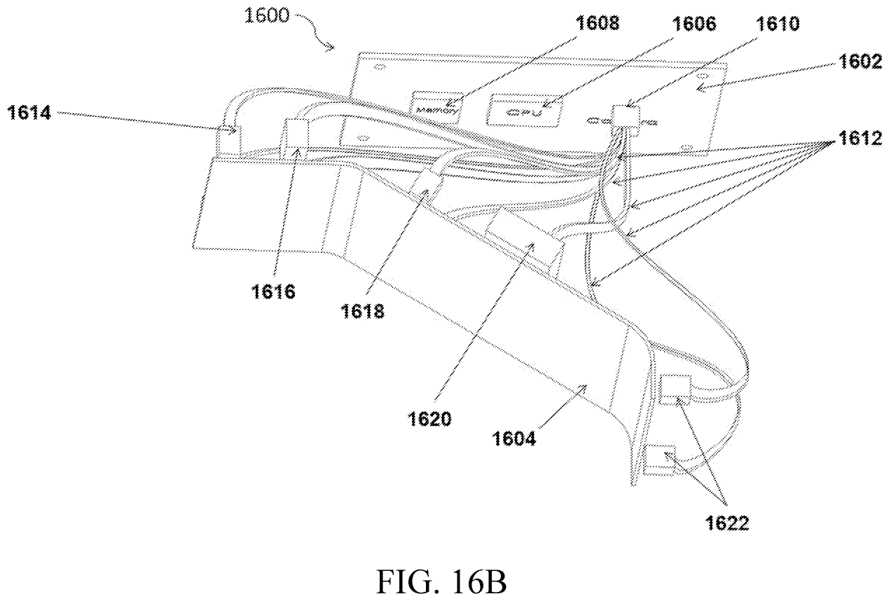

FIGS. 16A and 16B illustrate an example banknote imaging system 1600 according to various embodiments of this disclosure. The system 1600 can be used as part of the unattended payment systems of the various embodiments of the present disclosure, such as the unattended payment systems 100-130, 900, 1000, 1100, 1200, 1300, and 1400, and/or the payment acceptors disclosed in the various embodiments of this disclosure, such as the banknote acceptors 200-280, 400, 500, 600, 700, and 800, or with any other suitable currency apparatus. The system 1600 includes a printed circuit board (PCB) 1602 disposed above a wall of a banknote path 1604, such as a banknote path of the currency handling apparatus and/or the banknote validator. It will be understood that the banknote path 1604 illustrated in FIGS. 16A and 16B is an example, and the banknote path 1604 can include various shapes, dimensions, lengths, or other characteristics without deviating from the present disclosure. The PCB 1602 has included thereon a central processing unit (CPU) or processor 1606 and a memory 1608. The processor 1606 can process imaging signals received via an imaging sensor 1610, such as signals that include image data pertaining to banknotes travelling along the banknote path 1604. The memory 1608 can store the image data, such as raw image data and processed image data created by the processor 1606 manipulating the raw image data according to various processes described herein to retrieve information from the raw image data concerning the subject, such as banknote details.

In some embodiments, the imaging sensor 1610 can be a camera. In some embodiments, the imaging sensor 1610 can include a sensor array, such as a charge coupled device (CCD) sensor array or a complementary metal oxide semiconductor (CMOS) sensor array, or any other optical sensor array that receives light transmitted to the imaging sensor. The sensor array of the imaging sensor 1610 is coupled to an optical fiber bundle that is bifurcated into a plurality of optical fiber sub-bundles 1612 that each are operable to transmit light with high efficiency via total internal reflection. In various embodiments of this disclosure, the size aspect ratio and number of the fibers in the bundle is closely matched to the size of the number of pixels in the sensor array of the imaging sensor 1610. In some embodiments, there may be no attempt to optically correlate the fibers in the plurality of optical fiber sub-bundles 1612 to any particular location on the sensor array of the imaging sensor 1610. Each one of the plurality of optical fiber sub-bundles 1612 is flexible, and can be folded as needed to reach various positions along the banknote path 1604 in order to provide to the imaging sensor 1610 various images providing various information on banknotes as the banknotes travel along the banknote path 1604.

Each one of the plurality of optical fiber sub-bundles 1612 can be encapsulated into target sensor areas along the banknote path 1604, and can be disposed at a particular distance above a wall of the banknote path 1604 so that the plurality of optical fiber sub-bundles 1612 does not interfere with the progress of the banknote along the banknote path 1604, while still being able to capture images of at least a portion of the banknote. As such, the plurality of optical fiber sub-bundles 1612 can be installed in various configurations within a currency handling apparatus or banknote validator at different positions along the banknote path 1604. For example, as shown in the examples of FIGS. 16A and 16B, the plurality of optical fiber sub-bundles 1612 include start sensors 1614 disposed near an entrance to the banknote path 1604, width sensors 1616 disposed further along the banknote path 1604 from the start sensors 1614, progress sensors 1618 disposed further still along the banknote path 1604, a recognition sensor 1620 disposed further still along the banknote path 1604, and exit sensors 1622 disposed near an exit of the banknote path 1604 or at a particular point along the banknote path 1604 that ends a banknote imaging section of the banknote path 1604, such as if the banknote path 1604 continues on to various other locations, such as storage locations, within a currency handling apparatus. The imaging sensor 1610 can be divided into channels for capturing images via each of the different sensors 1614, 1616, 1618, 1620, and 1622. In some embodiments, the imaging sensor 1610 can capture 4 or 5 pixels per fiber.

The sensors 1614, 1616, 1618, 1620, and 1622 each have a geometry to fulfill a particular purpose. Each of the plurality of sub-bundles 1612 allocated to the sensors 1614, 1616, 1618, 1620, and 1622 includes a target number of fibers based on which of the sensors 1614, 1616, 1618, 1620, and 1622 the sub-bundle is used. For example, the start sensors 1614 include one or more fiber sub-bundles disposed at points near the entrance to the banknote path 1604 to transmit light to the imaging sensor 1610 so that the imaging sensor 1610 can capture images of the entrance area of the banknote path 1604. In some embodiments, such as shown in FIGS. 16A and 16B, the start sensors 1614 can include two sensors or fiber sub-bundles each having a small number of fibers disposed above small areas at opposite sides with respect to the width of the banknote path 1604, to allow for detection of the sides of a banknote as the banknote enters the banknote path 1604.

In some embodiments, the start sensors 1614 can be of various other configurations, such as sub-bundles of different sizes to cover different areas of the banknote path 1604, such as one start sensor that covers the width, or a portion of the width, of the banknote path 1604. It will be understood that the differing sizes of the sub-bundles for the start sensors 1614 can be determined by evaluating how much of the area of the banknote path 1604 to monitor to efficiently detect a banknote entering the banknote path 1604, and to account for different possible orientations of banknotes entering the banknote path 1604. For example, the start sensors 1614 can have a small number of fibers for each sub-bundle because, in some embodiments, the start sensors 1614 are configured to detect the presence of a banknote, and not to capture data from the banknote, and thus the relatively small number of fibers disposed at each side of the banknote path 1604 provide a lower resolution that is sufficient to detect if a banknote enters the banknote path 1604.

The width sensors 1616 include one or more fiber sub-bundles disposed over areas of the banknote path 1604 further down the banknote path 1604 from the entrance of the banknote path 1604. The width sensors 1616 transmit light to the imaging sensor 1610 so that the imaging sensor 1610 can capture images of the banknote as it travels down the banknote path 1604 to determine a width of the banknote. In some embodiments, such as shown in FIGS. 16A and 16B, the width sensors 1616 can include two sensors or fiber sub-bundles each having an intermediate number of fibers disposed above areas at opposite sides with respect to the width of the banknote path 1604, to allow for detection side portions of the banknote as the banknote. From detecting the side portions or edges of the banknote, the processor 1606 can analyze the images returned via the width sensors 1616 to the imaging sensor 1610, and determine the width of the banknote based on the captured images of the side portions or edges of the banknote. In some embodiments, the width sensors 1616 have more fibers than the start sensors 1614, as a larger portion of the banknote may need to be imaged to determine the width of the banknote. In some embodiments, the width sensors 1616 could include one width sensor, such as a width sensor disposed over the full width of the banknote path 1604 to detect each edge of a banknote traveling along the banknote path 1604.

The progress sensors 1618 include one or more fiber sub-bundles disposed over interior areas of the banknote path 1604. Images returned via the progress sensors 1618 can be used to determine the progress of a banknote, so that the processor 1606 can determine where the banknote is along the banknote path 1604. In some embodiments, such as shown in FIGS. 16A and 16B, the progress sensors 1618 can include two sensors or fiber sub-bundles each having a small number of fibers disposed above small areas at opposite sides with respect to the width of the banknote path 1604, to allow for detection of the sides of a banknote as the banknote travels along the banknote path 1604.

In some embodiments, the progress sensors 1618 can be of various other configurations, such as sub-bundles of different sizes to cover different areas of the banknote path 1604, such as one progress sensor that covers the width, or a portion of the width, of the banknote path 1604. It will be understood that the differing sizes of the sub-bundles for the progress sensors 1618 can be determined by evaluating how much of the area of the banknote path 1604 to monitor to efficiently detect a banknote traveling along the banknote path 1604, and to account for different possible orientations of banknotes. For example, the progress sensors 1618 can have a small number of fibers for each sub-bundle because, in some embodiments, the progress sensors 1618 are configured to detect the presence of a banknote, and not to capture data from the banknote, and thus the relatively small number of fibers disposed at each side of the banknote path 1604 provide a lower resolution that is sufficient to detect the presence or absence of a banknote in the banknote path 1604.

The recognition sensor 16160 includes a sub-bundle of a larger number of fibers, and is disposed over an interior portion of the banknote path 1604. The recognition sensor 16160 is used to detect various characteristics of banknotes, including serial numbers, strings or tape attached to banknotes, security components of banknotes, denominations of banknotes, or other banknote characteristics. The recognition sensor 16160 can have a high aspect ratio rectangular shape covering the full width of the banknote path 1604 with a relatively narrow dimension in the direction of the banknote transport. As a banknote travels along the banknote path 1604 and passes by the recognition sensors 16160, the imaging sensor 1610 can capture images of portions of the banknote, which can be stored in the memory 1608 and analyzed by the processor 1606 to determine the various characteristics of the banknote. Based on the determined characteristics the processor 1606 can determine whether to refuse the banknote. The processor 1606 can also store various information obtained from the banknote, such as a serial number, which can be used to track the banknote in the system 1600. For example, the processor 1606 can store the detected serial number in the memory 1608, and, upon detecting the serial number again during a dispensing operation, can determine that the banknote is no longer stored within the currency handling apparatus.

The exit sensors 1622 include one or more fiber sub-bundles disposed at points near an exit or transition point of the banknote path 1604. The exit sensors 1622 transmit light to the imaging sensor 1610 so that the imaging sensor 1610 can capture images of this exit or transition area of the banknote path 1604. In some embodiments, such as shown in FIGS. 16A and 16B, the exit sensors 1622 can include two sensors or fiber sub-bundles each having a small number of fibers disposed above small areas at opposite sides with respect to the width of the banknote path 1604, to allow for detection of the sides of a banknote as the banknote exits the banknote path 1604, or as the banknote moves from this portion of the banknote path 1604 to another portion of the banknote path or another area of a currency handling apparatus.

In some embodiments, the exit sensors 1622 can be of various other configurations, such as sub-bundles of different sizes to cover different areas of the banknote path 1604, such as one start sensor that covers the width, or a portion of the width, of the banknote path 1604. It will be understood that the differing sizes of the sub-bundles for the exit sensors 1622 can be determined by evaluating how much of the area of the banknote path 1604 to monitor to efficiently detect a banknote exiting the banknote path 1604, and to account for different possible orientations of banknotes exiting the banknote path 1604. For example, the exit sensors 1622 can have a small number of fibers for each sub-bundle because, in some embodiments, the exit sensors 1622 are configured to detect the presence of a banknote, and not to capture data from the banknote, and thus the relatively small number of fibers disposed at each side of the banknote path 1604 provide a lower resolution that is sufficient to detect if a banknote exits the banknote path 1604.

In some embodiments, the imaging sensor 1610 can also receive images from a tach of a driving motor. The tach of a driving motor can provide information about how much motion has been imparted by the driving motor. This information when coupled with the images from the start sensors 1614, width sensors 1616 and tracking sensors 1618 can provide information about slippage of a banknote in the banknote transportation path 1604. This slippage information could be useful in compensation of speed of banknote transportation by either increasing or decreasing speed of rotation of the driving motor.

The banknote imaging system 1600 in some embodiments thus provides a single imaging sensor 1610 or imaging sensor that is capable of multiple functions by being able to detect various characteristics of the banknote and different positions of the banknote in the banknote path 1604 via the sensors 1614, 1616, 1618, 16160, and 1602. The use of fiber optic bundles for the sensors 1614, 1616, 1618, 16160, and 1602 provide for a loose cluster of fibers pinched together into a small area. Instead of illuminating the fiber optic bundles with a light source, the imaging sensor 1610 captures individual pixels of light each from approximately one fiber. The differing sizes and number of fibers of the sensors 1614, 1616, 1618, 16160, and 1602 provide for variable resolutions based on the type of information to be determined for each sensor, which is not achievable in other system that use standard lenses. It can thus be understood that all the optical areas of interest are available to the sensor, but each pixel is effectively randomized in spatial location. This would ordinarily result in scrambled image, but the processor 1606 can be calibrated to use the image since, once the system 1600 is installed in an apparatus, the spatial distribution can be fixed over the life of the sensor or system 1600, and the spatial distribution can be learned at a manufacturing calibration stage. The system 1600 is calibrated to map the pixels and the spatial distribution is stored in the memory 1608. This map can be used to pre-process data that can be further processed by the processor 1606 using image recognition software. Once the pixel mapping has been completed a standard (human and machine) recognizable image can be reconstructed and banknote recognition may proceed.

The system 1600 also provides freedom of physical shape since the fibers may be trimmed to different lengths and bent as desired. The compact size of the imaging sensor 1610 allows the imaging sensor 1610 to mount directly to the PCB 16016 along with the processor 1606 and the memory 1608, which is not achievable in other systems without mirrors. This avoids the interference, cost and reliability issues of connectors and cables. The system 1600 also can be installed in various apparatuses of differing manufacturing tolerances, as the sensors 1614, 1616, 1618, 16160, and 1602 can be placed at different areas along the banknote path 1604 as needed, or the sizes or number of the sensors 1614, 1616, 1618, 16160, and 1602 can be altered based on the apparatus. Other systems using lenses and mirrors do not have the same flexibility as the system 1600 to be installed in various currency handling apparatuses.

Although FIGS. 16A and 16B illustrate an example of a banknote imaging system 1600, various changes may be made to FIGS. 16A and 16B. For example, the sensors 1614, 1616, 1618, 16160, and 1602 can be disposed at different locations along the banknote path, such as the width sensors 1616 being disposed after the recognition sensor 16160, and can be disposed in different sizes or including a different number of fibers. In some embodiments, the ratio of pixels to fibers for the imaging sensor 1610 can be changed. For example, four pixels per fiber can be used that, while introducing some redundancy, can be useful to improve signal to noise ratio. In some embodiments, four fibers per pixel can be used, which can degrade calibration performance, but can be compensated for by using weighted values for the pixel mapping.

In some embodiments, secondary lenses can be added to improve the optical coupling of the bundle to the sensor array or to increase the light gathering area of the target receivers. A secondary lens or an array of lenses can be used to increase focusing and alter the field of view of the imaging sensor 1610. In some embodiments, target sensor fibers can be captured at various angles other than normal to the banknote surface. This would allow the inspection of optically variable device (OVD) banknote security features using only one imaging sensor or imaging sensor for all types of sensing, converging into a focal point from a range of angles and allowing for detection of optically variable ink or color reflections. In some embodiments, calibration can be performed using a liquid crystal display (LCD) screen inserted in the banknote path 1604. Each pixel in the LCD can be activated in turn by an attached display controller. When in calibration mode, the LCD screen steps through each pixel in turn while also communicating with the device under testing. This allows the spatial calibration process to be automated, economical and reliable. In some embodiments, clustering of fibers in areas of high spatial interest and using sparse bundles for areas with less demanding requirements can be used, such as using a lower density for banknote edges, and a higher density for high interest areas.

In some embodiments, the imaging sensor 1610 can be used to capture images using transmissive or reflective methods. In some embodiments, a single imaging sensor can be used for both reflective and transmissive methods to capture images of both sides of the banknote by enabling or disabling a light source at different times. In some embodiments, an imaging sensor can be disposed on each side of the banknote path 1604 to capture images in a reflective mode. In some embodiments, each side of the banknote path 1604 can be illuminated to facilitate the capturing of images in reflective and/or transmissive modes.

The various embodiments of this disclosure provide a coin handling apparatus or coin validator including a coin imaging system that includes a processor, a memory, and an imaging sensor. The coin imaging system disclosed in the various embodiments of this disclosure can be included in the unattended payment systems of the various embodiments of the present disclosure, such as the unattended payment systems 100-130, 900, 1000, 1100, 1200, 1300, and 1400, and/or the payment acceptors disclosed in the various embodiments of this disclosure, such as the coin deposit withdrawal systems 300-330, or payment acceptors 400, 500, 600, 700, and 800. The imaging sensor is coupled to one or more fiber optic sensors, such as fiber optic bundles, positioned at various points in relation to a coin path to detect coins travelling along the coin path in order to provide the system with various information concerning the coins. The coin imaging system in various embodiments provides a single imaging sensor or imaging sensor that is capable of multiple functions by being able to detect various characteristics of coins and different positions of coins in the coin path via the fiber optic sensors. In various embodiments, the coin imaging system can be calibrated to map pixels of the imaging sensor to the optical fibers of the fiber optic sensors, and a spatial distribution for the pixels can be stored the memory. This map can be used to pre-process data that can be further processed by the processor using image recognition software. Once the pixel mapping has been completed a standard (human and machine) recognizable image can be reconstructed and coin recognition may proceed.

In various embodiments of this disclosure, the coin imaging system provides freedom of physical shape since fibers may be trimmed to different lengths and bent as desired. The imaging sensor can be of a compact size allowing the imaging sensor to mount directly to a printed circuit board along with the processor and the memory, which is not achievable in other systems without mirrors. This avoids the interference, cost and reliability issues of connectors and cables. The coin imaging system also can be installed in various apparatuses of differing manufacturing tolerances, as the fiber optic sensors can be placed at different areas along the coin path as needed, or the sizes or number of the fiber optic sensors can be altered based on the apparatus. Other systems using lenses and mirrors do not have the same flexibility as the coin imaging system of this disclosure to be installed in various currency handling apparatuses.

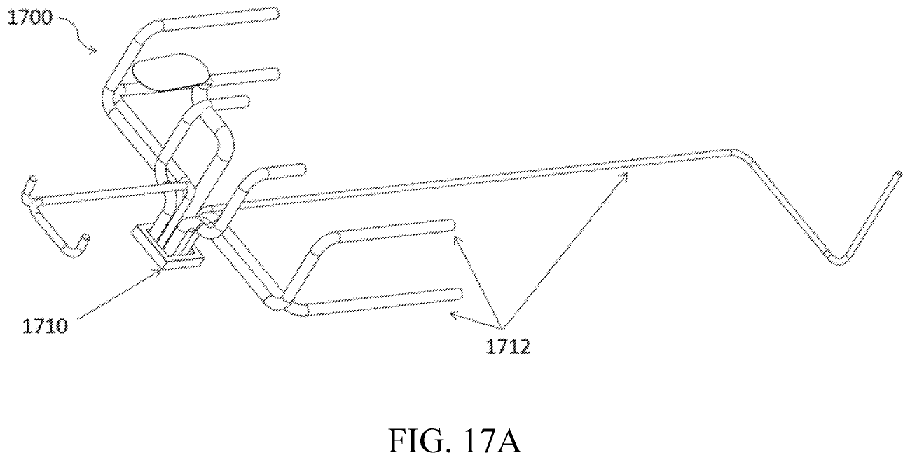

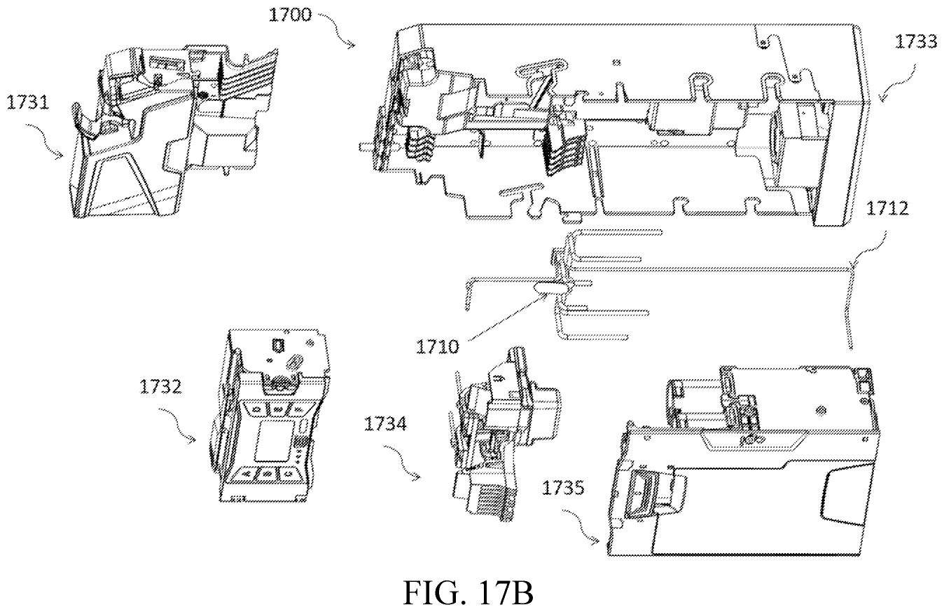

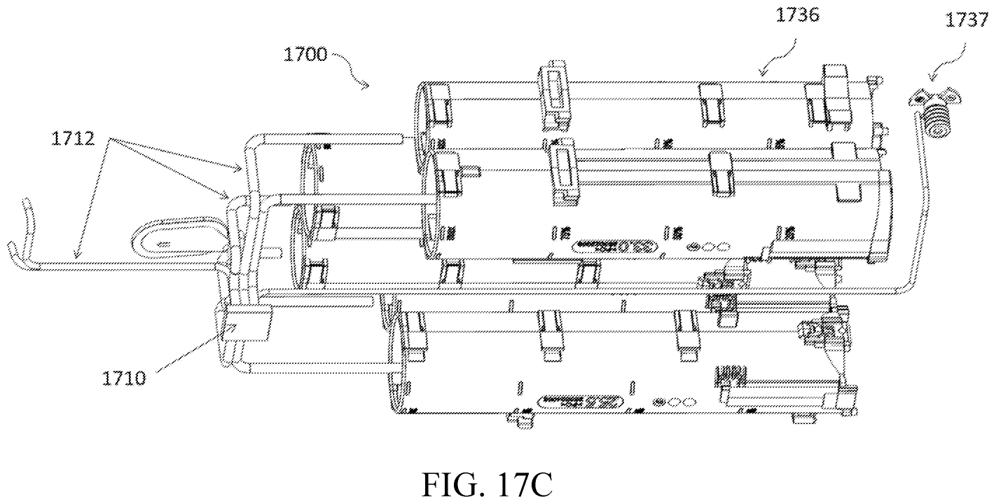

FIGS. 17A, 17B and 17C illustrate an example coin imaging system 1700 according to various embodiments of this disclosure. The system 1700 can be used as part of the unattended payment systems of the various embodiments of the present disclosure, such as the unattended payment systems 100-130, 900, 1000, 1100, 1200, 1300, and 1400, and/or the payment acceptors disclosed in the various embodiments of this disclosure, such as the coin deposit withdrawal systems 300-330, or payment acceptors 400, 500, 600, 700, and 800, or with any other suitable currency apparatus. The system 1700 includes an imaging sensor 1710 and fiber optic cables 1712. One end of all fiber optic cables 1712 originate from the imaging sensor 1710 and other ends of the fiber optic cables 1712 reach into various locations of the coin imaging system 1700. It will be understood that the coin imaging system 1700 illustrated in FIGS. 17A and 17B is an example, and the coin imaging system 1700 can include various shapes, dimensions, lengths, or other characteristics without deviating from the present disclosure.

The example coin acceptor shown in FIGS. 17B and 17C includes a coin accepting bezel 1731, a coin accepting module 1732, chassis 1733, gates module 1734, and coin tubes module 1735. The coin tubes module 1735 includes coin tubes 1736 and a motor or a solenoid 1737. An inserted coin enters through the coin accepting bezel 1731 and into the coin accepting module 1732. If deemed acceptable, then the coin enters the coin tubes 1736 through the gating module 1734. The fiber optic cables 1712 can track movement of the coin through the coin accepting bezel 1731, the coin accepting module 1732, the gating module 1734 and into the coin tubes 1736. A PCB inside the coin acceptor 1700 has included thereon a central processing unit (CPU) or processor and a memory. The processor can process imaging signals received via an imaging sensor 1710, such as signals that include image data pertaining to coins travelling along a coin path. The memory can store the image data, such as raw image data and processed image data created by the processor manipulating the raw image data according to various processes described herein to retrieve information from the raw image data concerning the subject, such as coin details.

In some embodiments, the imaging sensor 1710 can be a camera. In some embodiments, the imaging sensor 1710 can include a sensor array, such as a charge coupled device (CCD) sensor array or a complementary metal oxide semiconductor (CMOS) sensor array, or any other optical sensor array that receives light transmitted to the imaging sensor. The sensor array of the imaging sensor 1710 is coupled to an optical fiber bundle that is bifurcated into a plurality of optical fiber sub-bundles 1712 that each are operable to transmit light with high efficiency via total internal reflection. In various embodiments of this disclosure, the size aspect ratio and number of the fibers in the bundle is closely matched to the size of the number of pixels in the sensor array of the imaging sensor 1710. In some embodiments, there may be no attempt to optically correlate the fibers in the plurality of optical fiber sub-bundles 1712 to any particular location on the sensor array of the imaging sensor 1710. Each one of the plurality of optical fiber sub-bundles 1712 is flexible, and can be folded as needed to reach various positions along the coin path of the coin accepting bezel 1731, the coin accepting module 1732, the gating module 1734 and the coin tubes 1736 in order to provide to the imaging sensor 1710 various images providing various information on coins as the coins travel along the coin path.

Each one of the plurality of optical fiber sub-bundles 1712 can be encapsulated into target sensor areas along the coin path, and can be disposed at a particular distance around a wall of the coin path so that the plurality of optical fiber sub-bundles 1712 does not interfere with the progress of the coin along the coin path, while still being able to capture images of at least a portion of the coin. As such, the plurality of optical fiber sub-bundles 1712 can be installed in various configurations within a currency handling apparatus or coin validator at different positions along the coin path. For example, as shown in the examples of FIGS. 17A and 17B, the plurality of optical fiber sub-bundles 1712 include start sensors in the coin accepting bezel 1731 disposed near an entrance to the coin path, tracking sensors disposed further along the coin path from the coin accepting module 1732 disposed further still along the coin path, a recognition sensor disposed in the coin accepting module 1732 still along the coin path, and tracking sensors in the gating module 1734 disposed near an exit of the coin path. The coin path ends in the coin tubes 1736, where fiber optic cables can carry images of coins in coin tubes 1736 to the imaging sensor 1710. The imaging sensor 1710 can be divided into channels for capturing images via each of the different locations 1731, 1732, 1733, 1734, 1735, and 1736. In some embodiments, the imaging sensor 1710 can capture 4 or 5 pixels per fiber.

Many of the features and aspects presented herein can be applied to other currency processing systems without departing from the intended scope and spirit of the present disclosure. The inventive aspects of the present disclosure, however, are not limited to coins processing systems utilizing sorting disks and could be utilized in other currency processing systems, such as belt and rail systems, regardless of speed as long as the coin position is controlled. In addition, although differing in appearance, the coin processing systems and devices depicted and discussed herein can each take on any of the various forms, optional configurations, and functional alternatives described above and below with respect to the other disclosed embodiments, and thus can include any of the corresponding options and features.

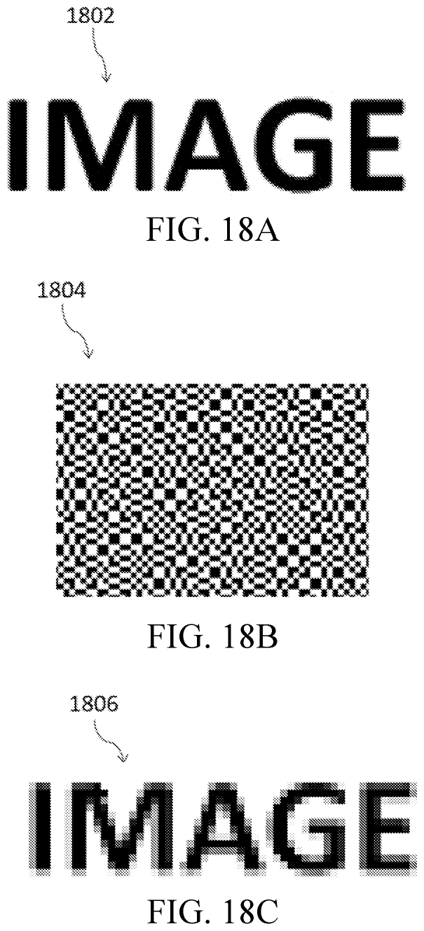

FIGS. 18A-18C illustrate examples image types in accordance with various embodiments of this disclosure. FIG. 18A illustrates an example original image 1802 as viewed by the imaging sensors 1610 and 1710. FIG. 18B illustrates an example captured image 1804 as captured by the imaging sensor 1610 and 1710 via the various sensors. FIG. 18C illustrates an example decoded image 1806 after reverse mapping.

As described with respect to FIGS. 16A, 16B, 17A, 17B and 17C the differing sizes and number of fibers of the sensors 1614, 1616, 1618, 1620, and 1622, and the placement of the sensors, provide for variable resolutions based on the type of information to be determined for each sensor. Accordingly, the optical areas of interest are available to the sensor but each pixel is effectively randomized in spatial location. This would ordinarily result in a scrambled image, but the processor 1606 can be calibrated to use the image since, once the system 1600 and/or 1700 is installed in an apparatus, the spatial distribution can be fixed over the life of the sensor or system 1600 and 1700, and the spatial distribution can be learned at a manufacturing calibration stage. The system 1600/1700 is calibrated to map the pixels and the spatial distribution is stored in the memory. This map can be used to pre-process data that can be further processed by the processor using image recognition software. Once the pixel mapping has been completed a standard (human and machine) recognizable image can be reconstructed and banknote recognition may proceed.

FIG. 18A shows how the original image 1802 of a subject would appear to the imaging sensor 1610 and/or 1710 at a normal aspect ratio. FIG. 18B shows an example of how the captured image 1804 of the original image 1802 would appear to the imaging sensor 1610/1710 when captured via the various sensors in systems such as the banknote imaging system 1600 and the coin imaging system 1700. Since the aspect ratio is different for the imaging sensor 1610/1710 due to the spatial distribution of the imaging sensor 1610/1710 between the sensors the captured image 1804 appears scrambled to the human eye. However, since the banknote imaging system 1600 and coin imaging system 1700 have been calibrated based on the spatial distribution of the sensors on the imaging sensor 1610/1710, the imaging sensor 1610/1710 and the processor can determine from the captured image 1804 the details of the subject, such as a serial number on a banknote or embossing information on a coin, or can use the captured image 304 to create a usable image.

FIG. 18C shows an example decoded image 1806 that has been reconstructed by reverse mapping the captured image 1804 using the mapped spatial distribution. This decoded image 1806 can then be used by the banknote imaging system 1600 or the coin imaging system 1700, or a human, to detect various characteristics of the image, such as serial numbers, objects such as strings or tape attached to banknotes, security components, denominations of banknotes, embossing on coin or other characteristics. In some embodiments, modified banknote recognition methods can be used based on agnostic image analysis of pixel to pixel variation that are blind to the human visualization of the banknote. In some embodiments, modified coin recognition methods can be used based on agnostic image analysis of pixel to pixel variation that are blind to the human visualization of the coin. The recognition can thus be done directly on the scrambled pixel data of the captured image 1804.

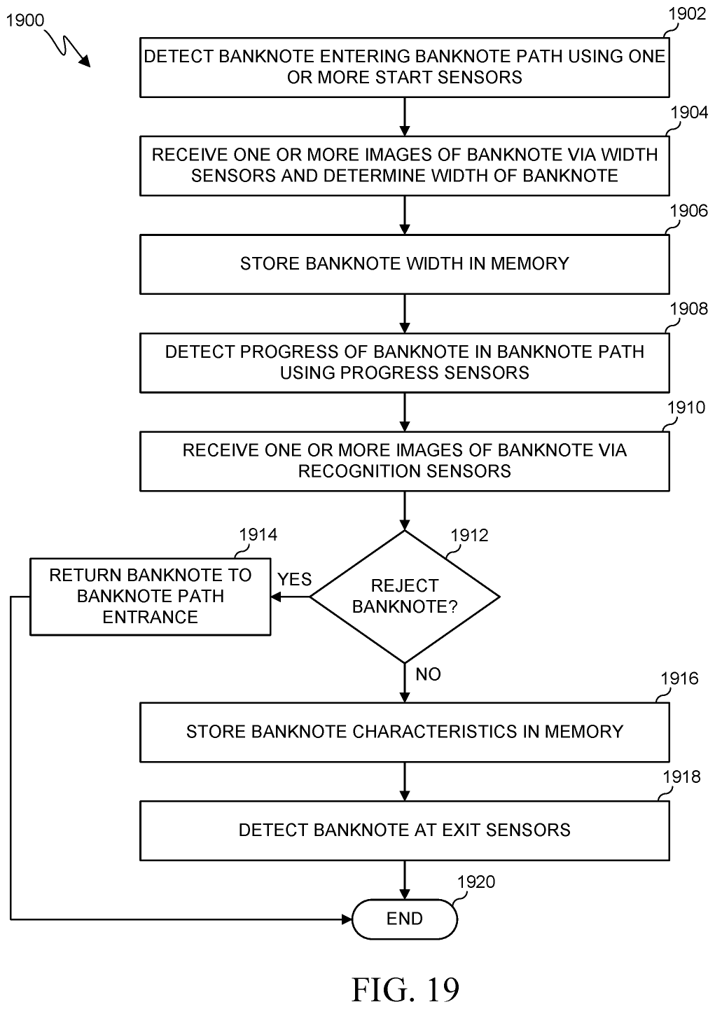

FIG. 19 illustrates an example banknote detection process 1900 in accordance with various embodiments of this disclosure. FIG. 19 does not limit the scope of this disclosure to any particular embodiments. While the flowchart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. It will be understood that the process 1900 is described with respect to a processor of the unattended payment systems 100-130, 900, 1000, 1100, 1200, 1300, and 1400, the payment acceptors disclosed in the various embodiments of this disclosure, such as the banknote acceptors 200-280, 400, 500, 600, 700, and 800, and/or the banknote imaging system 1600, such as the processor 1606. However, the process 1900 can be used with any other suitable device(s) and in any suitable system.

At block 1902, the processor detects a banknote entering a banknote path using one or more start sensors, such as start sensors 1614. The start sensors can be placed near an entrance to the banknote path and can be fiber optic bundles that transmit light to an imaging sensor, such as the imaging sensor 1610, to capture at least one image of the area near the entrance to the banknote path. The processor can then use the image of this area of the banknote path to determine if a banknote has entered the banknote path. At block 1902, the processor receives one or more images of a banknote via one or more width sensors, such as the width sensors 1616. The processor can then use the received images to determine a width of the banknote based on where the edges of the banknote appear in the images. At block 1906, the processor can store the determined banknote width in memory, such as the memory 1608.

At block 1908, the processor detects the progress of a banknote in the banknote path using one or more progress sensors, such as progress sensors 1618. At block 1910, the processor receives one or more images of a banknote via one or more recognition sensors, such as the recognition sensor. The processor can use the images received via the recognition sensor and the imaging sensor to read various banknote characteristics, such as serial numbers, strings or tape attached to banknotes, security components of banknotes, denominations of banknotes, or other banknote characteristics. The processor can use the banknote characteristics to determine if a banknote should be accepted or rejected and can store the various banknote characteristics to track the banknote as it is stored and transferred through a currency handling apparatus.

At decision block 1912, the processor determines whether to reject the banknote based on the banknote characteristics. If so, the process 1900 moves to block 1914. At block 1914, the processor controls the banknote apparatus to return the banknote back to the banknote path entrance. In some embodiments, the banknote can be stored in a temporary storage unit or can be returned to a user through a separate rejection path of the banknote apparatus. The process 1900 then ends at block 1920. If, at decision block 1912, the processor determines that the banknote is accepted, the process 1900 moves to block 1916. At block 1916, the processor stored the banknote characteristics in memory for the accepted banknote. This way, the processor does not store information concerning rejected banknotes. At block 1918, the processor detects a banknote at one or more exit sensors, such as the exit sensors 1622. Detection of a banknote at the exit sensors indicates that an accepted banknote is exiting the banknote path, such as being transferred to a storage location in a currency handling apparatus, or such as transitioning to a different transport area of the currency handling apparatus. The process 1900 then ends at block 1920.

Although FIG. 19 illustrates an example of a banknote detection process 1900, various changes may be made to FIG. 19. For example, the process 1900 may not include one or more of blocks 1902, 1902, 1906, 1908, or 1918, such as if a system using the process 1900 does not include start sensors, width sensors, progress sensors, and/or exit sensors. In some embodiments, block 1916 can be performed before decision block 1912, such as if the processor is configured to store information even for banknotes that are rejected, such as to track unauthentic banknotes that are again attempted to be introduced into the banknote handling apparatus.

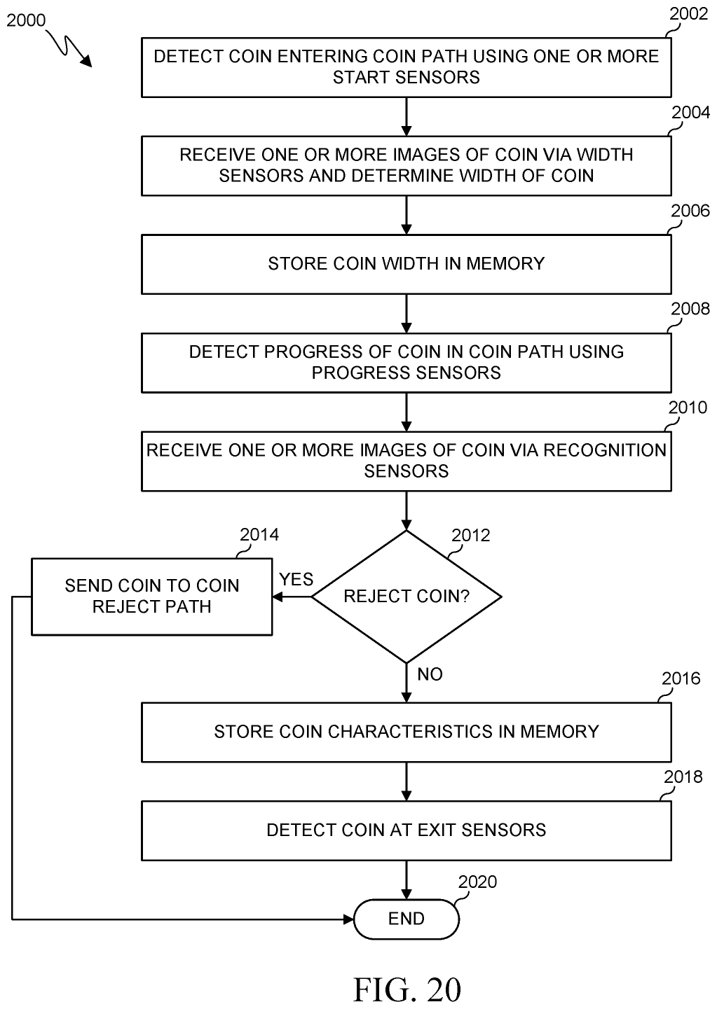

FIG. 20 illustrates an example coin detection process 2000 in accordance with various embodiments of this disclosure. FIG. 20 does not limit the scope of this disclosure to any particular embodiments. While the flowchart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. It will be understood that the process 2000 is described with respect to a processor of the unattended payment systems of the various embodiments of the present disclosure, such as the unattended payment systems 100-130, 900, 1000, 1100, 1200, 1300, and 1400, the payment acceptors disclosed in the various embodiments of this disclosure, such as the coin deposit withdrawal systems 300-330 or payment acceptors 400, 500, 600, 700, and 800, and/or the coin imaging system 1700. However, the process 2000 can be used with any other suitable device(s) and in any suitable system.

At block 2002, the processor detects a coin entering a coin path using one or more start sensors, such as start sensors located in the coin accepting bezel 1731. The start sensors can be placed near an entrance to the coin path and can be fiber optic bundles that transmit light to an imaging sensor, such as the imaging sensor 1710, to capture at least one image of the area near the entrance to the coin path. The processor can then use the image of this area of the coin path to determine if a coin has entered the coin path. At block 2002, the processor receives one or more images of a coin via one or more tracking sensors and/or recognition sensor, such as in the coin accepting module 1732. The processor can then use the received images to determine a width of the coin based on where the edges of the coin appear in the images. At block 2006, the processor can store the determined coin width in memory.

At block 2008, the processor detects the progress of a coin in the coin path using one or more progress sensors, such as by the gating module 1734. At block 2010, the processor receives one or more images of a coin via one or more recognition sensors, such as in the coin accepting module 1732. The processor can use the images received via the recognition sensor and the imaging sensor to read various coin characteristics, such as serial numbers, strings or tape attached to coins, security components of coins, denominations of coins, or other coin characteristics. The processor can use the coin characteristics to determine if a coin should be accepted or rejected and can store the various coin characteristics to track the coin as it is stored and transferred through a currency handling apparatus.

At decision block 2012, the processor determines whether to reject the coin based on the coin characteristics. If so, the process 2000 moves to block 2014. At block 2014, the processor controls the coin apparatus to return the coin back to the coin path entrance. In some embodiments, the coin can be stored in a temporary storage unit or can be returned to a user through a separate rejection path of the coin apparatus. The process 2000 then ends at block 2020. If, at decision block 2012, the processor determines that the coin is accepted, the process 2000 moves to block 2016. At block 2016, the processor stored the coin characteristics in memory for the accepted coin. This way, the processor does not store information concerning rejected coins. At block 2018, the processor detects a coin at one or more coin tubes, such as coin tubes 1736. Detection of a coin at the coin tube sensors indicates that an accepted coin is entered in the coin tubes, such as being transferred to a storage location in a currency handling apparatus, or such as transitioning to a different transport area of the currency handling apparatus. The process 2000 then ends at block 2020.

Although FIG. 20 illustrates an example of a coin detection process 2000, various changes may be made to FIG. 20. For example, the process 2000 may not include one or more of blocks 2002, 2002, 2006, 2008, or 2018, such as if a system using the process 2000 does not include start sensors, width sensors, progress sensors, and/or exit sensors. In some embodiments, block 2016 can be performed before decision block 2012, such as if the processor is configured to store information even for coins that are rejected, such as to track unauthentic coins that are again attempted to be introduced into the coin handling apparatus.

This disclosure provides a coin acceptor configured to take images of embossing on an inserted coin. The coin acceptor is configured to automatically take images of a coin by using both direct reflection and side reflection using an imaging sensor and an illumination source.

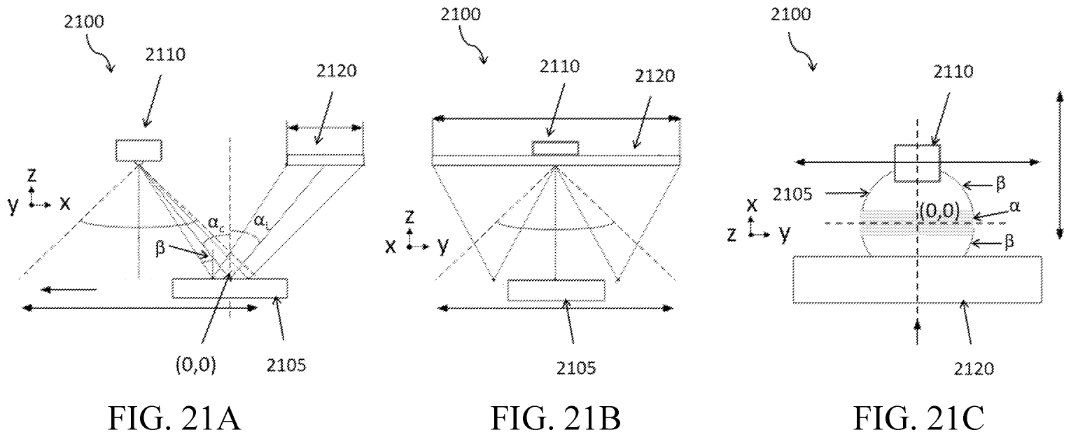

FIGS. 21A-21C illustrate an example of a coin imaging system 2100 in accordance with various embodiments of this disclosure. The coin imaging system 2100 can be used as part of the unattended payment systems of the various embodiments of the present disclosure, such as the unattended payment systems 100-130, 900, 1000, 1100, 1200, 1300, and 1400, and/or the payment acceptors disclosed in the various embodiments of this disclosure, such as the coin deposit withdrawal systems 300-330, or payment acceptors 400, 500, 600, 700, and 800, or with any other suitable currency apparatus. A coin acceptor such as those described above can include the coin imaging system 2100 in addition to other coin authentication sensors such as magnetic, inductive or capacitive sensors that detect properties of coin material. The coin acceptor includes a transportation path to transport a coin for validation. The coin imaging system 2100 includes an imaging sensor 2110 and an illumination source 2120 to take images of coin 2105. The imaging sensor 2100 takes images of the coin 2105 when the coin 2105 is moving. The imaging sensor 2110 and the illumination source 2120 are arranged in such a manner that a slice of a coin 2105 “α” is imagined under direct reflection and slices of coin 2105 “β” imagined under side reflection. The imaging sensor 2110 and the illumination source 2120 are arranged on the same side of the coin transportation path serially. As the coin 2015 moves inside the coin transportation path, the slice of coin under direct illumination moves and multiple images of the coin are taken.

In some embodiments, the illumination source 2120 is larger than the imaging sensor 2110. This configuration ensures that coin slice is uniformly illuminated. In some embodiments, the imaging sensor system 2100 could be similar to imaging sensor system 1700 as explained in FIGS. 17A-17C. The imaging sensor 2110 can receive images of the coin 2105 through fiber optic cables. In some embodiments, the imaging sensor 2100 can receive images of the coin 2105 through mirrors, a reflective surface, or a refractive surface.

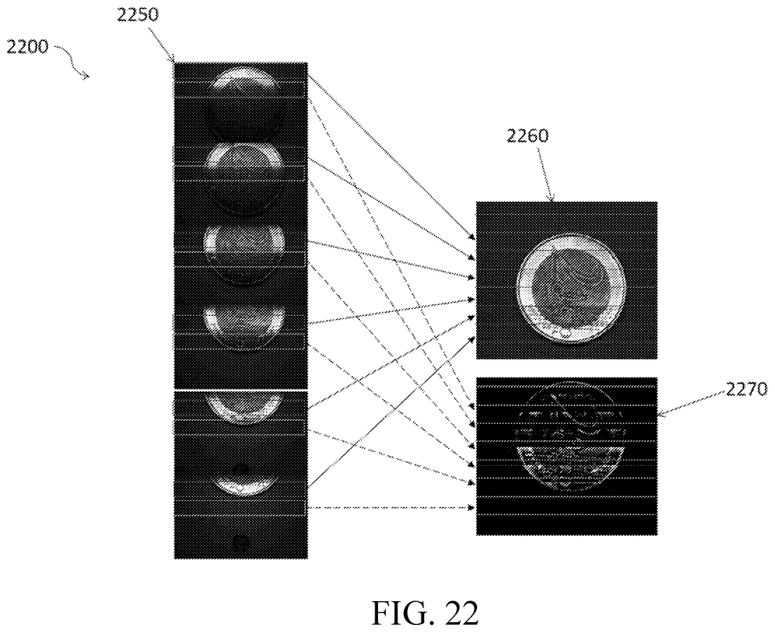

FIG. 22 illustrates images of a genuine coin captured under the coin imaging system 2100. Image blocks 2250 show image slices of coins under both direct reflection and side reflection. A processor in the coin imaging sensor system 2100 then stiches images taken under direct reflection to form an image of the coin 2105 in direct reflection as illustrated by 2260. The processor in the coin imaging sensor system 2100 then stiches images taken under side reflection to form an image of the coin 2105 in side reflection as illustrated by 2270. The processor can create more than one image of the coin 2105 under side reflections as only a portion of the coin 2105 is under direct illumination and remaining portions are under side reflection. The processor can compare images 2260 and 2270 captured and stitched under direct reflection and side reflection to analyze contrast between these figures. This contrast between images 2260 and 2270 can be generated by embossing on the coin 2105.

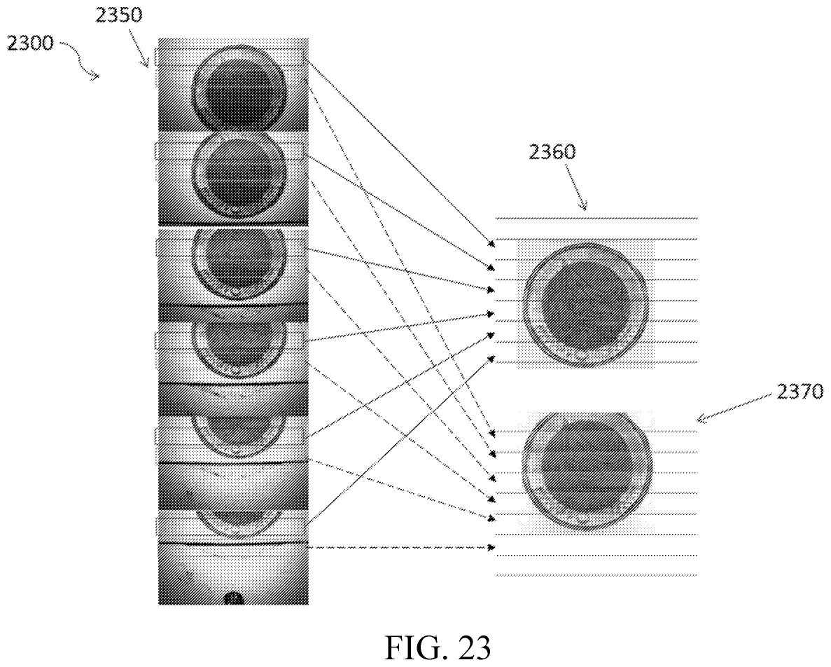

FIG. 23 illustrates images of a non-genuine coin captured under the coin imaging system 2100. Image blocks 2350 show image slices of coins under both direct reflection and side reflection. A processor in the coin imaging sensor system 2100 then stiches images taken under direct reflection to form an image of the coin 2105 in direct reflection as illustrated by 2360. The processor in the coin imaging sensor system 2100 then stiches images taken under side reflection to form an image of the coin 2105 in side reflection as illustrated by 2370. The processor can create more than one image of the coin 2105 under side reflections as only a portion of the coin 2105 is under direct illumination and remaining portions are under side reflection. The processor can compare images 2360 and 2370 captured and stitched under direct reflection and side reflection to analyze contrast between the images. In this example FIG. 23, the non-genuine coin lacks the contrast between images 2360 and 2370 can be generated by embossing on the coin 2105. This lack of contrast could indicate that the coin may not have genuine embossing.

The imaging sensor system 2100 captures images of a side of the coin 2105 in both direct reflection and side reflection. These images create images with contrast because of embossing on the coin 2105. The illumination source 2120 allows the imaging sensor 2110 to take images of the coin 2105 where both direct and side reflections are taken through the same time frame and image processing allows creation of images under direct reflection as shown by 2260 and 2360 and under side reflection as shown by 2270 and 2370 from images 2250 and 2350 respectively. Non-genuine coins made from the same material having a printed image as embossing or coins missing embossing may not produce images with different contrast under direct and side reflections. This absence or presence of contrast between images 2260 and 2270 as well as 2360 and 2370 can differentiate between genuine and non-genuine coins. In addition, by examining contrast between images 2260 and 2270, a proper image of the embossing of a coin can be reconstructed. Coins with improper embossing can be deemed non-genuine if the embossing pattern does not match.

In some embodiments, another set of coin image sensor system 2100 can be placed on the opposite side of the first set of coin image sensor system 2100 to take images of both side of the coin. In some embodiments, a single image sensor system 2100 can be employed with passing the coin through the image sensor system 2100 after inverting the coin to take images of both sides of the coin. In some embodiments, fiber optic cables could be used to take images from one or both side of the coin.

This disclosure provides a coin changer configured to automatically detect a cassette configuration so that the coin changer can determine which cassettes are loaded for specific coin denominations. The coin changer is also configured to detect when a coin is improperly filled, or if a coin is misrouted, so that the condition can be detected and corrected before a payout error, or a coin jam occurs. In some embodiments, a coin changer includes one or more imaging sensors or imaging sensors that view a coin tube cassette of the coin changer, and the coin stack therein, from above. In some embodiments, a single imaging sensor can be used with image redirecting features, or a plurality of imaging sensor can be used, with an imaging sensor placed above each of the coin tubes in the coin changer. The imaging sensor viewing the coin stack captures one or more images of the coin stack, including the topmost coin. The imaging sensor also captures images of identifying marks on the coin tube. In some embodiments, the identifying marks can be an encoded tube identifier (ID) for automatic cassette configuration.

Coin changers with field configurable cassettes cannot automatically detect the coin cassette configuration (i.e., what coin tubes are in what position). The coin cassette configuration has to be manually loaded into the product in manufacturing or by the customer. Further, these coin changers cannot detect when a coin tube is improperly filled, such as filling a tube with the incorrect coin denomination, or if a coin is misrouted, such as if the coin changer intended to place a coin in position a first position, but the coin was instead placed in a second, unintended, position. In such events, the result is a payout jam, or the customer receives incorrect change.

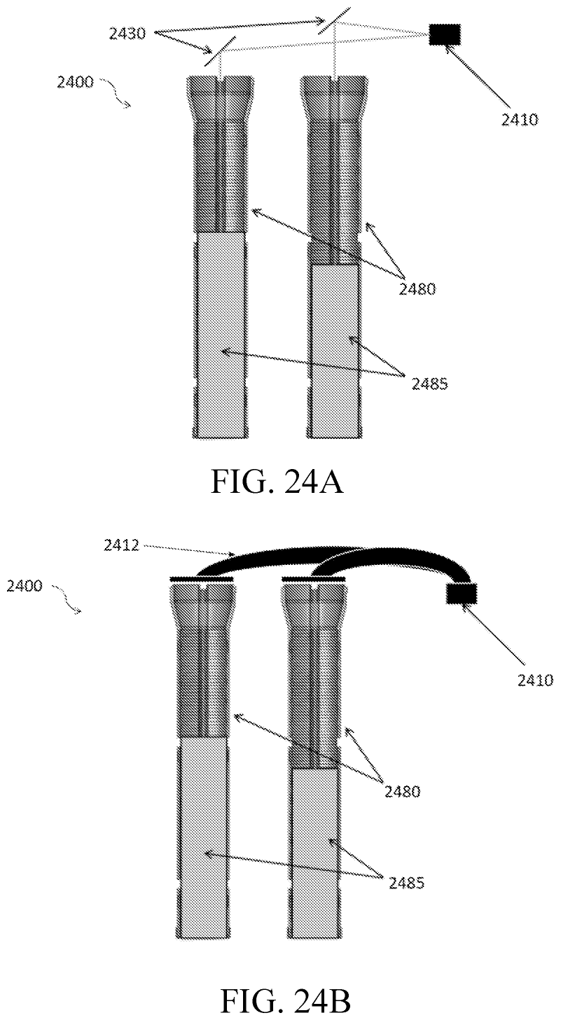

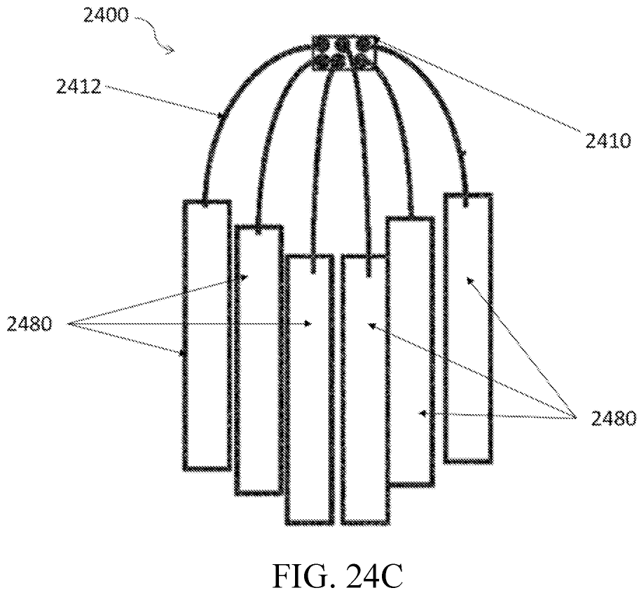

FIGS. 24A-24C illustrate an example coin tube imaging system 2400 according to various embodiments of the present disclosure. The coin tube imaging system 2400 can be used as part of the unattended payment systems of the various embodiments of the present disclosure, such as the unattended payment systems 100-130, 900, 1000, 1100, 1200, 1300, and 1400, and/or the payment acceptors disclosed in the various embodiments of this disclosure, such as the coin deposit withdrawal systems 300-330, or payment acceptors 400, 500, 600, 700, and 800, or with any other suitable currency apparatus. The coin tube imaging system shown in FIGS. 24A-24C is for illustration only. Other coin tube imaging systems could be used without departing from the scope of the present disclosure.

The coin tube imaging system includes at least one imaging sensor 2410 or spatially resolving optical sensor 2410 positioned within a coin changer to capture one or more images of one or more coin tubes 2480 or coin cassettes in the coin changer 2400. Coins 2485 are stored inside the coin tubes 2480. An evaluation unit coupled to the at least one imaging sensor is configured to receive at least one spatially resolved image. In some embodiments, a single imaging sensor 2410 can be positioned such that the imaging sensor can view each of the coin tubes 2480 in the coin changer. As illustrated in FIG. 24A, each coin tube 2480 can have a mirror 2430 disposed above the coin tube 2480 that reflects an image of the inside of the coin tube 2480 that can be captured by the imaging sensor 2410 positioned in view of each of the mirrors 2430. In some embodiments, the coin tube imaging system includes a single imaging sensor 2410 that captures images of each of the coin tubes 2480 via one or more optical fiber bundles 2412 connected between the imaging sensor and one or more coin tubes 2480. In some embodiments, the coin tube imaging system can include multiple imaging sensors 2410, with an imaging sensor 2410 disposed over each of the coin tubes 2480 to capture images of each coin tube 2480.

The at least one imaging sensor 2410 and evaluation unit are configured to capture images of the interior of the coin tube 2480, and to determine a fill level of the coin tube by determining a distance between the imaging sensor 2410, or between the mirror 2430 at the top of a coin tube, and an uppermost coin in the coin tube, as also described in U.S. patent application Ser. No. 10/290,168, which is incorporated herein by reference in its entirety. In some embodiments, the evaluation unit is configured to evaluate the at least one spatially resolved image to detect a diameter (“d”) of an uppermost coin in the at least one coin tube and determine the fill level of the at least one coin tube from a ratio between i) one of the inner or the outer diameter (“D”) of the at least one coin tube on the spatially resolved image and ii) the detected diameter d of the uppermost coin in the coin tube. In some embodiments, the distance takes into account a defined distance according to the following equation:

$$a = \frac{A \cdot D}{d}$$

wherein:

a is distance of the at least one spatially resolving optical sensor from the uppermost coin filled into the coin tube, or a distance between a mirror or optical fiber from the uppermost coin filled into the coin tube;

A is the distance of the at least one spatially resolving optical sensor from the topside of the at least one coin tube, or a distance of a mirror or optical fiber from the topside of the at least one coin tube;

d is the diameter of the uppermost coin filled into the coin tube in the spatially resolved image; and

D is the inner or outer diameter of the at least one coin tube in the spatially resolved image.

In addition to fill level, the imaging sensor and/or the evaluation unit is also configured to detect a tube ID of the coin tubes that is used to identify various information regarding a specific coin tube. For example, the tube ID can identify a type of coin denomination intended for the coin tube. The tube ID can be encoded using a variety of methods, such as a number of markings (lines, arcs, symbols, or other shapes), a color of such markings, a barcode, a quick response code or other type of matrix barcode, or combinations thereof. In some embodiments, NFC tags can be included on the coin tubes to identify the coin tubes. The tube ID can be applied to coin tubes in many ways, such as being molded into the tube, adhered to the tube as a label, via pad printing or silk screening, laser etched onto the tube, or combinations thereof. In encoding a tube ID and applying the encoding to a coin tube, a sufficient bit depth is used in the encoding that can be detected by the imaging sensor.

One or more images of a coin in the coin tube are used to detect mis-filled or mis-routed coins. Having stored the tube ID, the evaluation unit compares the actual image of the coin with known good image data for the coin that is associated with the tube ID of the particular coin tube. If there is a mismatch, a mis-route or mis-fill is detected. In some embodiments, to enhance image quality, the coin tube can be a black tube, or include a black interior, with serrations on an inner diameter of the coin tube. The black interior and the serrations minimize reflections from sidewalls of the tube, improving coin edge detection capability. In some embodiments, one or more of the coin tubes can include white markings in an interior of the coin tube that serve as a tube ID that are captured in images by the imaging sensor.

It will be understood that various changes can be made to FIG. 24 without departing from the scope of the present disclosure. For example, in some embodiments, raised pins can be included on a coin tube that, depending on the number and locations of the raised pins, the evaluation unit detects insertion of the coin tube in the coin changer, and detects the information concerning the coin tube, such as denomination type. Other coin changers may use raised pins on a coin cassette, not per tube, and such configuration of the cassette is locked by the manufacturer, whereas using pins per tube allows for different configurations by the end-user. In some embodiments, mis-routes can be detected using recognition coils above each tube. In some embodiments, a mass-based tube level sensing system can be used to detect a misroute. In some embodiments, a mass-based tube level sensing system can be combined with another tube level sensing system to detect mis-fills by comparing a measured coin stack height with a coin stack mass. Combining a mass-based sensing system with a fill level sensing system thus can provide an improved system in which both height and mass is detected, as a mass-based system alone may not detect mis-fill, such as if a stack of dimes weighs the same as another stack of nickels of differing amounts.

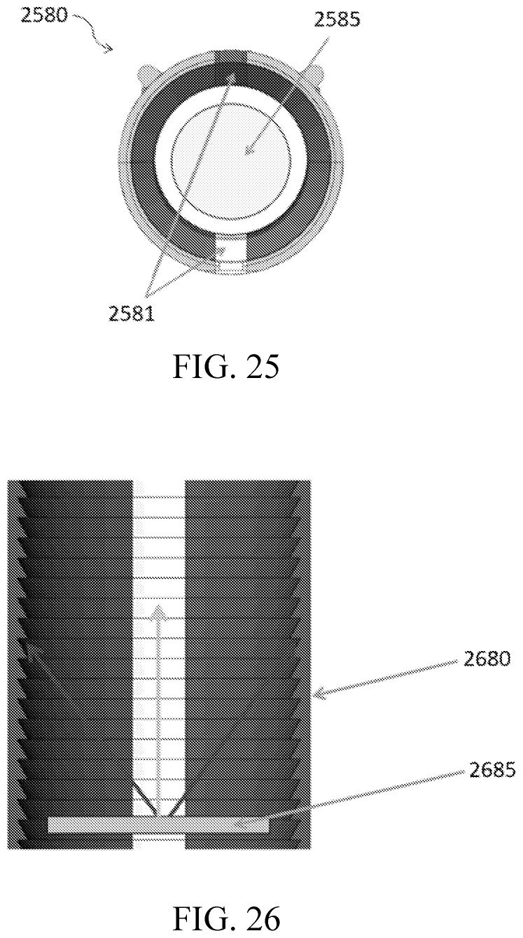

FIG. 25 illustrates an example top view of a coin tube 2580 in accordance with various embodiments of the present disclosure. The coin tube 2580 can be used as part of the unattended payment systems of the various embodiments of the present disclosure, such as the unattended payment systems 100-130, 900, 1000, 1100, 1200, 1300, and 1400, and/or the payment acceptors disclosed in the various embodiments of this disclosure, such as the coin deposit withdrawal systems 300-330, or payment acceptors 400, 500, 600, 700, and 800, or with any other suitable currency apparatus. The coin tube shown in FIG. 25 is for illustration only. Other coin tubes could be used without departing from the scope of the present disclosure.

The coin tube 2580 includes a tube ID 2581 for use in detecting the coin tube and identifying various properties of the coin tube. In various embodiments of the present disclosure, an imaging sensor 2410 can capture images of the coin tube 2580/2480 so that, in addition to fill level of coins 2585, the imaging sensor detects the tube ID 2581 of the coin tube 2580 to identify the various properties of the coin tube. For example, the tube ID 2581 can identify a type of coin denomination intended for the coin tube 2580. The tube ID 2581 can be encoded using a variety of methods, such as a number of markings (lines, arcs, symbols, or other shapes), a color of such markings, a barcode, a quick response code or other type of matrix barcode, or combinations thereof. For example, as shown in FIG. 25, the tube ID 2581 has a number of stripes that identifies the coin tube, as well as a color of the tube ID that also serves to identify the coin tube. In some embodiments, NFC tags can be included on the coin tubes to identify the coin tubes. The tube ID 2581 can be applied to coin tubes in many ways, such as being molded into the tube, adhered to the tube as a label, via pad printing or silk screening, laser etched onto the tube, or combinations thereof. In encoding a tube ID and applying the encoding to a coin tube, a sufficient bit depth is used in the encoding that can be detected by the imaging sensor.

One or more images of a coin in the coin tube are used to detect mis-filled or mis-routed coins. Having stored the tube ID, the evaluation unit compares the actual image of the coin with known good image data for the coin that is associated with the tube ID of the particular coin tube. If there is a mismatch, a mis-route or mis-fill is detected. For example, the tube ID can identify that the coin tube is for storing dimes. Thus, if the imaging sensor and/or the evaluation unit determine that a coin at the top of the coin stack in the coin tube is of a denomination other than dimes, a mis-route or mis-fill signal can be sent, and subsequent operations using the coin tube can be halted until the error is remedied. In some embodiments, to enhance image quality, the coin tube can be a black tube, or include a black interior, with serrations on an inner diameter of the coin tube. The black interior and the serrations minimize reflections from sidewalls of the tube, improving coin edge detection capability. In some embodiments, one or more of the coin tubes can include white markings in an interior of the coin tube that serve as a tube ID that are captured in images by the imaging sensor.

FIG. 26 illustrates an example cross-section of an interior of a coin tube 2680 according to various embodiments of the present disclosure. The coin tube 2680 can be used as part of the unattended payment systems of the various embodiments of the present disclosure, such as the unattended payment systems 100-130, 900, 1000, 1100, 1200, 1300, and 1400, and/or the payment acceptors disclosed in the various embodiments of this disclosure, such as the coin deposit withdrawal systems 300-330, or payment acceptors 400, 500, 600, 700, and 800, or with any other suitable currency apparatus. In some embodiments, the coin tube 2680 is the coin tube 2580. The coin tube shown in FIG. 26 is for illustration only. Other coin tubes could be used without departing from the scope of the present disclosure.

The coin tube 2680 includes a black tube interior with serrations on an inner diameter of the black tube interior. The black surfaces of the interior of the coin tube 2680, coupled with the serrated sides of the interior, can enhance image quality of images taken by an imaging sensor 2410. The black interior and the serrations minimize reflections from sidewalls of the tube, improving coin edge detection capability. In some embodiments, one or more of the coin tubes 2680 can include white markings in an interior of the coin tube that serve as a tube ID that are captured in images by the imaging sensor 2410. A differing number of white markings can be used to differentiate different coin tube types. In some embodiments, the white markings can be one or more white stripes or strips extending from a top of the coin tube to a bottom of the coin tube, such that the one or more lines are viewable in captured images. In some embodiments, the white markings can also assist with coin edge detection, as the white markings can be disposed, or extend down the interior of the coin tube to, edges of one or more coins in the coin stack.

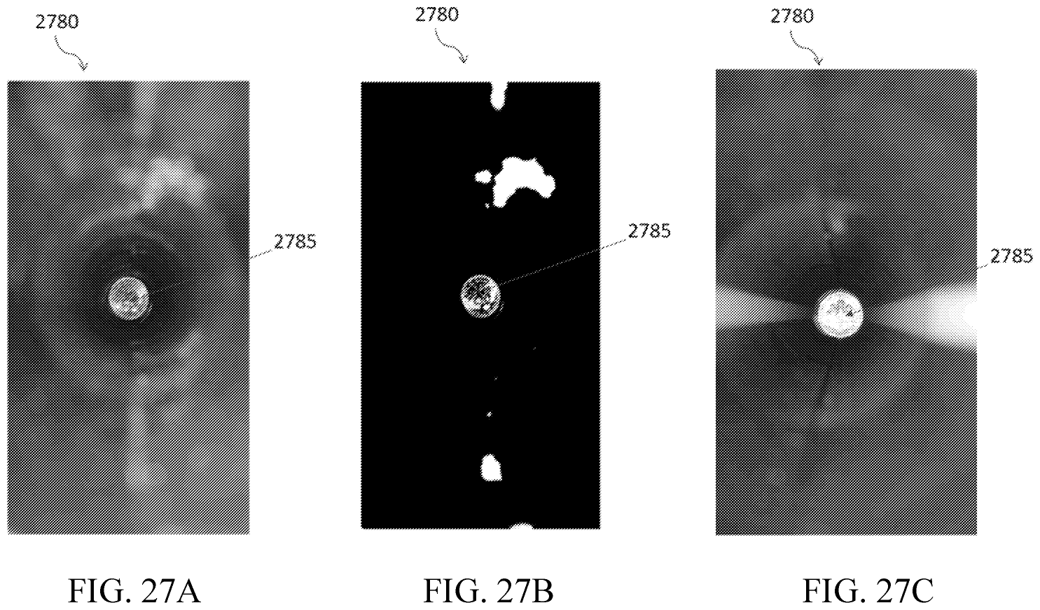

FIGS. 27A-27C illustrate example images of a coin tube captured by an imaging sensor according to various embodiments of the present disclosure. The images shown in FIGS. 27A-27C are for illustration only. Other types of images can be captured without departing from the scope of the present disclosure.

As shown in FIG. 27A, when the imaging sensor captures an images of a coin tube, such as a coin tube 2780 having a black saw tooth or serrated interior as shown in FIG. 27A, a raw coin image can be provided including one or more coins 2785 within the coin tube 2780. The contrast between the black interior walls of the coin tube and the coin, which can be non-black colors such as silver, copper, or other metallic coin colors, allow for the evaluation unit to detect the edges of the coin 2785, as well as read or recognize the denomination of the coin in the coin tube 2780.

As shown in FIG. 27B, in some embodiments, the imaging sensor 2410 and/or the evaluation unit can convert a raw image, such as that shown in FIG. 27A, to a bitmap image. In some embodiments, the bitmap image can be the size of 1 bit, or other sizes. As shown in FIG. 27B, a converted bitmap image can be used to more easily detect coin edges of a coin 2785 in the coin tube 2780, as the coin can, as a result of the conversion, be surrounded by black space in the converted image.

As shown in FIG. 27C, when the imaging sensor captures an images of a coin tube, such as a coin tube 2780 having a black saw tooth or serrated interior as shown in FIG. 27C, a raw coin image can be provided including one or more coins within the coin tube. The contrast between the black interior walls of the coin tube and the coin, which can be non-black colors such as silver, copper, or other metallic coin colors, allow for the evaluation unit to detect the edges of the coin, as well as read or recognize the denomination of the coin in the coin tube. As also shown in FIG. 27C, the coin tube 2780 can include one or more white markings in an interior of the coin tube that contrasts in the image with the black interior of the coin tube 2780. In some embodiments, the white markings are used as a tube ID that identifies the coin tube type, such as identifying a coin denomination for the coin tube. In some embodiments, a different tube ID can be used, and the white markings are used as a further delineation between the walls of the tube and the edges of coins in the coin tube. The image shown in FIG. 27C can also be converted to a bitmap image as described with respect to FIG. 27B.

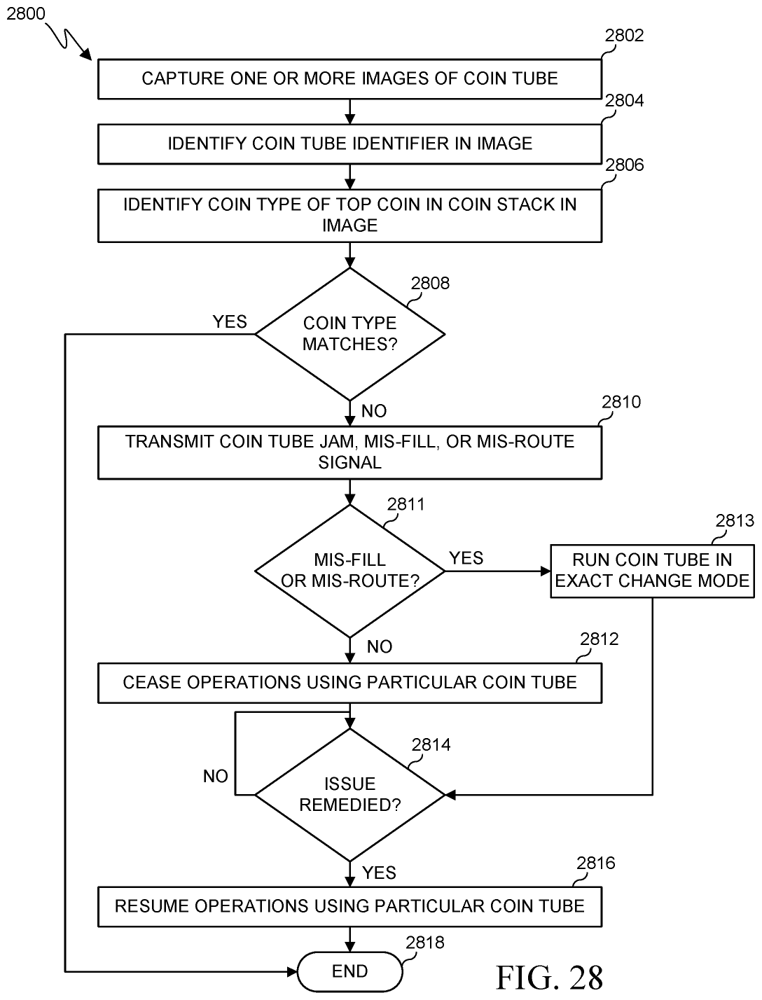

FIG. 28 illustrates an example coin tube imaging process 2800 according to various embodiments of the present disclosure. FIG. 28 does not limit the scope of this disclosure to any particular embodiments. While the flowchart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. It will be understood that the process 2800 is described with respect to a processor of at least one imaging sensor, at least one evaluation unit, or a combination thereof. The process 2000 can be used with the unattended payment systems of the various embodiments of the present disclosure, such as the unattended payment systems 100-130, 900, 1000, 1100, 1200, 1300, and 1400, the payment acceptors disclosed in the various embodiments of this disclosure, such as the coin deposit withdrawal systems 300-330 or payment acceptors 400, 500, 600, 700, and 800, the coin imaging system 1700, and/or the coin tube imaging system 2400. However, the process 2800 can be used with any other suitable device(s) and in any suitable system.

At block 2802, the processor captures one or more images of a coin tube. In some embodiments, the one or more images are captured using at least one imaging sensor or spatially resolving optical sensor positioned within a coin changer to capture one or more images of one or more coin tubes or coin cassettes in the coin changer. In some embodiments, a single imaging sensor can be positioned such that the imaging sensor can view each of the coin tubes in the coin changer. In some embodiments, each coin tube can have a mirror disposed above the coin tube that reflects an image of the inside of the coin tube that can be captured by the imaging sensor positioned in view of each of the mirrors. In some embodiments, a single imaging sensor is used that captures images of each of the coin tubes via one or more optical fiber bundles connected between the imaging sensor and one or more coin tubes. In some embodiments, multiple imaging sensors can be used, with an imaging sensor disposed over each of the coin tubes to capture images of each coin tube. In some embodiments, to enhance image quality, the coin tube can be a black tube, or include a black interior, with serrations on an inner diameter of the coin tube. The black interior and the serrations minimize reflections from sidewalls of the tube, improving coin edge detection capability. In some embodiments, one or more of the coin tubes can include white markings in an interior of the coin tube that serve as a tube ID that are captured in images by the imaging sensor.

The one or more images captured at block 2802 can be raw images, or processed images such as the bitmap image described with respect to FIG. 27B, that the processor analyzes to determine various conditions of the coin tube, such as fill level, coin tube type, and/or issues with the coin tube such as a mis-fill or a mis-route. At block 2804, the processor identifies, using the one or more images, a coin tube ID. Coin tube IDs is used to identify various information regarding a specific coin tube. For example, a tube ID can identify a type of coin denomination intended for the coin tube. The tube ID can be encoded using a variety of methods, such as a number of markings (lines, arcs, symbols, or other shapes), a color of such markings, a barcode, a quick response code or other type of matrix barcode, or combinations thereof. In some embodiments, NFC tags can be included on the coin tubes to identify the coin tubes. The tube ID can be applied to coin tubes in many ways, such as being molded into the tube, adhered to the tube as a label, via pad printing or silk screening, laser etched onto the tube, or combinations thereof. In encoding a tube ID and applying the encoding to a coin tube, a sufficient bit depth is used in the encoding that can be detected by the imaging sensor.

At block 2806, the processor, using the one or more images, identifies a coin type of a top coin in a coin stack in the coin tube. At decision block 2808, the processor determines if the coin type matches a coin type associated with the coin tube ID identified in block 2804. If so, the process 2800 ends at block 2818. If not, the process 2800 moves to block 2810. Having identified and stored the coin tube ID, the processor can compare the actual image of the coin with known good image data for the coin that is associated with the tube ID of the particular coin tube. At block 2810, the processor transmits a coin tube jam, mis-fill, or mis-route signal, such as to a central monitoring system, indicating that there is a jam, mis-fill, or mis-route of at least one coin in the coin stack of the particular coin tube.

At decision block 2811, the processor determines if the coin type mismatch and the transmitted signal at block 2810 were due to a mis-fill or mis-route of one or more coins in the coin tube. If not, the process moves to block 2812. If so, at block 2813, the processor can run the coin tube in exact change mode. The process 2800 then moves to decision block 2814 until the issue in the coin tube is remedied. For example, if a nickel is routed into a quarter dollar tube, the processor can identify the mis-routed nickel in the coin tube allocated for storing quarters using image analysis, as described with respect to the various embodiments of this disclosure. The processor can keep using the coin tube for storing quarters and can continue to dispense quarters until only the nickel is left in the coin tube. Then, when only the nickel is left, the nickel can be dispensed from this coin tube that is allocated for storing quarters, instead of dispensing from a coin tube allocated for storing nickels. Once the misrouted nickel is dispensed, then the empty coin tube allocated for storing quarters can be switched out of exact change mode and used in regular operation.

If, at decision block 2811, the processor determines the issue is not a mis-fill or mis-route, at block 2812, the processor ceases operations using the particular coin tube for which a mismatch has been detected. In some embodiments, the coin exchanger can continue operating using other coin tubes for which no mismatch has been detected. In some embodiments, the coin exchanger may cease overall operation when a mismatch in any tube is detected. In some embodiments, the process 2800 can move from block 2810 to block 2812 even if the detected issue is a mis-fill or mis-route. At decision block 2814, the processor determines if the mismatch issues have been remedied, such as if the processor detects a technician has serviced the machine, and that the identified mismatched coin is no longer present in the coin tube. If not, the process 2800 loops at decision block 2814 until the issue is remedied. If the issue is remedied, at block 28128, the processor resumes operations using the coin tube. The process 2800 ends at block 2818.

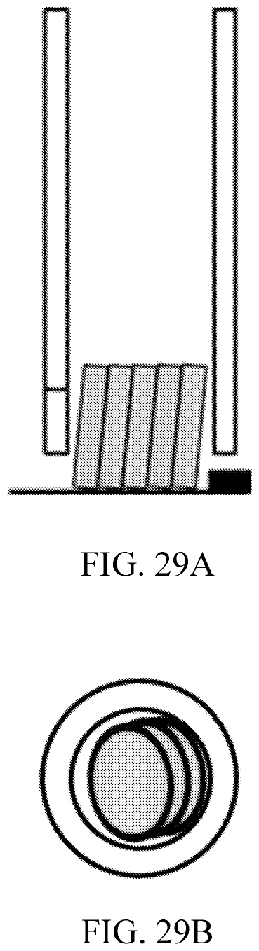

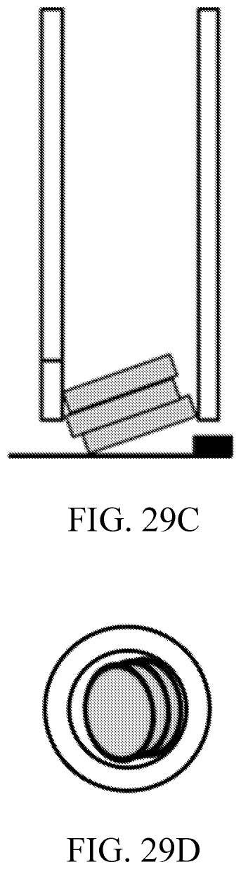

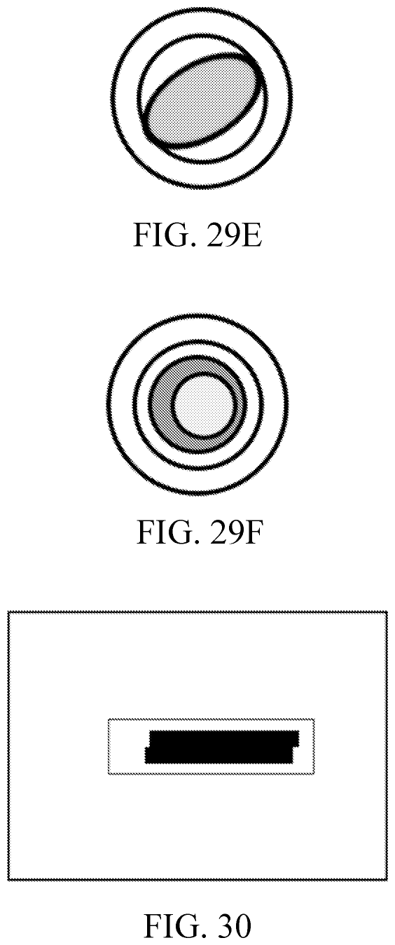

FIGS. 29A-29F illustrates various examples of jammed or improperly places coins in a coin tube in accordance with various embodiments of the present disclosure. FIG. 29A illustrates a side view of coins lying on their sides, instead of lying horizontally, in a coin tube. FIG. 29B illustrates a top view of coins that are lying on their sides, instead of lying horizontally, in a coin tube. FIG. 29C illustrates a side view of jammed coins inside a coin tube. FIG. 29D illustrates a top view of jammed coins inside a coin tube. FIG. 29E illustrates a top view of a jammed coin inside a coin tube. FIG. 29F illustrates a top view of a coin transferred to an incorrect coin tube.

As described in the various embodiments of this disclosure, various states of coin tubes can be identified by the coin tube imaging system, such as coin type, fill level, coin jams, coin misalignments, incorrect coin denominations, or other states. Various states can be identified by image analysis. For example, coin misalignment, i.e., lying on their sides instead of horizontally, as shown in FIGS. 29A and 29B, can be detected by the coin tube imaging system. Coin jams such as shown in FIGS. 29C-29E can also be detected by the coin tube imaging system. Coins transferred or deposited to an incorrect coin tube, as shown in FIG. 29F, can also be detected by the coin tube imaging system. Upon encountering these kinds of situations, the system can either stop using that particular coin tube that has a misalignment, jam, improper coin type, or other issues, the system can operate in exact change mode, or the system can be set to an out-of-service mode. The image analysis provides a unique capacity to selectively not use jammed coin tubes. For example, if a nickel is routed in a coin tube that is used for quarters, then the system can send all subsequent quarters to either a second quarter coin tube or to cashbox, to keep the coin apparatus operational. If there is no spare quarter coin tube, then the system can set the coin apparatus to operate in an exact change mode.

FIG. 30 illustrates a front view of coins jammed in a coin hopper entrance. For example, the coin imaging system 2400 can visualize a jam in the hopper entrance and can take remedial steps or put the hopper out of order. In addition, the coin acceptor can send an alert to the unattended payment system, such as the unattended payment systems 100-130 (FIGS. 1A-1D).

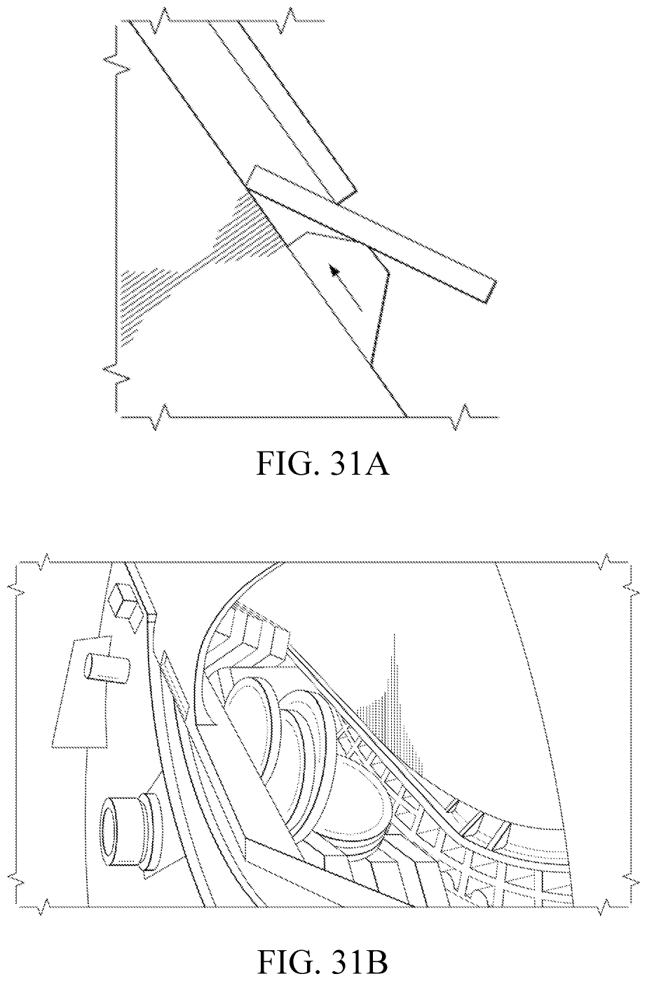

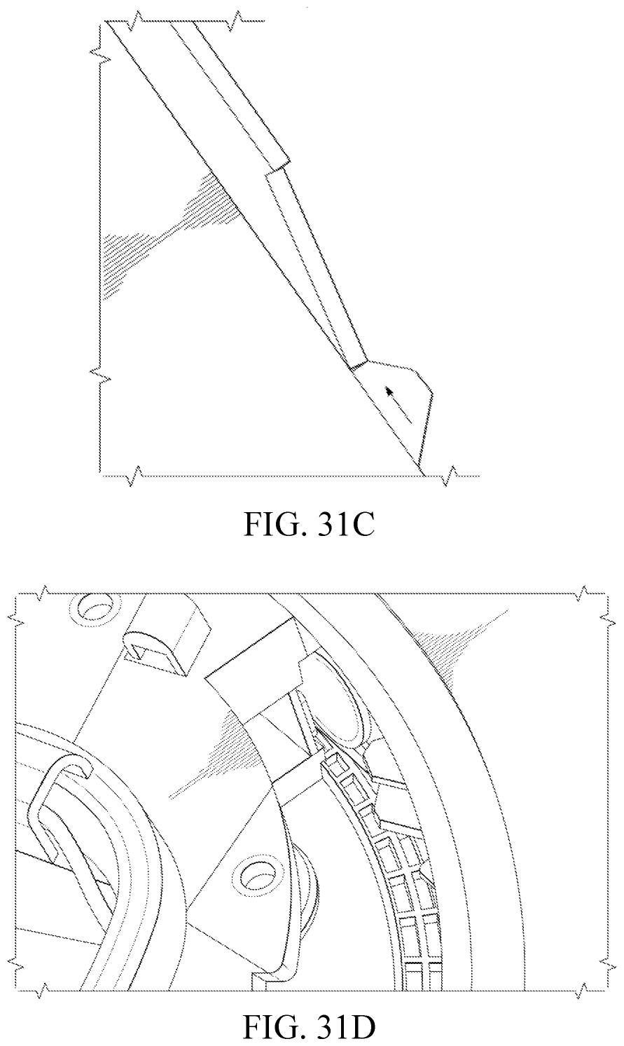

FIGS. 31A-31D illustrates various examples of jammed coins in a coin track in accordance with various embodiments of the present disclosure. FIGS. 31A-31D illustrate side views of coins jammed in the coin track. The coin imaging system 2400 can visualize a jam in the coin track and can take a remedial step or put the coin acceptor out of order. In addition, the coin acceptor can send an alert to the unattended payment system, such as the unattended payment systems 100-130 (FIGS. 1A-1D).

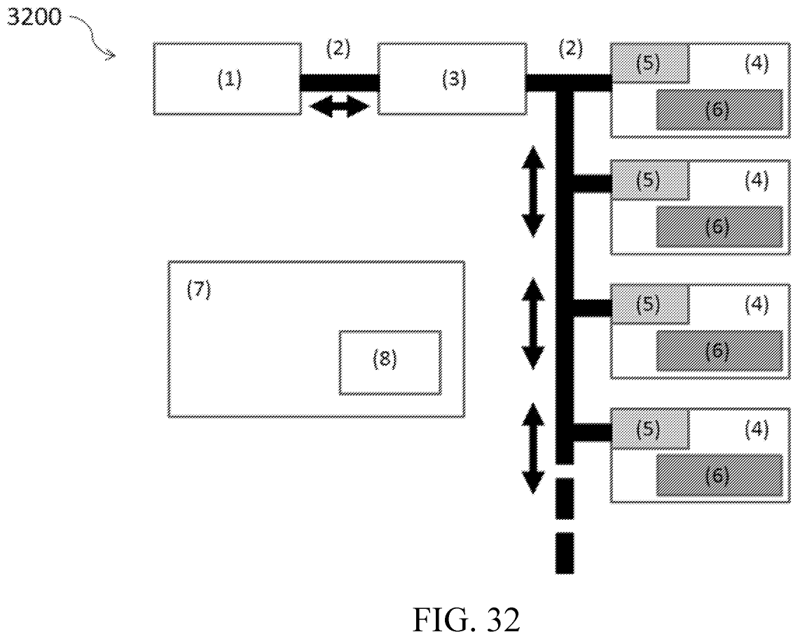

FIG. 32 illustrates an example banknote recycling system 3200 for providing audit integrity in accordance with various embodiments of this disclosure. Banknote recycling systems can come in a wide variety of configurations, such as those illustrated in FIGS. 2D, 2E, 2G-2I, and FIG. 32 does not limit the scope of this disclosure to any particular implementation of a banknote recycling system. The banknote recycling system 3200 includes an input area (1) where a consumer inserts banknotes. The input area (1) can be, in some embodiments, a banknote accepting head, a payment bezel, or another type of device that accepts banknotes inserted into the banknote recycling system 3200. The banknote recycling system 3200 further includes a banknote recognition system (2). The banknote recognition system (2) is configured to resolve the serial number of each banknote introduced into the system. After a banknote is input into the input area (1) and passes the banknote recognition system (2), a banknote path (3) conveys the banknote to one or multiple storage locations (4). The banknote recycling system also includes a banknote extraction device (5) to extract banknotes from either the top or bottom of a banknote stack (6) in some or all of the storage locations (4). A control system or controller (7), including hardware and software to execute control logic and a memory (8), supports the functions of the components (1)-(5).

During a normal operation of the banknote recycling system 3200, a customer inserts banknotes into the system that are scanned by the sensor (2) to capture various parameters for each inserted banknote. The sensor (2) can include an imaging sensor, such as an imaging sensor or contact image sensor (CIS). The sensor (2) can sense the presence and/or measure values of human and/or machine readable features to determine if an inserted banknote is genuine or not. The sensor (2) can also determine various parameters such as serial numbers, denominations, series, orientations, and/or locations of some of the security features for each accepted genuine banknote. The banknote is then transported via the banknote path (3) in response to commands from the control system and deposited in one of the storage locations (4). The destination and parameters identified by the sensor (2) are recorded in the memory (8). If a banknote is to be dispensed, the controller issues a command or signal to the banknote extraction device (5) to remove a banknote from the banknote stack (6) and to move the banknote via the banknote path (3) back through the sensing element (2), where the parameters are read for the second time before finally being passed to the customer via the input area (1). Depending on whether the store is designed as a LIFO or FIFO system, the controller can check the parameters against the expected value and report an error.

In other embodiments, the sensor (2) reads serial numbers of accepted banknotes before transporting accepted banknotes to one of the storage locations (4) via the banknote path (3). The destination and serial number identified by sensor (2) are recorded in memory (8). If a banknote is to be dispensed, the controller issues a command or signal to the banknote extraction device (5) to remove a banknote from the banknote stack (6) and to move the banknote via the banknote path (3) back through the sensing element (2), where the serial number is read for the second time before finally being passed to the customer via the input area (1). Depending on whether the store is designed as a LIFO or FIFO system, the controller can check the serial number against the expected value and report an error.

During normal operation, the system accumulates banknotes in the storage area(s) (4) and at any instant in time has in memory the parameters of each banknote in the storage areas (4) and the sequence in which these parameters are deposited. In the event of a jam condition the operator can open covers and access storage compartments as required to clear the jam. After closing the covers and restarting the system, the controller (7) will initiate a test dispense from each storage area in turn. The banknote is returned as far as sensor (2) but not back to the customer accessible inlet. By examining the parameters of this note the unit can determine if one or more notes have been removed. The system can then alert management that there has been a suspicious event. Since the unit has stored in memory every parameter in each store, even sophisticated attempts to steal notes from lower in the stack will eventually be detected. The banknote recycling system thus provides a strong deterrent against the theft of currency, such as when opening the system during a jam.

In some embodiments, during normal operation, the system accumulates banknotes in the storage area(s) (4) and at any instant in time has in memory the serial number of each banknote in the storage areas (4) and the sequence in which these serial numbers are deposited. In the event of a jam condition the operator can open covers and access storage compartments as required to clear the jam. After closing the covers and restarting the system, the controller (7) will initiate a test dispense from each storage area in turn. The banknote is returned as far as sensor (2) but not back to the customer accessible inlet. By examining the serial number of this note the unit can determine if one or more notes have been removed. The system can then alert management that there has been a suspicious event. Since the unit has stored in memory every serial number in each store, even sophisticated attempts to steal notes from lower in the stack will eventually be detected. The banknote recycling system thus provides a strong deterrent against the theft of currency, such as when opening the system during a jam.

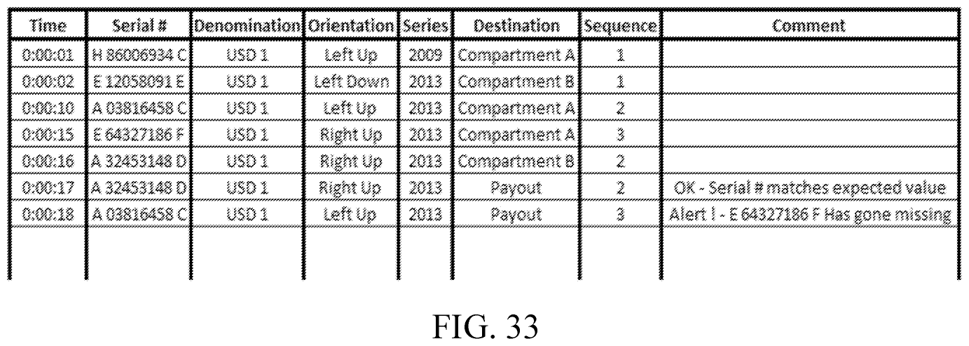

FIG. 33 illustrates example banknote data in accordance with various embodiments of this disclosure. The banknote data can be determined by the banknote recognition system (2) and/or the controller (7) and stored in the memory (8) of the banknote recycling system. Banknote scanning may be performed by either imaging sensor or contact image sensing. Multiple optical character recognition algorithms can be used for recognizing information on banknotes. Storing the banknote data provides a high level of audit accountability internal to the banknote processing system.

As illustrated in FIG. 33, the banknote recycling system 3200 can store various data on banknotes that are introduced into the banknote recycling system 3200. This data can include a time of introduction or payout of a banknote. The time of introduction can be a time the banknote was inserted, a time of scanning of the banknote by the banknote recognition system (2), a time of storage of the banknote, or any other timing that can be useful for storing in association with the introduced banknote. In some embodiments, the time can be a time associated with a runtime, such as if a first banknote is introduced one second into runtime, and thus a timing of one second is recorded, a second banknote is introduced three second into runtime, and thus a timing of three seconds is recorded, and so on. In some embodiments, the time can be a timestamp for when the banknote is introduced into the system, such as a timestamp that provides a time of day and/or a date that the banknote is introduced. Other timing formats can also be used.

The banknote data can also include a serial number. The serial number can be scanned, stored, and used to identify banknotes introduced into the system, and to track how and when the banknote is dispensed from the system. When a banknote is introduced into the system, the banknote recognition system and/or sensors capture images of the banknote. The image is processed to read the serial number from the banknote, and the serial number is stored in memory in association with other data regarding the banknote. The banknote is stored in a storage location of the banknote recycling system. In some embodiments, and as shown in FIG. 33, other information such as denomination, orientation, banknote year or series can also be read from the banknote and stored in the memory in association with other data concerning the banknote.

The controller can also store in the memory which storage location the banknote is stored in, and the banknote's sequence number for that stored location. For example, as illustrated in FIG. 33, a banknote could be stored in compartment A or compartment B and the controller stores in memory the sequence number for the banknotes, that is, a number indicated how many other banknotes have already been introduced into that compartment. For example, a first banknote introduced into an empty storage compartment can be given a value of 1, the second banknote a value of 2, and so on. When a payout or other event in which banknotes are dispensed occurs, as the banknote is passed back through the banknote recognition system, the sensors again read the serial number and possibly other information from the banknote to determine if the banknote has been dispensed out of sequence. Comments regarding the result of dispensing a banknote can also be recorded in the memory in association with the other banknote data for the banknote. In some embodiments, the stored banknote parameter for at least some of the banknotes is a banknote printing site identifier. In some embodiments, the stored banknote parameter for at least some of the banknotes is a banknote sheet location identifier. Banknotes are commonly printed in bulk onto large sheets that are later cut to size the banknotes may contain an identifier indicating the location on the bulk printed sheet.

For example, as shown in FIG. 33, a banknote with serial number A 32453148 D is introduced into the system and stored in compartment B as the second banknote in the sequence. No other banknotes are yet introduced into compartment B. This banknote is later paid out, with the system recording a comment that the payout is “OK” since the serial number matches the expected value, that is, the system expected serial number A 32453148 D to be dispensed first from compartment B since it was the last banknote introduced into compartment B, and thus was on top of the banknote stack in compartment B. As another example, another banknote having a serial number of A 03816458 C is introduced as a second banknote in compartment A, and another banknote having serial number E 64327186 F is introduced as the third banknote in compartment A. If the banknote having serial number A 03816458 C is dispensed before the serial number having serial number E 64327186 F, as shown in FIG. 33, the controller can issue an alert indicating that E 64327186 F is missing.

In some embodiments, other data stored regarding a banknote can also trigger alerts, warnings, flags, or other events based on the type of data. For example, the denomination, orientation, or other banknote data of a banknote can be used to trigger events. For instance, if a banknote is introduced in a left up orientation, and the banknote is paid out in a left down orientation, a warning or flag can be given by the system indicating that banknotes in the system may have been tampered with. In some cases, a change in orientation may only indicate that a jam was corrected, and a bill was placed back within the machine at a different orientation. In some cases, the flag or warning can signal that the banknotes should be checked to determine if any banknotes are missing due to the detected change in orientation.

In some embodiments, in response to such as warning or flag, the controller can initiate a test dispense from one or more of the storage areas. The banknote is returned as far as the sensor but not back to the customer accessible inlet. By examining the serial number of each note the unit can determine if one or more notes have been removed. The system can then alert management that there has been a suspicious event. Since the unit has stored in memory every serial number in each store, even sophisticated attempts to steal notes from lower in the stack will eventually be detected. The banknote recycling system thus provides a strong deterrent against the theft of currency, such as when opening the system during a jam. In some embodiments, a recorded time of deposit along with the serial number and sequence information can be used. If the time and sequence records to not create a monotonic series, then there is can be evidence of tampering. Furthermore, the timestamp may be useful for forensic purposes to put a boundary on the time frame of a fraud attempt. This could be correlated with records of when access doors were unlocked and by whom. It will be understood that banknotes can be stored in various ways, such as in a FIFO configuration, and the system can be configured accordingly to recognize the order is which serial numbers are expected to be dispensed from the stack.

As described above, while various embodiments can be included, the system is configured is to identify each individual banknote and track it throughout the banknote processing system. A further level of security may be added by sharing the serial number information with peripheral devices within an organization such as a retail store with a central cash room on site. In some embodiments, if the banknote storage locations are detachable, they may be provided with internal memory storage of not only the note count and denomination but serial number and sequence information as well. An external receiving device such as a cash counter with serial number recognition capability could verify the contents of the portable storage locations. This would provide a high level of cash control within not just a single device but an entire organization. If the portable storage devices contain their own memory, then it relieves the central controller of the burden of storing this information. Thus, a storage module may be swapped out with another module with no loss of audit integrity.

In some embodiments, each storage device is equipped with a unique identifier, such as a bar code or radio frequency identifier (RFID). The information about the banknote count, denomination and serial number, and/or other information, is transmitted via a data network from the sending device to the receiving device. For example, the storage unit could be removed from a banknote processor at the customer point of sale in a retail store and moved to a cash room for counting and consolidation. The detailed information about the contents could be transmitted in parallel by a data network to the cash room and complete audit security maintained even if the storage unit itself had relatively weak physical protection against tampering. In some embodiments, the system can be configured to track some other characteristic of an individual banknote. These characteristics may not be perfectly unique but still useful. For example, and as described herein, the banknote sensor could record the orientation of each banknote as presented by the customer in one of four random ways. The pattern of banknote orientation over a sequence of say ten banknotes would generate a sequence of 4\hat{ }10 possible combinations (1,048,576). The chances that a fraudster would replicate this sequence are thus more than a million to one.

Other parameters of a banknote that might be used would include marks that identify the banknote manufacturing location, the banknote location in the manufacturers printing plate, the date of the banknote, the series and sub-series of a banknote, a treasury signature, or other information. These types of information can be evaluated as part of a sequence of adjacent notes to identify traceable patterns that can trigger alerts or other events if the expected pattern is not found. The various embodiments provided herein provide the potential for closed loop auditing of cash within a machine or an organization. The system may be further expanded by exchanging the serial number (or some proxy for it) with a third party such as a Cash in Transit (CIT) company and or a receiving bank. The present disclosure also protects against a class of fraud where an unscrupulous operator replaces valid cash in the storage area with forgeries and abuses the human confidence created by the reliable and proven automatic recognition system to pass them off as valid banknotes. Existing methods of counting banknotes in a bulk stack are subject to errors of accuracy and repeatability which mean that low level fraud (i.e., theft of a single note during an audit period) cannot be prosecuted even though the face value of the banknote may be substantial.

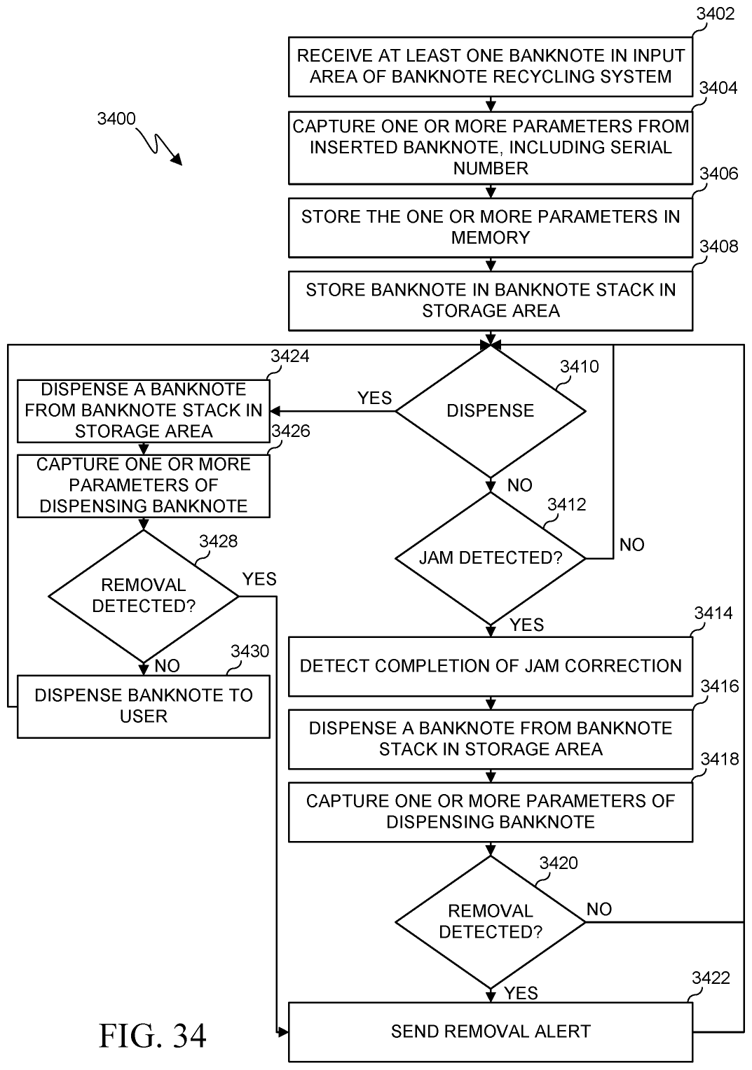

FIG. 34 illustrates an example banknote audit integrity process 3400 in accordance with various embodiments of this disclosure. FIG. 34 does not limit the scope of this disclosure to any particular embodiments. While the flowchart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. It will be understood that the process 3400 is described with respect to a processor of the unattended payment systems 100-130, 900, 1000, 1100, 1200, 1300, and 1400, the payment acceptors disclosed in the various embodiments of this disclosure, such as the banknote acceptors 200-280, 400, 500, 600, 700, 800, and 3200 and/or the banknote imaging system 1600, such as the processor 1606. However, the process 3400 can be used with any other suitable device(s) and in any suitable system.

At block 3402, a banknote recycling system receives at least one banknote in an input area, and the banknote is pulled further into the banknote recycling system through a banknote path. At block 3404, the controller captures one or more parameters from the inserted banknote, including a serial number, using a banknote recognition system and/or sensors to detect parameters of, and/or capture images of, banknotes. At block 3406, the controller stores the one or more captured parameters in memory. At block 3408, the controller stores the banknote in a banknote stack in a storage area or begins a stack if the inserted banknote is the first banknote to be deposited in the storage area. The parameters stored in memory can include the serial number, banknote deposit time, denomination type, banknote orientation, banknote series, a storage area name or type, a sequence number, any comments regarding the banknote, and/or other parameters.

At decision block 3410, the controller determines if an event occurs that includes dispensing banknotes, such as a payment/change transaction, a withdrawal or other event. If not, at decision block 3412, the controller determines if a jam is detected. If not, the process 3400 loops back to decision block 3410. If, at decision block 3412, the controller determines a jam is detected, the controller can issue a jam alert and await completion of a jam correction operation. At block 3414, the controller detects completion of the jam operation, such as detecting that doors, covers, or other components of the apparatus have been opened and closed. In some embodiments, the system can also be restarted. At block 3416, the controller causes the apparatus to dispense a banknote from a banknote stack in a storage area. In some embodiments, the controller dispenses a banknote from each storage area in turn. The dispensed banknote is returned as far as sensor but not back to the customer accessible inlet.

At block 3418, the controller uses the banknote recognition system and/or sensors to capture one or more parameters, such as the serial number, of the dispensing banknote. By examining the parameters, such as the serial number, of the dispensed banknote, the unit can determine if one or more banknotes have been removed. At decision block 3420, the controller determines if a removal, or other issues such as an out of sequence note or a note in a non-expected orientation, is detected, based on comparing the stored banknote parameters with the parameters captured at block 3418. If, at decision block 3420, a removal is not detected, the process 3400 loops back to decision block 3410. If, at decision block 3420, a removal is detected, the process 3400 moves to block 3422. At block 3422, the controller sends a removal alert, indicating the possible theft of a banknote, or other issues. The alert can inform management that there has been a suspicious event. Since the unit has stored in memory every serial number in each store, even sophisticated attempts to steal notes from lower in the stack will eventually be detected. The banknote recycling system thus provides a strong deterrent against the theft of currency, such as when opening the system during a jam. The process 3400 then loops back to decision block 3410.

If, at decision block 3410, the controller determines an event occurs that includes dispensing banknotes, the process 3400 moves to block 3424. At block 3424, the controller causes the apparatus to dispense a banknote from a banknote stack in a storage area. At block 3426, the controller uses the banknote recognition system and/or sensors to capture one or more parameters, such as the serial number, of the dispensing banknote. By examining the parameters, such as the serial number, of the dispensed banknote, the unit can determine if one or more banknotes have been removed. At decision block 3428, the controller determines if a removal, or other issues such as an out of sequence note or a note in a non-expected orientation, is detected, based on comparing the stored banknote parameters with the parameters captured at block 3418. If, at decision block 3428, a removal is not detected, the controller causes the system to dispense the banknote to the user at block 3430.

If, at decision block 3428, a removal is detected, the process 3400 moves to block 3422. At block 3422, the controller sends a removal alert, indicating the possible theft of a banknote, or other issues. The alert can inform management that there has been a suspicious event. Since the unit has stored in memory every serial number in each store, even sophisticated attempts to steal notes from lower in the stack will eventually be detected. The process 3400 then loops back to decision block 3410. It will be understood that, while FIG. 34 illustrates looping back to decision block 3410 in many instances, additional banknotes can be deposited into the system such as described with respect to blocks 3402-3408 during this loop or at other times.

During operation of banknote acceptors and banknote deposit withdrawal systems cashboxes fill up with accepted banknotes. Either an operator, CIT person or other authorized persons picks up cashboxes from multiple banknote acceptors and banknote deposit withdrawal systems to collect cash. In many cases the operator, CIT person or other authorized persons go to multiple banknote acceptors and banknote deposit withdrawal systems with empty cashboxes; they pick up completely or partially filled cashboxes and put empty cashboxes. Many operators or CIT use either RFID, or smart cashboxes or insert a coupon in cashboxes before picking them up to identify individual cashbox with banknote acceptors and banknote deposit withdrawal systems. These smart cashboxes, or RFID enabled cashbox increase cost of cashboxes and require operator to have special readers. Inserting a coupon before removal of cashbox increases time of collection as well as requires skilled operator.

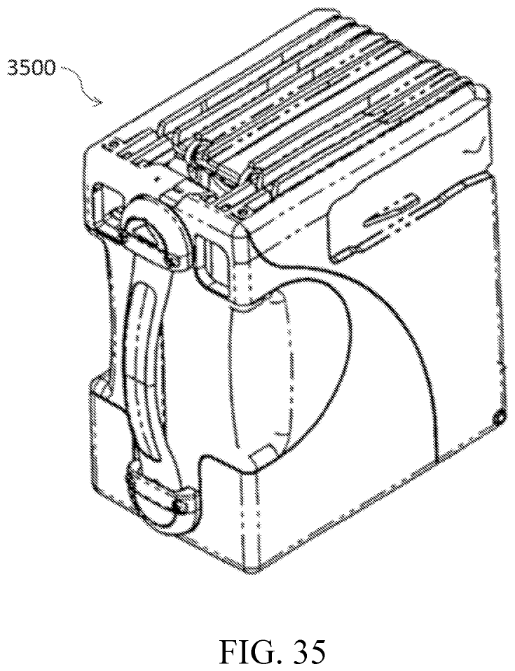

In some embodiments, banknote acceptors and banknote deposit withdrawal systems 200-280 as shown in FIGS. 2A-2I include a banknote cashbox or storage unit 3500 shown in FIG. 35. Banknote acceptors and banknote deposit withdrawal systems 200-280 store accepted banknotes in the cashbox 3500. Banknote cashboxes 3500 can come in a wide variety of configurations, such as those illustrated in FIGS. 2A-2I, and FIG. 32 does not limit the scope of this disclosure to any particular implementation of a banknote cashbox 3500. The banknote acceptors and banknote deposit withdrawal systems 200-280 capture and store parameters of accepted banknotes described in FIG. 33. The banknote acceptors and banknote deposit withdrawal systems 200-280 provide stored parameters of accepted banknotes stored in banknote cashbox 3500 to operator or to a cash-room or to CIT location. As the operator, CIT person or authorized persons collect cashboxes 3500 from multiple banknote acceptors and banknote deposit withdrawal systems 200-280 and bring them to a cash-room or to CIT location data about stored parameters of accepted banknotes stored in banknote cashbox 3500 is entered into a banknote counting machine. The banknote counting machine in the cash-room or in the CIT location could be one of banknote acceptors or banknote deposit withdrawal systems 200-280 as shown in FIGS. 2A-2I. Once the banknotes from the collected cashboxes 3500 are entered into the banknote counting machine, the banknote counting machine captures parameters from banknotes and compares parameters received from banknote acceptors or banknote deposit withdrawal systems to identify origin of banknote cashbox 3500 to a banknote acceptor or banknote deposit withdrawal system 200-280.

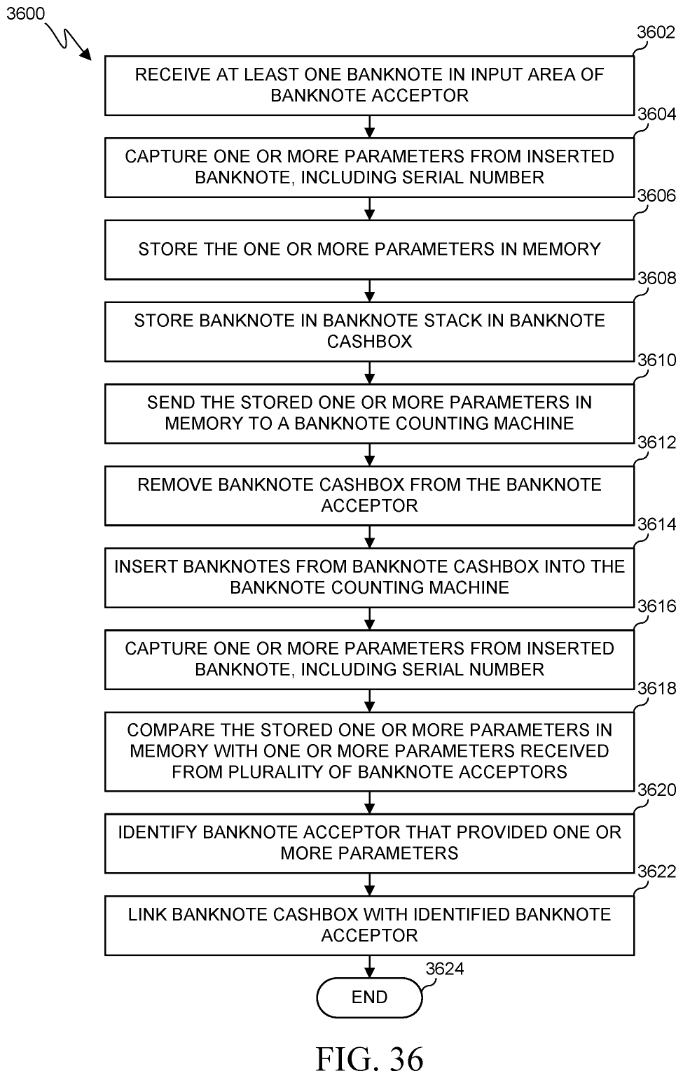

FIG. 36 illustrates an example banknote cashbox identification process 3600. It will be understood that the process 3600 is described with respect to a processor of the unattended payment systems 100-130, 900, 1000, 1100, 1200, 1300, and 1400, the payment acceptors disclosed in the various embodiments of this disclosure, such as the banknote acceptors 200-280, 400, 500, 600, 700, 800, and 3200 and/or the banknote imaging system 1600, such as the processor 1606. However, the process 3400 can be used with any other suitable device(s) and in any suitable system. In step 3602, a banknote acceptor and/or banknote deposit withdrawal systems, such as systems 200-280 as shown in FIGS. 2A-2I, accept one or more banknotes in input area. In step 3604, the banknote acceptor and/or banknote deposit withdrawal system captures one or more parameters from inserted banknote described in FIG. 33. In step 3606, the banknote acceptor and/or banknotes deposit withdrawal system stores one or more banknote parameters in memory. In step 3608, the banknote acceptor and/or banknote deposit withdrawal system stores banknote in banknote cashbox. In step 3610, the banknote acceptor and/or banknote deposit withdrawal system sends the stored banknote parameters data to a banknote counting machine. In step 3612, a banknote cashbox is removed from the banknote acceptors and/or banknote deposit withdrawal systems. In step 3614, banknotes from multiple cashboxes are inserted into the banknote counting machine. In step 3616, the banknote counting machine captures one or more parameters from inserted banknotes. In step 3618, the banknote counting machine compares one or more parameters of banknotes received from inserted banknotes and from the banknote acceptors and/or banknote deposit withdrawal systems. In step 3620, the banknote counting machine identifies the banknote acceptor and/or banknote deposit withdrawal system that provided one or more parameters of banknotes. In step 3622, the banknote counting machine links the cashbox 3500 to a banknote acceptor and/or banknote deposit withdrawal system. The process 3600 ends at block 3624.

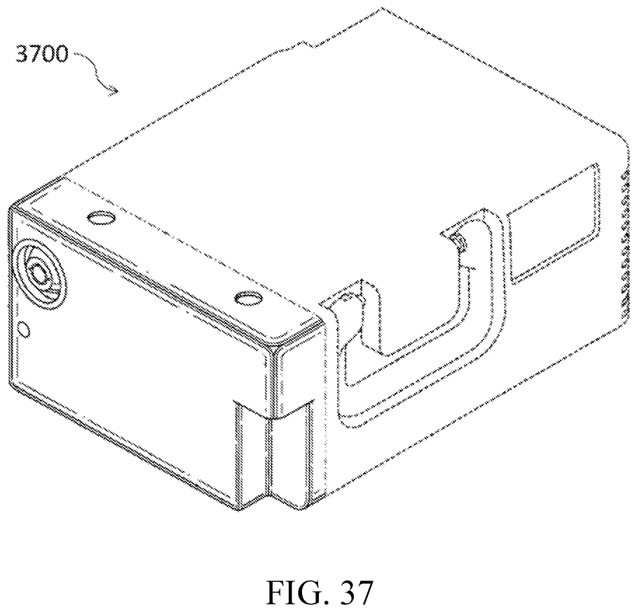

During operation of banknote deposit withdrawal systems 230-240 (FIGS. 2D-2E), 260-280 (FIGS. 2G-2I) accept banknotes during banknote acceptance and provide change or cashback using stored banknotes from one or more of the banknote recycling units. These banknote recycling units store lower denomination banknotes and send extra accepted banknotes to banknote cashbox. During operation lower denomination banknotes are used to provide change to customers. Before beginning of operation of banknote deposit withdrawal systems banknote recycling units require filling up to provide change for initial transactions. This filling up of banknote recycling units is carried out either an operator, CIT person or other authorized persons manually or by a banknote loader unit 3700 shown in FIG. 37. Filling of banknote recycling units manually carries risk of theft or operator making calculation error and taking operator time in filling up banknote recycling units. In many instances, the banknote loader unit 3700 could be filled in a cash-room or in a CIT location and then operator or CIT person takes multiple filled banknote loader units 3700 to multiple banknote deposit withdrawal systems 3200. Many operators or CIT use either RFID, or smart banknote loader units or insert a coupon in banknote loader units before filling them up to identify individual banknote loader unit to identify inside banknote deposit withdrawal systems. These smart banknote loader unit, or RFID enabled banknote loader units increase cost of cashboxes and require operator to have special readers. Inserting a coupon before filling of banknote loader units increases time of collection as well as requires skilled operator.

In some embodiments, banknote deposit withdrawal systems 230-240 (FIGS. 2D-2E), 260-280 (FIGS. 2G-2I) include a banknote loader unit 3700 shown in FIG. 37. Banknote loader units 3700 can come in a wide variety of configurations, such as those illustrated in 230-240 (FIGS. 2D-2E), 260-280 (FIGS. 2G-2I) and FIG. 32 does not limit the scope of this disclosure to any particular implementation of a banknote loader units 3700. In a cash-room or CIT location multiple banknote loader units 3700 are filled by a banknote loader unit filling machines. The banknote loader unit filling machines can be banknote acceptors or banknote deposit withdrawal systems 200-280 as shown in FIGS. 2A-2I. The banknote loader unit filling machines fill banknote loader units 3700 with banknotes for which one or more parameters identified in FIG. 33 are captured and stored into the banknote loader unit filling machines. The data of one or more parameters stored banknotes in banknote loader units 3700 is then sent to multiple banknote deposit withdrawal systems. These filled banknote loader units 3700 are then taken to multiple banknote deposit withdrawal systems 230-240 (FIGS. 2D-2E), 260-280 (FIGS. 2G-2I). Upon insertion of banknote loader units 3700 into multiple banknote deposit withdrawal systems, the banknote deposit withdrawal system then dispenses banknotes from the banknote loader unit 3700 to capture and compare stored parameters of banknotes in the banknote loader unit 3700 with data one or more parameters received from the banknote loader unit filling machine. The banknote deposit withdrawal system then identifies origin of the banknote loader unit 3700 to a banknote loader unit filling machine.

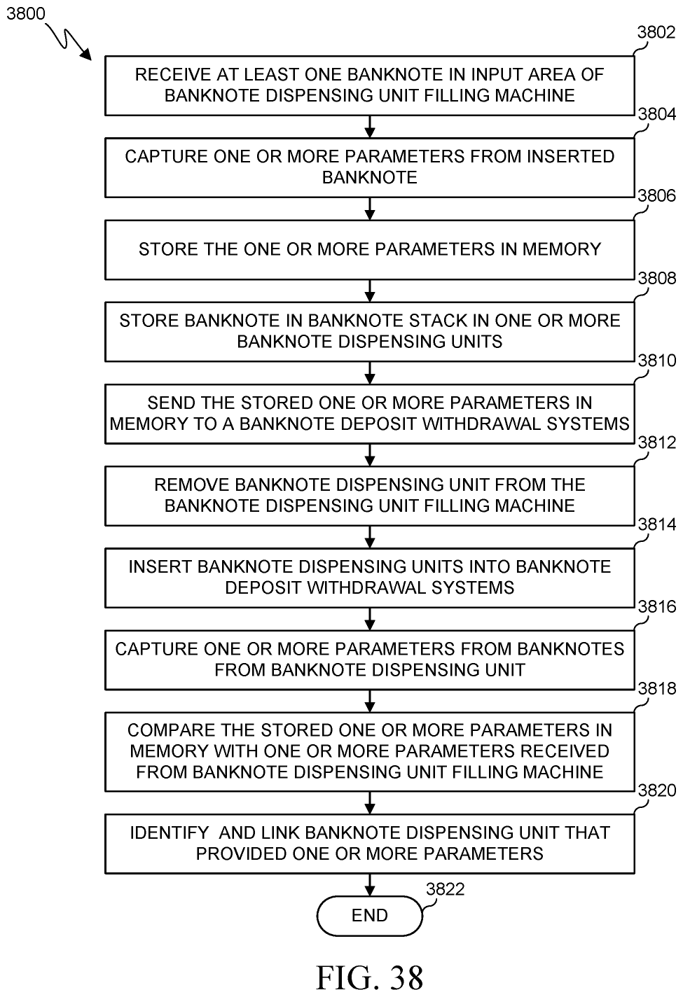

FIG. 38 illustrates an example banknote loader unit identification process 3800. It will be understood that the process 3800 is described with respect to a processor of the unattended payment systems 100-130, 900, 1000, 1100, 1200, 1300, and 1400, the payment acceptors disclosed in the various embodiments of this disclosure, such as the banknote acceptors 200-280, 400, 500, 600, 700, 800, and 3200 and/or the banknote imaging system 1600, such as the processor 1606. However, the process 3800 can be used with any other suitable device(s) and in any suitable system. In step 3802, a banknote loader unit filling machine, such as machines 200-280 as shown in FIGS. 2A-2I, accept one or more banknotes in input area. In step 3804, the banknote loader unit filling machine captures one or more parameters from inserted banknote described in FIG. 33. In step 3806, the banknote loader unit filling machine stores one or more banknote parameters in memory. In step 3808, the banknote loader unit filling machine stores banknote in banknote loading unit 3700. In step 3810, the banknote loader unit filling machine sends the stored banknote parameters data to multiple banknote acceptors and/or banknote deposit withdrawal systems. In step 3812, banknote loader units 3700 are removed from the banknote loader unit filling machine. In step 3814, banknotes loader units 3700 are inserted into multiple banknote deposit withdrawal systems. In step 3816, the banknote deposit withdrawal system captures one or more parameters from dispensed banknotes from the banknote loader unit 3700. In step 3818, the banknote deposit withdrawal systems compares one or more parameters of banknotes received from dispensed banknotes and from the banknote loader unit filling machine. In step 3820, the banknote deposit withdrawal systems identifies and links the banknote loader unit 3700 to a banknote loader unit filling machine. The process 3800 ends at block 3822.

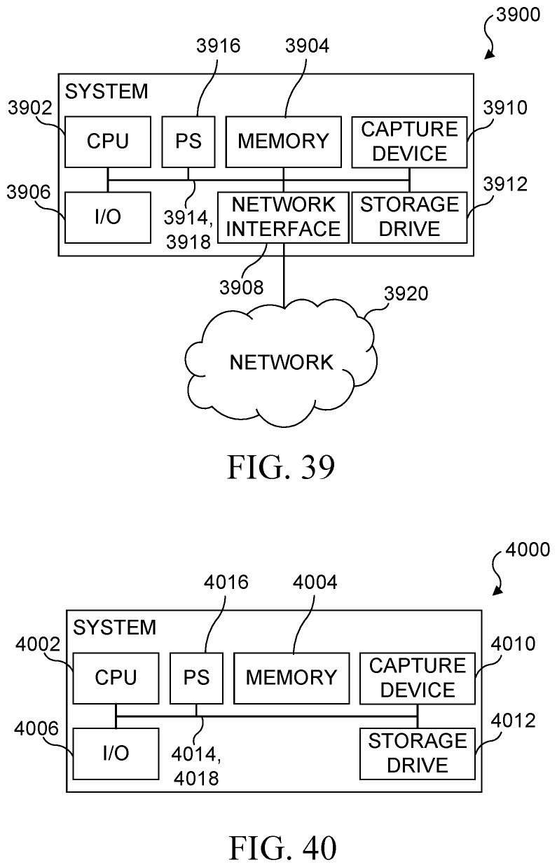

FIG. 39 illustrates an example electronic device 3900 in accordance with various embodiments of this disclosure. The device 3900 can be one example of a portion or all of the unattended payment systems 100-130, the banknote acceptors 200-280, the coin acceptors 300-330, or other devices disclosed herein such as the banknote acceptors 400, 500, 600, 700, 800, or the unattended payment systems 900, 1000, 1100, 1200, 1300, 1400. In some embodiments, the device 3900 can be an imaging sensor, or part of an imaging sensor system, such as being coupled to or in communication with an imaging sensor, such as the imaging sensor system 1600, 1700, 2100, or sensors 1610 and/or the sensors 1614, 1616, 1618, 1620, and 1622, sensor 1710, sensor 2110, or sensor 2410. The device 3900 includes a controller (e.g., a processor/central processing unit (“CPU”)) 3902, which can be the processor 1606, a memory unit 3904, which can be the memory 1608, and an input/output (“I/O”) device 3906. The device 3900 also includes at least one network interface 3908, or network interface controllers (NICs). The device 3900 further includes at least one capture device 3910 for capturing media or inputs to the system through an I/O device. In some embodiments, the capture device can be the imaging sensor 1610 and/or the sensors 1614, 1616, 1618, 1620, and 1622. The device 3900 also includes a storage drive 3912 used for storing content such as banknote data. The components 3902, 3904, 3906, 3908, 3910, and 3912 are interconnected by a data transport system (e.g., a bus) 3914. A power supply unit (PSU) 3916 provides power to components of the system 3900 via a power transport system 3918 (shown with data transport system 3914, although the power and data transport systems may be separate).

It will be understood that the system 3900 may be differently configured and that each of the listed components may actually represent several different components. For example, the CPU 3902 may actually represent a multi-processor or a distributed processing system; the memory unit 3904 may include different levels of cache memory, and main memory; the I/O device 3906 may include monitors, keyboards, touchscreens, and the like; the at least one network interface 3908 may include one or more network cards providing one or more wired and/or wireless connections to a network 3920; and the storage drive 3912 may include hard disks and remote storage locations. Therefore, a wide range of flexibility is anticipated in the configuration of the system 3900, which may range from a single physical platform configured primarily for a single user or autonomous operation to a distributed multi-user platform such as a cloud computing system.

The system 3900 may use any operating system (or multiple operating systems), including various versions of operating systems provided by Microsoft (such as WINDOWS), Apple (such as Mac OS X), UNIX, RTOS, and LINUX, and may include operating systems specifically developed for handheld devices (e.g., iOS, Android, RTOS, Blackberry, and/or Windows Phone), personal computers, servers, and other computing platforms depending on the use of the system 3900. The operating system, as well as other instructions (e.g., for telecommunications and/or other functions provided by the device 3900), may be stored in the memory unit 3904 and executed by the processor 3902. For example, if the system 3900 is, or is part of, the apparatus 100, the memory unit 3904 may include instructions for performing some or all of the steps, process, and methods described herein.

The network 3920 may be a single network or may represent multiple networks, including networks of different types, whether wireless or wired. For example, the device 3900 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 3900 with external devices.

FIG. 40 illustrates an example electronic device 4000 in accordance with various embodiments of this disclosure. The device 4000 can be one example of a portion or all of the unattended payment systems 100-130, the banknote acceptors 200-280, the coin acceptors 300-330, or other devices disclosed herein such as the banknote acceptors 400, 500, 600, 700, 800, or the unattended payment systems 900, 1000, 1100, 1200, 1300, 1400. In some embodiments, the device 4000 can be an imaging sensor, or part of an imaging sensor system, such as being coupled to or in communication with an imaging sensor, such as the imaging sensor system 1600, 1700, 2100, or sensors 1610 and/or the sensors 1614, 1616, 1618, 1620, and 1622, sensor 1710, sensor 2110, or sensor 2410. The device 4000 includes a controller (e.g., a processor/central processing unit (“CPU”)) 4002, which can be the processor 1606, a memory unit 4004, which can be the memory 1608, and an input/output (“I/O”) device 4006. The device 4000 further includes at least one capture device 4010 for capturing media or inputs to the system through an I/O device. In some embodiments, the capture device can be the imaging sensor 1610 and/or the sensors 1614, 1616, 1618, 1620, and 1622. The device 4000 also includes a storage drive 4012 used for storing content such as banknote data. The components 4002, 4004, 4006, 4010, and 4012 are interconnected by a data transport system (e.g., a bus) 4014. A power supply unit (PSU) 4016 provides power to components of the system 4000 via a power transport system 4018 (shown with data transport system 4014, although the power and data transport systems may be separate).

It will be understood that the system 4000 may be differently configured and that each of the listed components may actually represent several different components. For example, the CPU 4002 may actually represent a multi-processor or a distributed processing system; the memory unit 4004 may include different levels of cache memory, and main memory; the I/O device 4006 may include monitors, keyboards, touchscreens, and the like, and the storage drive 4012 may include hard disks and remote storage locations. Therefore, a wide range of flexibility is anticipated in the configuration of the system 4000, which may range from a single physical platform configured primarily for a single user or autonomous operation to a distributed multi-user platform such as a cloud computing system.

The system 4000 may use any operating system (or multiple operating systems), including various versions of operating systems provided by Microsoft (such as WINDOWS), Apple (such as Mac OS X), UNIX, RTOS, and LINUX, and may include operating systems specifically developed for handheld devices (e.g., iOS, Android, RTOS, Blackberry, and/or Windows Phone), personal computers, servers, and other computing platforms depending on the use of the system 4000. The operating system, as well as other instructions (e.g., for telecommunications and/or other functions provided by the device 4000), may be stored in the memory unit 4004 and executed by the processor 4002. For example, if the system 4000 is, or is part of, the apparatus 100, the memory unit 4004 may include instructions for performing some or all of the steps, process, and methods described herein.

In one example embodiments, a coin acceptor includes a transportation path to transport a coin for validation. The transportation path in the coin acceptor includes at least a side. The coin acceptor includes an image sensor to take images of the coin and an illumination source. The image sensor and the light source are on the same side of the transportation path. The image sensor and the light source are arranged serially in the transportation path in a manner that at least a region of the coin passes under a direct reflection and a side reflection. The coin acceptor further includes a computing device to examine the coin images captured under the direct reflection and the side reflection. The illumination source of the coin acceptor also includes is larger in at least one of the dimensions than at least one of the dimensions of the imaging sensor. The image sensor of the coin acceptor can view images carried by an optical fiber or by a reflecting surface. The illumination source of the coin acceptor provides illumination to the coin by an optical fiber or by a reflecting surface.

In another example embodiment, a method authenticating a coin in a coin acceptor includes transporting a coin in a transportation path comprising at lease a side. The method to authenticate a coin in the coin acceptor includes illuminating the coin in the transportation path. The method to authenticate a coin in the coin acceptor includes taking images of the coin in the transportation path in a manner that at least a region of the coin passes under a direct reflection and a side reflection. The method to authenticate a coin in the coin acceptor includes examining images of the coin captured under the direct reflection and the side reflection. The method to authenticate a coin in the coin acceptor includes observing images of the coin carried by an optical fiber or by a reflective surface. The method to authenticate a coin in the coin acceptor includes illuminating the coin by an optical fiber or a reflective surface.

In one example embodiment, a banknote acceptor of an unattended payment system includes an inlet to allow insertion of a banknote into the banknote acceptor. The banknote acceptor includes a banknote transport path to transport the banknote from the inlet to an interior of the banknote acceptor. The banknote acceptor includes at least one imaging sensor configured to capture an image of an object inserted in the banknote transport path, and capture an image of a user attempting to insert the object into the inlet of the banknote acceptor.

In one or more of the above examples, the banknote acceptor includes a reflective surface operable to change a field of view of the at least one imaging sensor. In one or more of the above examples, the reflective surface is operable to move to capture an image of a user attempting to insert an object into the inlet of the banknote acceptor. In one or more of the above examples, the reflective surface is operable to move to capture an image of an object present in the banknote transport path. In one or more of the above examples, the reflective surface can be a half-silvered mirror that reflects both a user's hand or input area of the banknote acceptor and the user's face. In one or more of the above examples, a split light path can be used such that half of the pixels captured by an imaging sensor are of a user's hand or an input area of the banknote acceptor, and the other half of the pixels captured by the imaging sensor are of a user's face.

In one or more of the above examples, the banknote acceptor further includes a reflective surface or a refractive surface operable to change a field of view of the at least one imaging sensor. In one or more of the above examples, the reflective surface or the refractive surface is operable to perform simultaneous monitoring of multiple noncontiguous regions of the banknote transport path.

In one or more of the above examples, the banknote acceptor includes at least a refractive surface operable to change a field of view of the at least one imaging sensor. In one or more of the above examples, the refractive surface is operable to move to capture an image of a user attempting to insert an object into the inlet of the banknote acceptor. In one or more of the above examples, the refractive surface moves to capture an image of an object present in the banknote transport path.

In one or more of the above examples, the at least one imaging sensor is operable to move to capture an image of an object present in the banknote transport path. In one or more of the above examples, a field of view for the image sensor comprises a one-way transparent surface. In one or more of the above examples, the banknote acceptor wakes up from a sleep mode if the at least one imaging sensor detects insertion or attempted insertion of the object into the inlet of the banknote acceptor. In one or more of the above examples, the refractive surface can be a half-silvered mirror that reflects both a user's hand or input area of the banknote acceptor and the user's face. In one or more of the above examples, a split light path can be used such that half of the pixels captured by an imaging sensor are of a user's hand or an input area of the banknote acceptor, and the other half of the pixels captured by the imaging sensor are of a user's face.

In one or more of the above examples, the image of the user and an image of the inserted object are stored in a memory of the banknote acceptor. In one or more of the above examples, the image of the user and the image of the inserted object are stored in a memory of the unattended payment system. In one or more of the above examples, an image of an area surrounding the unattended payment system is taken by the image sensor. In one or more of the above examples, a size throughout the banknote transport path is modified to accommodate denomination of the inserted banknote.

In one or more of the above examples, the image of the user and the image of the inserted object are linked and stored in a memory of the banknote acceptor. In one or more of the above examples, the image of the user and the image of the inserted object are linked and stored in a memory of the unattended payment system. In one or more of the above examples, the at least one imaging sensor is further configured to capture an image of digital indicia from a user's portable device, and send the captured image of the digital indicia to a communication device. The communication device is configured to send information of the digital indicia to a remote device. The remote device is configured to send an instruction to the unattended payment system to unlock the unattended payment system.

In one or more of the above examples, at least one imaging sensor is further configured to capture an image of digital indicia from a user's portable device, and send the captured image of the digital indicia to a communication device. The communication device is configured to send information of digital indicia to a remote device. The remote device is configured to provide credit to a user of the unattended payment system.

In one or more of the above examples, the banknote acceptor includes a security shutter is operated in response to an image captured by the at least one imaging sensor. In one or more of the above examples, at least one imaging sensor is further configured to monitor the inlet of the banknote acceptor for objects being inserted.

In another example embodiment, a method of taking an image of a user using an unattended payment system using at least one image sensor from a payment acceptor includes detecting when an object is being inserted in the inlet of the payment acceptor. The method includes finding a face of the user and taking an image of the user.

In one or more of the above examples, the method includes capturing an image of an object inserted in a payment media transport path of the payment acceptor. In one or more of the above examples, the method includes changing a field of view of the image sensor from the inlet of the payment acceptor to the user. In one or more of the above examples, the method includes storing images of a user and of an object inserted by the user. In one or more of the above examples, the method includes linking and storing images of a user and an inserted object. In one or more of the above examples, the method includes changing a width of a payment media transport path of the payment acceptor to accommodate a denomination of an inserted payment medium.

In one or more of the above examples, the method includes taking a picture of digital indicia on a user's portable device. The method includes sending information of digital indicia to an external communication device. The method includes sending information of the digital indicia to a remote device. The method includes receiving instruction from the remote device to unlock the unattended payment system. sending information of the digital indicia to a remote device. The method includes receiving instruction from the remote device to provide credit to a user of the unattended payment system. In one or more of the above examples, the method includes monitoring an inlet of the payment acceptor for objects being inserted.

In another example embodiment, a banknote acceptor of an unattended payment system includes an inlet to allow insertion of a banknote into the banknote acceptor. The banknote acceptor includes a banknote transport path to transport the banknote from the inlet to an interior of the banknote acceptor. The banknote acceptor includes at least one imaging sensor configured to capture an image of an object inserted in the banknote transport path, and capture an image of a user and/or payment media while attempting to insert the object into the inlet of the banknote acceptor.

In one or more of the above examples, the banknote acceptor includes a reflective and/or refractive surfaces operable to change a field of view of the at least one imaging sensor. In one or more of the above examples, the banknote acceptor includes a reflective and/or refractive surfaces allowing simultaneous monitoring of multiple noncontiguous regions. In one or more of the above examples, the banknote acceptor includes at least one imaging sensor is operable to move to capture the image of the user attempting to insert the object into the inlet of the banknote acceptor. In one or more of the above examples, the banknote acceptor includes at least one imaging sensor is operable to move to capture the image of the object inserted in the banknote transport path. In one or more of the above examples, the banknote acceptor includes a field of view for the at least one imaging sensor comprises a one-way transparent surface such as a partially silvered mirror or beam splitter. In one or more of the above examples, the banknote acceptor is operable to wake up from a sleep mode if the at least one imaging sensor detects insertion or detects attempted insertion of the object into the inlet of the banknote acceptor. In one or more of the above examples, the banknote acceptor includes a memory, wherein the image of the user and the image of the inserted object are stored in the memory of the banknote acceptor. In one or more of the above examples, the banknote acceptor stores the image of the user and the image of the inserted object in a memory of the unattended payment system. In one or more of the above examples, the banknote acceptor includes at least one image sensor that is further configured to capture an image of an area surrounding the unattended payment system. In one or more of the above examples, a size throughout of the banknote transport path of the banknote acceptor is modified to accommodate a denomination of the inserted banknote.

In another example embodiment, a payment acceptor of an unattended payment system includes an inlet to allow a user to insert payment medium into the payment acceptor. The payment acceptor includes an inlet to allow a user to insert payment medium into the payment acceptor. The payment acceptor includes a payment transport path to transport payment medium from the inlet to an interior of the payment acceptor. The payment acceptor includes at least one imaging sensor configured to capture an image of an object inserted in the payment transport path, and capture an image of a user attempting to insert an object into the inlet of the payment acceptor.

In one or more of the above examples, the payment acceptor includes at least a reflective surface operable to change a field of view of the at least one imaging sensor. In one or more of the above examples, the reflective surface is operable to move to capture an image of a user attempting to insert an object into the inlet of the said payment acceptor. In one or more of the above examples, the reflective surface is operable to move to capture an image of an object present in the payment transport path.

In one or more of the above examples, the payment acceptor includes at least a refractive surface operable to change a field of view of the at least one imaging sensor. In one or more of the above examples, the refractive surface is operable to move to capture an image of a user attempting to insert an object into the inlet of the payment acceptor. In one or more of the above examples, the refractive surface is operable to move to capture an image of an object present in the payment transport path.

In one or more of the above examples, the payment acceptor includes an imaging sensor operable to move to capture an image of a user attempting to insert an object into the inlet of the said payment acceptor. In one or more of the above examples, the imaging sensor is operable to move to capture an image of an object present in the payment transport path. In one or more of the above examples, a field of view for the image sensor comprises a one-way transparent surface.

In one or more of the above examples, the payment acceptor wakes up from a sleep mode if the at least one imaging sensor detects that an object is being inserted into the inlet of the payment acceptor. In one or more of the above examples, the image of the user and the image of the inserted object are stored in a memory of the unattended payment system. In one or more of the above examples, an image of an area surrounding the unattended payment system is taken by the image sensor. In one or more of the above examples, a size throughout the payment transport path is modified to accommodate denomination of inserted payment medium. In one or more of the above examples, the image of the user and the image of the inserted object are linked and stored in a memory of the payment acceptor. In one or more of the above examples, the image of the user and the image of the inserted object are linked and stored in a memory of the unattended payment system. In one or more of the above examples, at least one imaging sensor is configured to capture an image of digital indicia from a user's portable device, and send the captured image of the digital indicia to a communication device. The communication device is configured to send information of the digital indicia to a remote device. The remote device is configured to send an instruction to unlock the unattended payment system. In one or more of the above examples, at least one imaging sensor is further configured to capture an image of digital indicia from a user's portable device, and send the captured image of the digital indicia to a communication device. The communication device is configured to send information of the digital indicia to a remote device. The remote device is configured to provide credit to a user of the unattended payment system.

In one or more of the above examples, the payment acceptor includes a security shutter that is operated in response to an image captured by the at least one imaging sensor. In one or more of the above examples, at least one imaging sensor is configured to monitor the inlet of the payment acceptor for objects being inserted.

In another example embodiment, a device for determining a fill level and identifying a coin type mismatch of at least one coin tube includes at least one spatially resolving optical sensor positioned at a defined distance to an upper side of the coin tube and configured to capture at least one spatially resolved image of the upper side of the at least one coin tube. The device comprises an evaluation unit coupled to the at least one spatially resolving optical sensor and configured to receive the at least one spatially resolved image, identify, based on the at least one spatially resolved image of the upper side of the at least one coin tube, a coin tube identifier (ID) of the at least one coin tube. The device identifies a coin type of an uppermost coin in the at least one coin tube. The device determines that there is a mismatch between the identified coin type and a coin type associated with the coin tube ID. The device transmits a mis-fill or mis-route signal to another device.

In one or more of the above examples, the evaluation unit is further configured to evaluate the at least one spatially resolved image to detect a diameter (“d”) of the uppermost coin in the at least one coin tube and determine the fill level of the at least one coin tube from a ratio between i) one of an inner or an outer diameter (“D”) of the at least one coin tube on the spatially resolved image and ii) a detected diameter d of the uppermost coin in the coin tube, wherein the inner diameter of the at least one coin tube is a diameter of an opening of the at least one coin tube and the outer diameter of the at least one coin tube is a diameter of an outer wall of the at least one coin tube

detect the fill level of the at least one coin tube from a distance between the at least one spatially resolving optical sensor and the uppermost coin in the at least one coin tube, wherein the distance takes into account a defined distance according to equation:

$$a = \frac{A \cdot D}{d}$$

wherein:

a is defined as the distance between the at least one spatially resolving optical sensor and the uppermost coin filled in the coin tube,

A is defined as the distance between the at least one spatially resolving optical sensor and a topside of the at least one coin tube,

d is defined as the diameter of the uppermost coin in the coin tube measured in the spatially resolved image, and

D is defined as the inner or the outer diameter of the at least one coin tube measured in the spatially resolved image.

In another example embodiment, a coin acceptor includes a transportation path to transport a coin for validation. The coin acceptor includes the transportation path comprising at least a side. The coin acceptor includes an image sensor to take images of the coin. The coin acceptor includes an illumination source where the image sensor and the light source are on the same side of the transportation path. In addition, the image sensor and the light source are arranged serially in the transportation path in a manner that at least a region of the coin passes under a direct reflection and a side reflection.

In one or more of the above examples, the coin acceptor includes a computing device to examine the coin images captured under the direct reflection and the side reflection. In one or more of the above examples, at least one of the dimensions of the illumination source is larger than at least one of the dimensions of the imaging sensor. In one or more of the above examples, the image sensor views images carried by an optical fiber or by a reflective surface or by a refracting surface. In one or more of the above examples, the illumination source, provides illumination to the coin by an optical fiber or by a reflecting surface or by a refracting surface.

In another example embodiment, a method authenticating a coin in a coin acceptor includes transporting a coin in a transportation path comprising at lease a side. The method includes illuminating the coin in the transportation path. The method includes taking images of the coin in the transportation path in a manner that at least a region of the coin passes under a direct reflection and a side reflection.

In one or more of the above examples, the method includes examining images of the coin captured under the direct reflection and the side reflection. In one or more of the above examples, the method includes comparing images of the coin to detect presence or absence of embossing on the coin. In one or more of the above examples, the method includes observing images of the coin carried by an optical fiber or by a reflecting surface or by a refracting surface.

In another example embodiment, a banknote acceptor including a memory, an imaging sensor and one or more fiber optic cables coupled to the imaging sensor. The one or more fiber optic cables are each disposed at a position relative to a banknote path of the banknote acceptor. The banknote acceptor includes at least one processor coupled to the memory and the imaging sensor, wherein the at least one processor is configured to receive one or more images of a banknote captured by the imaging sensor via at least one of the one or more fiber optic sensors. The at least one processor is configured to analyze at least one of the one or more images to determine at least one banknote characteristic of the banknote. The at least one processor is configured to store the at least one banknote characteristic in the memory, and cause the banknote validator to perform an action based on the stored at least one banknote characteristic.

In one or more of the above examples, the image sensor views images carried by fiber optic sensors for recognition from recognition location. In one or more of the above examples, the image sensor, views images carried by fiber optic sensors for tracking from plurality of tracking locations. In one or more of the above examples, the image sensor, views images carried by fiber optic sensors for start from one or more of start locations. In one or more of the above examples, the image sensor, views images carried by fiber optic sensors for tach from one or more of the tach locations. In one or more of the above examples, the image sensor, views images carried by fiber optic sensors for multiple banknote detection from one or more of the multiple banknote detector locations.

In another example embodiment, a method of operating a banknote acceptor includes acquiring images from a start location of the banknote acceptor. The method includes processing said acquired images from the start location to determine if the inserted object is a banknote, if the inserted object is a banknote then start pulling the banknote inside the banknote acceptor. The method includes acquiring images from a recognition location and processing acquired images from the recognition location to determine if the inserted banknote is acceptable. If the inserted banknote is acceptable then, the method includes, transporting the accepted banknote further inside the banknote acceptor. The method includes acquiring images from plurality of tracking locations and processing said acquired images from the tracking locations to track location of the banknote inside the banknote acceptor. A single image sensor is acquiring and processing images from the start location, the recognition location and the tracking locations.

In one or more of the above examples, the method includes acquiring images from a tach location, processing acquired images from the tach location to determine revolutions of a rotating shaft in a given time. In one or more of the above examples, the method includes acquiring images from a double banknote detection location and processing acquired images from the multiple banknote detection location to determine if more than one banknote is detected.

In another example embodiment, a currency handling apparatus includes a banknote input area operable to receive banknotes into the currency handling apparatus. The currency handling apparatus includes one or more sensors configured to capture one or more banknote parameters from each of the banknotes received into the currency handling apparatus. The currency handling apparatus includes one or more storage areas, a banknote transport path operable to convey the banknotes to the one or more storage areas and to dispense the banknotes at least to the one or more sensors. The currency handling apparatus includes a memory configured to store the one or more banknote parameters of some of the banknotes received into the currency handling apparatus. The currency handling apparatus includes a controller coupled to the memory, wherein the controller is configured to receive, from the one or more sensors, at least one banknote parameter for a banknote dispensed from one of the one or more storage areas to the one or more sensors. The controller is configured to compare the at least one banknote parameter with the one or more banknote parameters stored in the memory, and generate an alert signal based on the comparison of the at least one banknote parameter with the one or more banknote parameters stored in the memory.

In one or more of the above examples, the stored banknote parameter for at least some of the banknotes is a banknote orientation. In one or more of the above examples, the stored banknote parameter for at least some of the banknotes is a banknote series. In one or more of the above examples, the stored banknote parameter for at least some of the banknotes is a banknote denomination. In one or more of the above examples, the stored banknote parameter for at least some of the banknotes is a banknote serial number.

In another example embodiment, a banknote cashbox recognition system includes a banknote acceptor to store accepted banknote. The banknote acceptor includes a banknote cashbox to store accepted banknotes, one or more sensors configured to capture one or more banknote parameters from each of the banknotes received into the banknote acceptor. The banknote acceptor includes a memory configured to store the one or more banknote parameters of some of the banknotes accepted into the banknote acceptor. The banknote cashbox recognition system includes a banknote counting unit to count accepted banknotes from banknote cashboxes from plurality of banknote acceptors. The banknote cashbox recognition system includes a device to provide data from plurality of banknote acceptors about the one or more banknote parameters of some of the banknotes received into the plurality banknote acceptors. The banknote counting unit is configured to link a banknote cashbox to a banknote acceptor by using the one or more banknote parameters of some of the banknotes received into the banknote acceptor.

In one or more of the above examples, the stored banknote parameter for at least some of the banknotes is a banknote orientation. In one or more of the above examples, the stored banknote parameter for at least some of the banknotes is a banknote series. In one or more of the above examples, the stored banknote parameter for at least some of the banknotes is a banknote denomination. In one or more of the above examples, the stored banknote parameter for at least some of the banknotes is a banknote serial number.

In another example embodiment, a banknote dispense module recognition system includes, a banknote dispense unit filling machine to fill at least a banknote dispensing unit. The banknote dispense unit filling machine includes at least a banknote dispensing unit, one or more sensors configured to capture one or more banknote parameters from each of the banknotes stored into the banknote dispense unit. The banknote dispense unit filling machine is configured to store the one or more banknote parameters of some of the banknotes stored into at least one of the banknote dispensing units. Banknote dispense module recognition system includes a device to provide data from the banknote dispense unit about the one or more banknote parameters of some of the banknotes stored into the plurality banknote dispense units to plurality of banknote deposit withdrawal systems. The banknote dispense module recognition system includes multiple banknote deposit withdrawal systems to store accepted banknote. Each of the banknote deposit withdrawal systems includes a banknote cashbox to store accepted banknotes, at least a banknote dispense module to dispense banknotes. The banknote deposit withdrawal system is configured to dispense banknotes to a customer from one or more of the banknote dispense modules. The banknote deposit withdrawal systems includes one or more sensors configured to capture one or more banknote parameters from each of the banknotes stored into the banknote dispense module. The banknote deposit withdrawal system configured to identify a banknote dispense module by using the one or more banknote parameters of some of the banknotes stored into the banknote dispense module.

In one or more of the above examples, the stored banknote parameter for at least some of the banknotes is a banknote orientation. In one or more of the above examples, the stored banknote parameter for at least some of the banknotes is a banknote series. In one or more of the above examples, the stored banknote parameter for at least some of the banknotes is a banknote denomination. In one or more of the above examples, the stored banknote parameter for at least some of the banknotes is a banknote serial number.

In another example embodiment, a method of operating a currency handling apparatus includes acquiring one or more banknote parameters from each of the banknotes received into the currency handling apparatus using one or more sensors. The method includes storing accepted banknotes into one or more storage areas. The method includes transporting accepted banknotes using a banknote transport path to convey the banknotes to the one or more storage areas and to dispense the banknotes at least to the one or more sensors. The method includes storing the one or more banknote parameters of some of the banknotes received into the currency handling apparatus. The method includes receiving, from the one or more sensors, at least one banknote parameter for a banknote dispensed from one of the one or more storage areas to the one or more sensors. The method includes comparing the at least one banknote parameter with the one or more banknote parameters stored in the memory, and generating an alert signal based on the comparison of the at least one banknote parameter with the one or more banknote parameters stored in the memory.

In one or more of the above examples, the stored banknote parameter for at least some of the banknotes is a banknote orientation. In one or more of the above examples, the stored banknote parameter for at least some of the banknotes is a banknote series. In one or more of the above examples, the stored banknote parameter for at least some of the banknotes is a banknote denomination. In one or more of the above examples, the stored banknote parameter for at least some of the banknotes is a banknote serial number.

In another example embodiment, a method of recognizing banknote cashbox includes accepting banknotes in a banknote acceptor and storing accepted banknotes in a banknote cashbox. The method includes capturing one or more banknote parameters from each of the banknotes received into the banknote acceptor by using one or more sensors. The method includes storing the one or more banknote parameters of some of the banknotes accepted into the banknote acceptor in a memory. The method includes counting accepted banknotes from banknote cashboxes from plurality of banknote acceptors in a banknote counting unit. The method includes providing data from plurality of banknote acceptors about the one or more banknote parameters of some of the banknotes received into the plurality banknote acceptors. The method includes linking a banknote cashbox to a banknote acceptor by using the one or more banknote parameters of some of the banknotes received into the banknote acceptor.

In one or more of the above examples, the stored banknote parameter for at least some of the banknotes is a banknote orientation. In one or more of the above examples, the stored banknote parameter for at least some of the banknotes is a banknote series. In one or more of the above examples, the stored banknote parameter for at least some of the banknotes is a banknote denomination. In one or more of the above examples, the stored banknote parameter for at least some of the banknotes is a banknote serial number.

In another example embodiment, a method of recognizing banknote dispense module includes filling at least a banknote dispensing unit in a banknote dispense unit filling machine. The method includes capturing one or more banknote parameters from each of the banknotes stored into the banknote dispense unit by using one or more sensors. The method includes storing the one or more banknote parameters of some of the banknotes stored into at least one of the banknote dispensing units. The method includes providing data from the banknote dispense unit about the one or more banknote parameters of some of the banknotes stored into the plurality banknote dispense units to plurality of banknote deposit withdrawal systems. The method includes dispensing banknotes to a customer from one or more of the banknote dispense modules using a banknote deposit withdrawal system. The method includes capturing one or more banknote parameters from each of the banknotes stored into the banknote dispense module using one or more sensors. The method includes identifying a banknote dispense module by using the one or more banknote parameters of some of the banknotes stored into the banknote dispense module.

In one or more of the above examples, the stored banknote parameter for at least some of the banknotes is a banknote orientation. In one or more of the above examples, the stored banknote parameter for at least some of the banknotes is a banknote series. In one or more of the above examples, the stored banknote parameter for at least some of the banknotes is a banknote denomination. In one or more of the above examples, the stored banknote parameter for at least some of the banknotes is a banknote serial number.

In one or more of the above examples, the stored banknote parameter for at least some of the banknotes is a banknote printing site identifier. In one or more of the above examples, the stored banknote parameter for at least some of the banknotes is a banknote sheet location identifier.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A banknote acceptor of an unattended payment system, the banknote acceptor comprising:
an inlet to allow insertion of a banknote into the banknote acceptor;
a banknote transport path to transport the banknote from the inlet to an interior of the banknote acceptor; and
at least one imaging sensor configured to:
capture an image of an object inserted in the banknote transport path, and
capture an image of a user attempting to insert the object into the inlet of the banknote acceptor.

2. The banknote acceptor of claim 1, further comprising a reflective surface or a refractive surface operable to change a field of view of the at least one imaging sensor.

3. The banknote acceptor of claim 2, wherein the reflective surface or the refractive surface is operable to perform simultaneous monitoring of multiple noncontiguous regions of the banknote transport path.

4. The banknote acceptor of claim 1, wherein the at least one imaging sensor is operable to move to capture the image of the user attempting to insert the object into the inlet of the banknote acceptor.

5. The banknote acceptor of claim 1, wherein the at least one imaging sensor is operable to move to capture the image of the object inserted in the banknote transport path.

6. The banknote acceptor of claim 1, wherein a field of view for the at least one imaging sensor comprises a one-way transparent surface.

7. The banknote acceptor of claim 1, wherein the banknote acceptor is operable to wake up from a sleep mode if the at least one imaging sensor detects insertion or attempted insertion of the object into the inlet of the banknote acceptor.

8. The banknote acceptor of claim 1, further comprising a memory, wherein the image of the user and the image of the inserted object are stored in the memory of the banknote acceptor.

9. The banknote acceptor of claim 1, wherein the image of the user and the image of the inserted object are stored in a memory of the unattended payment system.

10. The banknote acceptor of claim 1, wherein the at least one image sensor is further configured to capture an image of an area surrounding the unattended payment system.

11. The banknote acceptor of claim 1, wherein a size throughout the banknote transport path is modified to accommodate a denomination of the inserted banknote.

12. A currency handling apparatus, comprising:
a banknote input area operable to receive banknotes into the currency handling apparatus;
one or more sensors configured to capture one or more banknote parameters from each of the banknotes received into the currency handling apparatus;
one or more storage areas;
a banknote transport path operable to convey the banknotes to the one or more storage areas and to dispense the banknotes at least to the one or more sensors;
a memory configured to store the one or more banknote parameters of some of the banknotes received into the currency handling apparatus; and
a controller coupled to the memory, wherein the controller is configured to:
receive, from the one or more sensors, at least one banknote parameter for a banknote dispensed from one of the one or more storage areas to the one or more sensors,
compare the at least one banknote parameter with the one or more banknote parameters stored in the memory, and
generate an alert signal based on the comparison of the at least one banknote parameter with the one or more banknote parameters stored in the memory.

13. The currency handling apparatus of claim 12, wherein the stored one or more banknote parameters for at least some of the banknotes include a banknote orientation.

14. The currency handling apparatus of claim 12, wherein the stored one or more banknote parameters for at least some of the banknotes include a banknote series.

15. The currency handling apparatus of claim 12, wherein the stored one or more banknote parameters for at least some of the banknotes include a banknote denomination.

16. The currency handling apparatus of claim 12, wherein the stored one or more banknote parameters for at least some of the banknotes includes a banknote serial number.

17. The currency handling apparatus of claim 12, wherein the banknotes are dispensed from each of the one or more storage areas in turn.

18. The currency handling apparatus of claim 12, wherein the controller is further configured to:
detect a banknote jam;
issue a jam alert;
detect completion of a jam correction operation; and
resume the conveyance of the banknotes to the one or more storage areas or the dispensation of the banknotes at least to the one or more sensors.

19. The currency handling apparatus of claim 12, wherein the controller is further configured to provide the stored one or more banknote parameters to a banknote counting machine.

20. The currency handling apparatus of claim 12, wherein the controller is further configured to:
receive a banknote parameter from a banknote loading machine;
store the banknote parameter received from the banknote loading machine in the memory;
receive, from the one or more sensors, the at least one banknote parameter for the banknote dispensed from one of the one or more storage areas to the one or more sensors; and
compare the at least one banknote parameter with the banknote parameter received from the banknote loading machine.
